(19) United States
(12) Patent Application Publication
(10) Pub. No.: US 2025/0366394 A1
(43) Pub. Date: Dec. 4, 2025

(54) MOUNTING APPARATUS FOR SWATHER HEADER

(71) Applicant: HONEY BEE MANUFACTURING LTD., Frontier (CA)

(72) Inventors: Glenn Raymond HONEY, Bracken (CA); Muthanna ABOU NAJM, Frontier (CA); Steve Anthony DUECK, Bracken (CA)

(21) Appl. No.: 18/732,315

(22) Filed: Jun. 3, 2024

(51) Int. Cl. A01D 41/14

(52) U.S. Cl. CPC A01D 41/145

(57) ABSTRACT

An agricultural system comprises a propulsion unit comprises at least one, generally longitudinally extending, lift arm. The system also comprises a generally transversely extending implement comprising a generally transversely extending main frame. The implement may be a swather header and has a weight. The at least one lift arm is operable to support at least a first portion of the weight. A connection apparatus connects the at least one lift arm to the implement and transmit forces between the implement and the least one lift arm. The connection apparatus may be located proximate a distal end region of the at least one lift arm, and comprises a suspension mechanism operable to any one or more of, support, isolate, resist, cushion, absorb and dampen static forces and/or dynamic forces during the transmission of the static and/or dynamic forces between the implement and the at least one lift arm of the propulsion unit.

### TECHNICAL FIELD

The present disclosure relates, generally, to agricultural implements, including swather headers and, more specifically, to a mounting apparatus for a swather header.

### BACKGROUND

An agricultural implement, such as a swather (or windrower) on a propulsion unit or a spray boom on a power unit, may be propelled across a field. The swather may include a swather header mounted to lift arms of a propulsion or power unit with a mounting assembly. As the swather moves across the field, a cutter bar of the swather header may cut a crop and deposit the crop in windrows for drying.

During use, it may be desirable to control a height and tilt of the swather header relative to the propulsion unit and, thereby, control the height and tilt of the swather header relative to the ground surface and to crops in the field. Accurate control of the height and tilt of the swather header relative to the ground surface/crops may result in higher crop yields for harvesting, for example.

During operation of such an agricultural apparatus, a large proportion of the weight and other forces imparted by, and onto, the agricultural implement may be carried by the propulsion unit, with the loads least in part, being transferred/transmitted from/between the implement and its frame, via the mounting assembly, to/and the propulsion unit. In some systems, at least in some operational modes, a large proportion of the weight of, and other forces imparted onto, the implement may be supported by the cutter bar itself, where the cutter bar may rest upon and be supported, at least in part, by the ground surface.

At least for some agricultural implements, in at least some of their modes of operation, laterally positioned and spaced stabilizing components, such as ground engaging gauge wheels at or towards opposed ends of the implement, may be provided. The stabilizing components may be shown to provide additional support of at least some portion of the weight of the implement. The stabilizing components may also assist in minimizing the negative effects of other forces imparted on the agricultural implement. However, the interaction between the loads on the implement (which loads typically will vary during operation) when the implement has some additional support of stabilizers, such as gauge wheels, and the agricultural implement, can be challenging to manage.

For example, when the swather header is rigidly mounted to the propulsion unit and a gauge wheel on one side of a swather header encounters rising terrain, this can impart a significant upward dynamic shock force to the gauge wheel, which dynamic shock force is transferred/transmitted through the swather header to propulsion unit via the mounting assembly.

It is known to deploy mechanical springs or hydraulic systems associated with the lift arms of the propulsion unit to provide height adjustment and/or shock absorption of forces imparted to the propulsion unit. Mechanical springs positioned between the lift arms and the main body of the propulsion unit are known. But such systems have drawbacks.

It is therefore desirable to improve upon the design of such agricultural systems.

### SUMMARY

In an aspect of the disclosure, there is provided an agricultural system comprising: a propulsion unit comprises at least one, elongated and generally longitudinally extending, lift arm; a generally transversely extending implement comprising a generally transversely extending main frame, the implement having a weight; a mounting apparatus located on the at least one lift arm and operable to provide a first support force to support at least a first portion of the weight of the implement; wherein the mounting apparatus comprises a suspension mechanism operable to provide suspension of the portion of the weight of the implement on the propulsion unit.

In another aspect of the disclosure, there is provided an agricultural system comprising: a propulsion unit comprises at least one, generally longitudinally extending, lift arm; a generally transversely extending implement comprising a generally transversely extending main frame, the implement having a weight; wherein the at least one lift arm is operable to support at least a first portion of the weight of the implement; a connection apparatus operable to connect the at least one lift arm to the implement and transmit forces between the implement and the least one lift arm; wherein the connection apparatus comprises a suspension mechanism operable to any one or more of, support, isolate, resist, cushion, absorb and dampen static forces and/or dynamic forces during the transmission of the static and/or dynamic forces between the implement and the at least one lift arm of the propulsion unit.

In another aspect of the disclosure, there is provided a mounting apparatus comprising: an assembly; a first connection mechanism operable to connect the assembly to a propulsion unit, the propulsion unit including a lift arm, the first connection mechanism including a boot configured to engage and retain an end region of the lift arm; a second connection mechanism operable to connect the assembly to a main header frame of a swather header, the main header frame including a transverse support beam and a vertical strut secured to the transverse support beam, the assembly comprising a lift horn member operable to fixedly connect to the vertical strut with the second connection mechanism; a header suspension system including an expandable pressurized gas bag operably interposed between the boot and the lift horn member; and a pneumatic system configured to control a pressure of gas in the gas bag to, thereby, adjust an extent to which the mounting apparatus is operable to transfer, to the lift arm a force acting upon the main header frame.

In another aspect of the disclosure, there is provided an agricultural system comprising: a propulsion unit comprises at least one, elongated, generally longitudinally extending, lift arm, the at least one lift arm having a distal end region; a generally transversely extending implement comprising a generally transversely extending main frame, the implement having a weight; wherein the at least one lift arm is operable to support at least a first portion of the weight of the implement; a connection apparatus located proximate the distal end region of the at least one lift arm and operable to connect the at least one lift arm to the implement and transmit forces between the implement and the least one lift arm; wherein the connection apparatus comprises a suspension mechanism operable to one or more of support, isolate, resist, cushion, absorb and dampen static and/or dynamic forces during the transmission of the forces between the implement and the at least one lift arm of the propulsion unit; and a header height control system operable to control a distance between a bottom of the main header frame and a ground level.

In another aspect of the disclosure, there is provided an agricultural apparatus comprising: a propulsion unit including first and second generally longitudinally extending lift arms, the first and second lift arms being transversely spaced apart and each of the first and second lift arms having an end region; a transversely extending header having a weight; a first lower connecting apparatus and a second lower connecting apparatus interconnecting the end regions of the first and second lift arms respectively to the header and operable to provide support for at least a portion of the weight of the main header; wherein each of the first and second lower connecting apparatuses includes a fluid suspension mechanism operable to at least partly provide suspension between the end regions of the first and second lift arms and the main frame on the propulsion unit.

### BRIEF DESCRIPTION OF THE DRAWINGS

In figures which illustrate example embodiments:

FIG. 1 is a front perspective view of an agricultural apparatus according to one embodiment;

FIG. 2A is a front side perspective view of the agricultural implement of the agricultural apparatus of FIG. 1, with some parts being shown exploded;

FIG. 2B is an opposite rear side perspective view of the agricultural implement of the agricultural apparatus of FIG. 1;

FIGS. 3A, 3B and 3C are perspective views of some frame components of the agricultural implement of FIGS. 1A, 1B and 1C;

FIG. 4 is a schematic view of the system of FIG. 1 according to one embodiment;

FIG. 5 is a schematic view of the system of FIG. 1 according to one embodiment;

FIG. 6A is a side view of the apparatus of FIG. 1;

FIG. 6B is a front side perspective view of a portion of the apparatus of FIG. 6A;

FIG. 6C is a front side perspective view of a portion of FIG. 6B;

FIG. 7A is an enlarged rear lower perspective view of some other components of the agricultural implement of the agricultural apparatus of FIG. 1;

FIG. 7B is an enlarged rear perspective view of some components shown in FIG. 7A;

FIG. 7C is an enlarged upper exploded perspective view of components shown in FIG. 7A;

FIGS. 7D and 7E are enlarged upper exploded and assembled perspective views of components similar to the components shown in FIG. 7A; and

FIG. 8A is a front side perspective view of some components of the agricultural implement and propulsion unit of the agricultural apparatus of FIG. 1;

FIG. 8B is an enlarged front side perspective view of some of components of the agricultural implement shown in FIG. 5C;

FIG. 8C is an enlarged rear perspective view of some other components of the agricultural implement of the agricultural apparatus of FIG. 1;

FIG. 8D is an enlarged side elevation view of some components shown in FIG. 7B;

FIG. 8E is a front side perspective view of some components of an agricultural implement according to another embodiment, in a first configuration;

FIG. 8F is a front side perspective view of some components of an agricultural implement according to another embodiment, in a first configuration;

FIG. 9 is a left-side perspective view of a component of the agricultural implement of FIG. 1;

FIG. 9A is a right-side perspective view of the component of FIG. 9;

FIG. 10 is a left-side perspective view of another component of the agricultural implement of FIG. 1;

FIG. 10A is a left-side perspective view of the component of FIG. 9;

FIGS. 11A, 11B and 11C are rear side, front side and bottom perspective views of another component of the agricultural implement of FIG. 1;

FIG. 12A is an enlarged side elevation view of some components shown in FIG. 8D, in a first configuration;

FIG. 12B is an enlarged side elevation view of some components shown in FIG. 8D, in a second configuration;

FIG. 13 is a schematic of a pneumatic system in accordance with an embodiment;

FIG. 14A is an enlarged rear perspective view of some components of the agricultural implement of the agricultural apparatus of FIG. 1;

FIG. 14B is an enlarged front perspective view of some components shown in FIG. 14A; and

FIG. 15 is a perspective view of a three-point hitch that may form part of a propulsion unit, and which may be utilized to support a swather header.

### DETAILED DESCRIPTION

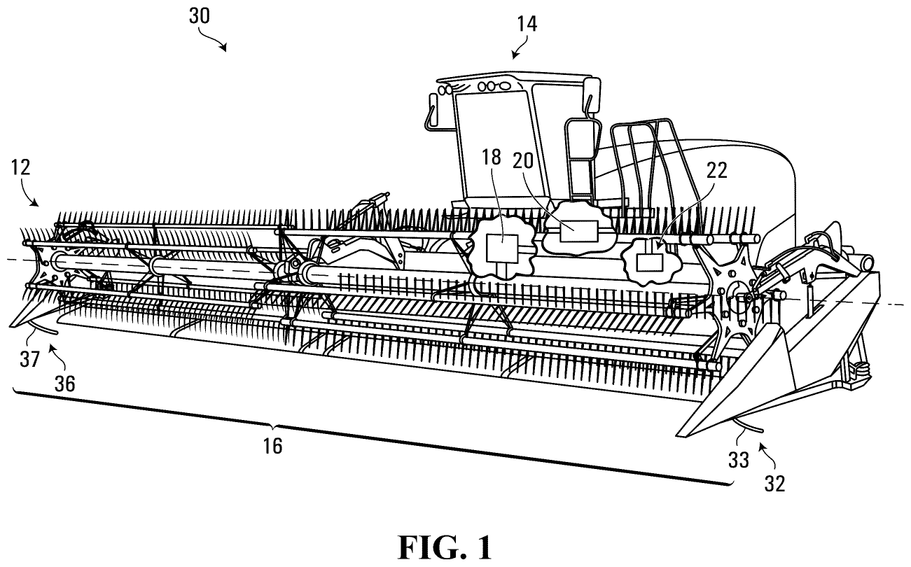

Referring to FIG. 1, an agricultural apparatus in accordance with one embodiment is shown at 30. Agricultural apparatus 30 may for example be a swather or windrower including a swather header 12 which may be mounted to and supported at least in part by a propulsion unit 14.

Propulsion unit 14, may be a known type of tractor, which may be configured and adapted to provide support for swather header 12 in front of propulsion unit 14 with the swather header 12 oriented in a forward-facing direction (as shown in FIG. 1). Propulsion unit 14 is operable to propel the forward movement of swather header 12 to cut and process crop material, and propulsion unit 14 can provide power and other utilities to swather header 12, during operation. In some embodiments, a swather header 12 may be supported in a rearward location of a propulsion unit, such that the swather header is oriented in a rearward facing direction relative to the propulsion unit. In such embodiments, the propulsion unit is operable to move rearwardly with the rearwardly facing header 12 and swather header 12 is operable to cut and process crop material during such rearward direction of the propulsion unit. Swather header 12 may be configured to cut crop material from crops growing in a field while the apparatus 30 is driven across a crop field by propulsion unit 14. Swather header 12 may also form the cut crop material into a windrow for drying and/or ripening. The crop material may then be subsequently collected, for example, baled, combined or rolled.

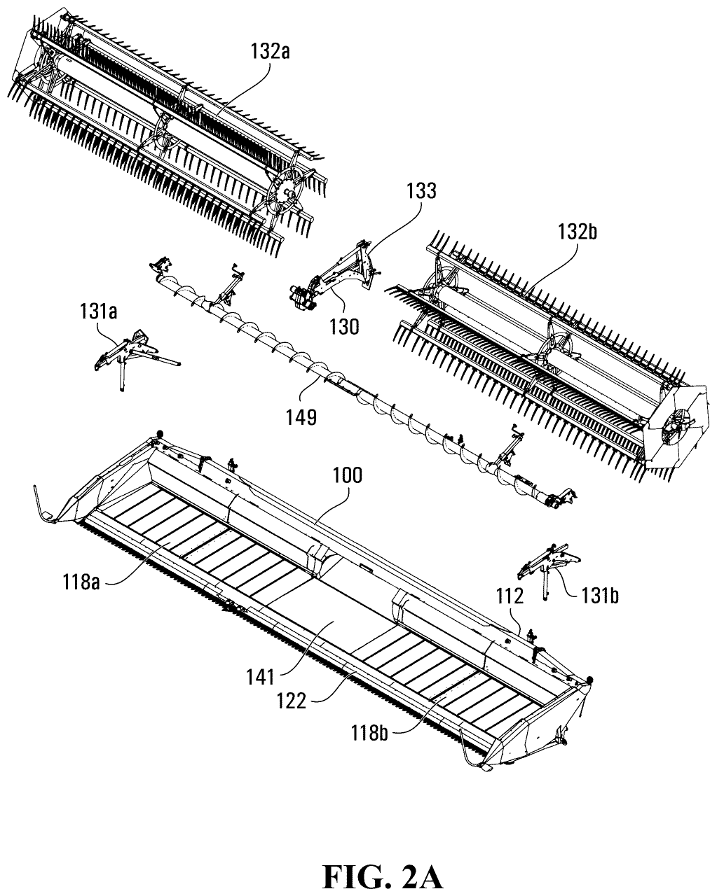

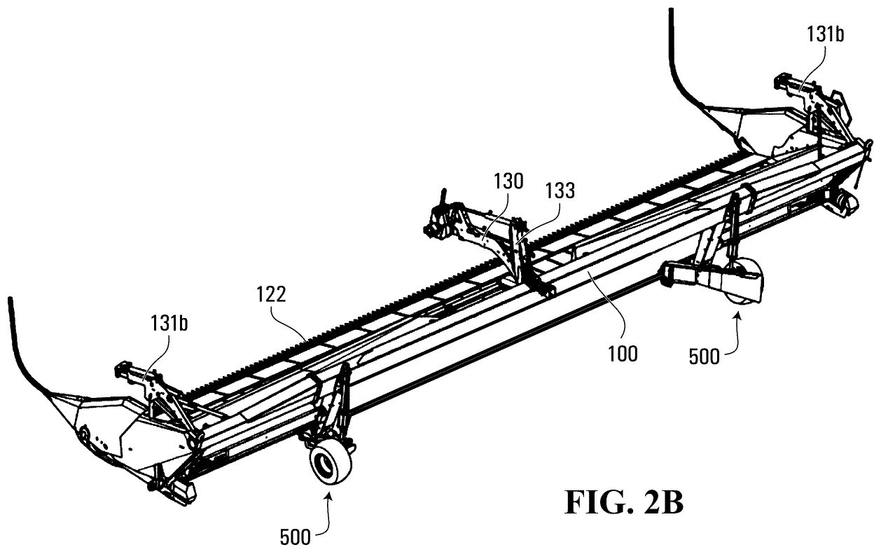

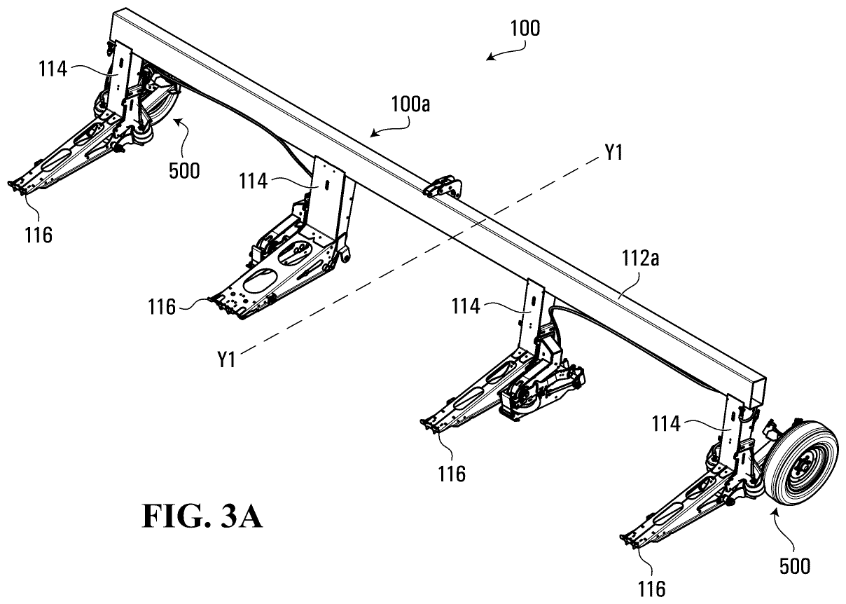

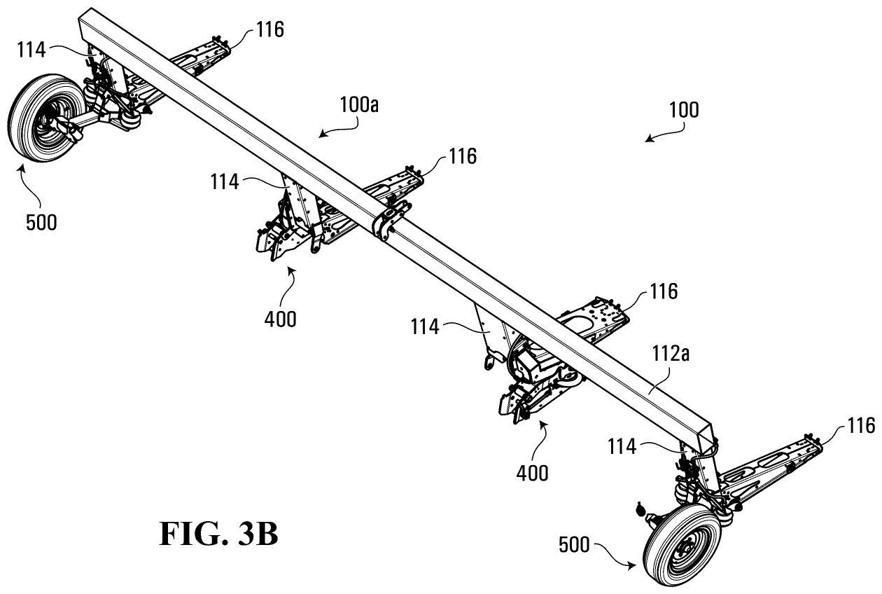

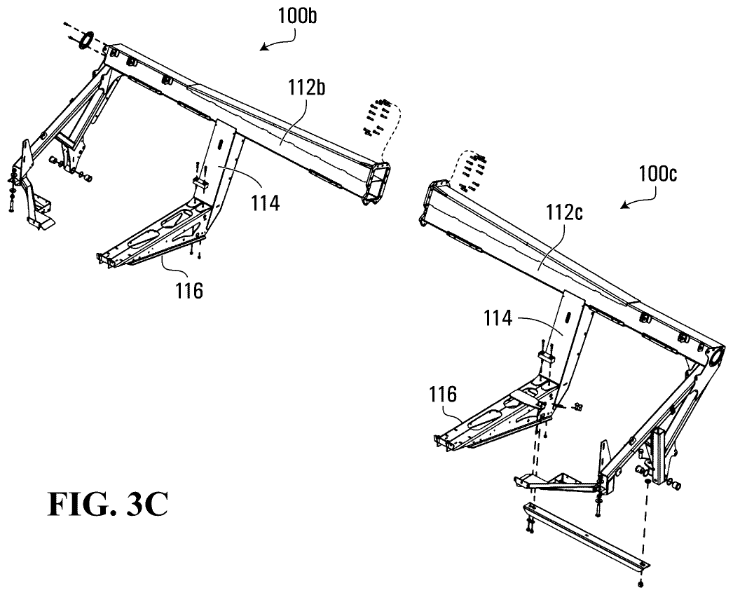

With particular reference to FIGS. 2A and 2B, swather header 12 extends generally transversely and may include a generally transversely extending main header frame generally designated 100. As shown in FIGS. 3A to 3C, main header frame 100 may include a main transverse support beam 112 (see FIG. 2A), which may include a central support beam component 112a, a right-side extension support beam component 112b and a left-side extension support beam component 112c. Support beam components 112a, 112b, 112c, may be fixedly connected to each other (for example, with bolted flanges) in an end-to-end relation with longitudinal alignment to create a transversely extending composite continuous transverse support beam 112. Transverse support beam 112 may be made from any suitably strong and configured material, such as a steel (such as ASTM A36 steel) hollow sectional tube member. Fixedly secured to transverse support beam 112, such as, for example, with fasteners or by welding, may be a plurality of transversely spaced, generally downwardly depending, vertical struts 114. Swather header 12 may have a weight which includes the weight of the main header frame 100, and the weight of the other components of the swather header that are mounted to/supported by the main header frame 100. By way of example only, swather headers in the range of 15 ft to 65 ft wide may have a corresponding range in total weight from about 1500 lbs. to about 8000 lbs. It may be noted that the weight of a header for a swather apparatus may be significantly less than the weight of a header for a corresponding width combine apparatus due to the former typically having fewer relatively heavy components (e.g. may be in order of about 3500 lbs. less in weight for the same width headers.

Fixedly secured, such as, for example, with fasteners or by welding, to a bottom end region of each vertical strut 114 may be a generally forwardly extending horizontal strut 116. Each vertical strut 114 may be made from any suitably strong and configured material, such as a steel (such as ASTM A36 steel) hollow sectional tube member. Each horizontal strut 116 may be a steel structural open member, such as a structural open member made from ASTM A36 steel.

Main header frame 100 may thus be formed as a central frame section 100a (FIGS. 3A to 3C) with opposite side frame sections 100b and 100c. For each frame section, 100a, 100b, 100c, the main support beams and vertical and horizontal struts may be fastened or welded together to form a single assembly/weldment. The center, right and left frame sections 100a, 100b, 100c can then be bolted together. Depending upon the required overall transverse width, the right and left frame section may vary in width, such that swather headers may range in total width of between about 15 ft and 60 ft, or possibly more.

With reference to FIGS. 1, 2A and 2B, swather header 12 may also include first and second lateral, transversely extending draper decks 118a, 118b supported on main header frame 100 and located on opposite transverse ends of swather header 12. Draper decks 118a, 118b may be mounted to main header frame 100 in a known manner and may be operable to collect and feed cut crop material to a swath opening 141 located between the inner ends of draper decks 118a, 118b. The crop material will fall through swath opening 141 and be deposited onto the ground surface in a windrow.

In other embodiments, swather header 12 may have more than one swath opening for depositing the cut crop onto the ground surface in more than one windrows at a time. Crop may be fed to each of the swath openings through a suitable arrangement of additional draper decks.

Swather header 12 may also include a center reel arm 130, a right-side reel arm 131a and a left side reel arm 131b, which may be mounted to, and supported by, main header frame 100 in a known manner. Center reel arm 130 and right-side reel arm 131a may support, for rotation about a reel axis, a right reel section 132a. Center reel arm 130 and left-side reel arm 131b may support, for rotation about the same common transversely extending reel axis, a left reel section 132b. Right and left reel sections 132a, 132b may be driven about their common transversely oriented reel axis with known reel drive systems. Reel sections 132a, 132b may be operable to pull crop material onto cutter bar 122 to be cut by the cutting blades of cutter bar 122, and then pull cut crop material directly into swath opening 141 and also onto draper decks 118a, 118b for transport to swath opening 141. In some embodiments, swather header 12 may not include a center reel arm 133 and may only have a right-side reel arm 131a and a left-side reel arm 131b.

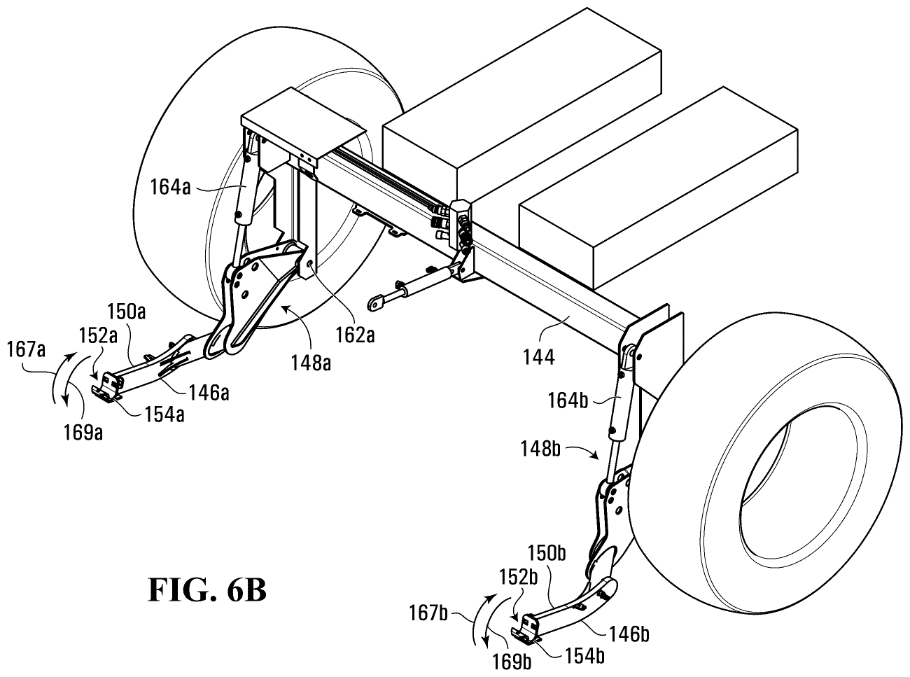

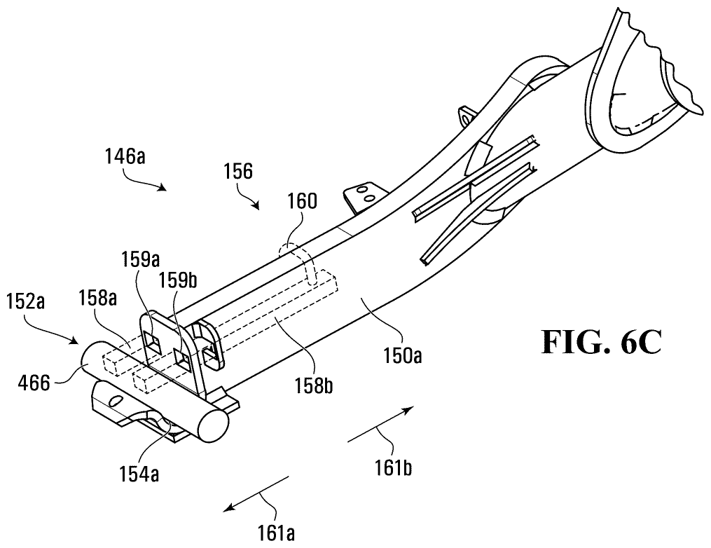

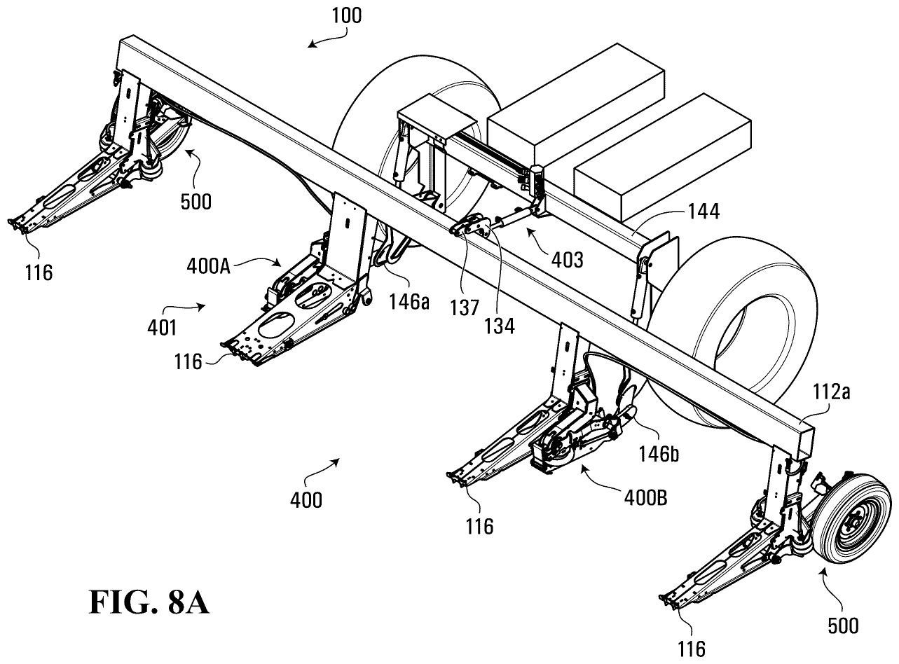

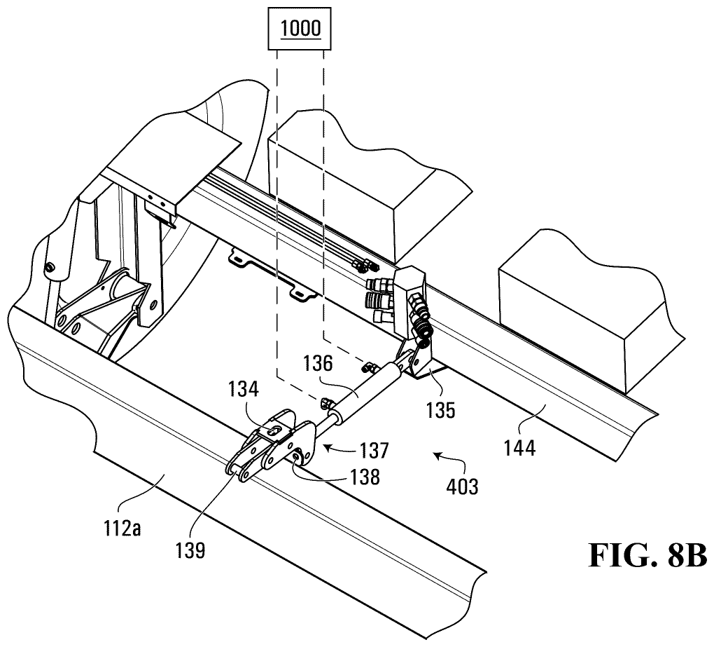

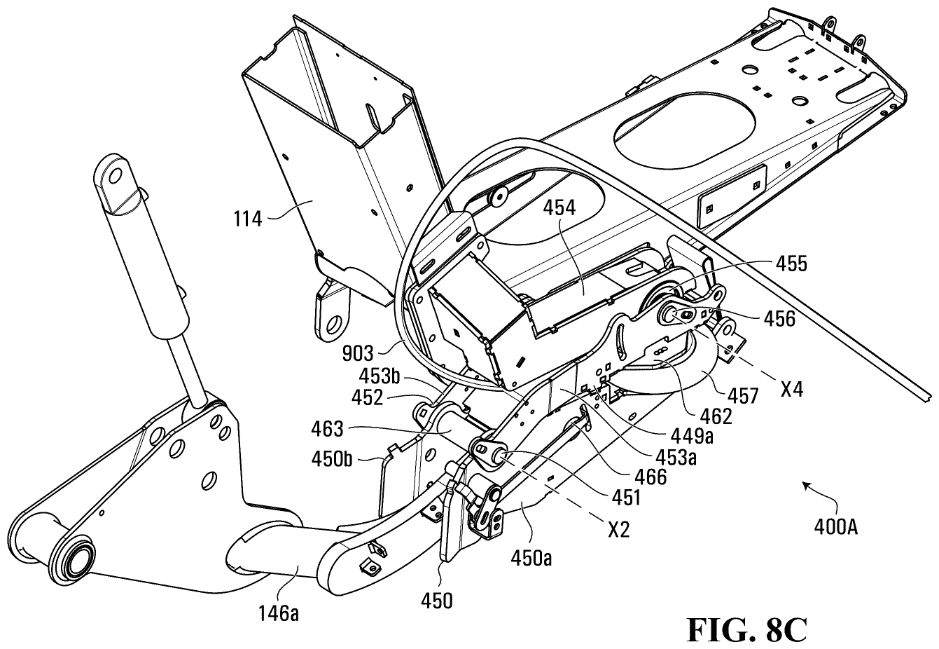

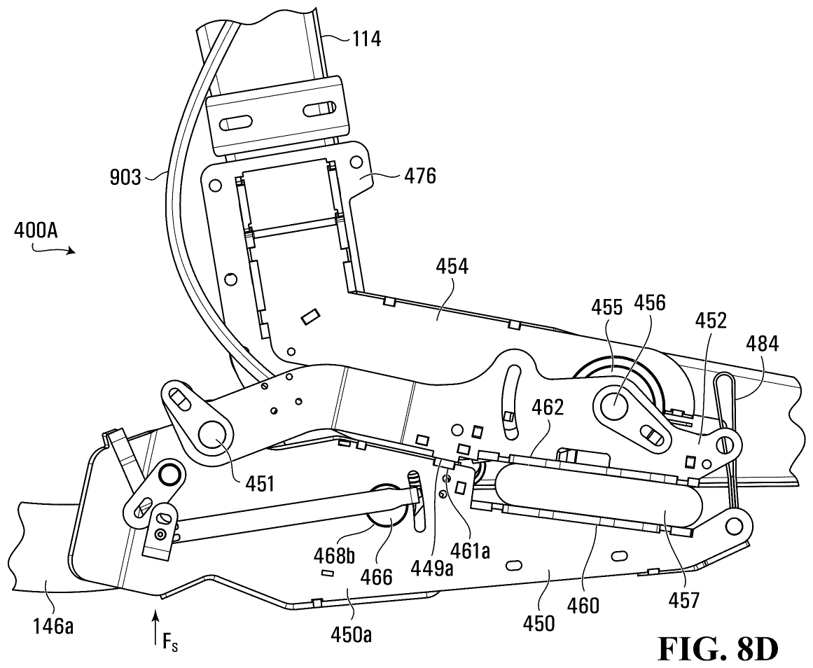

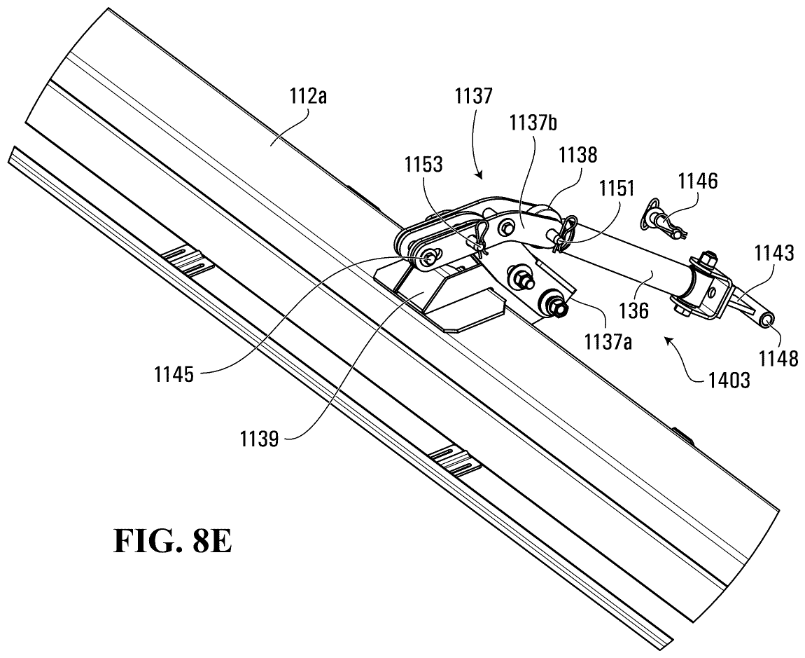

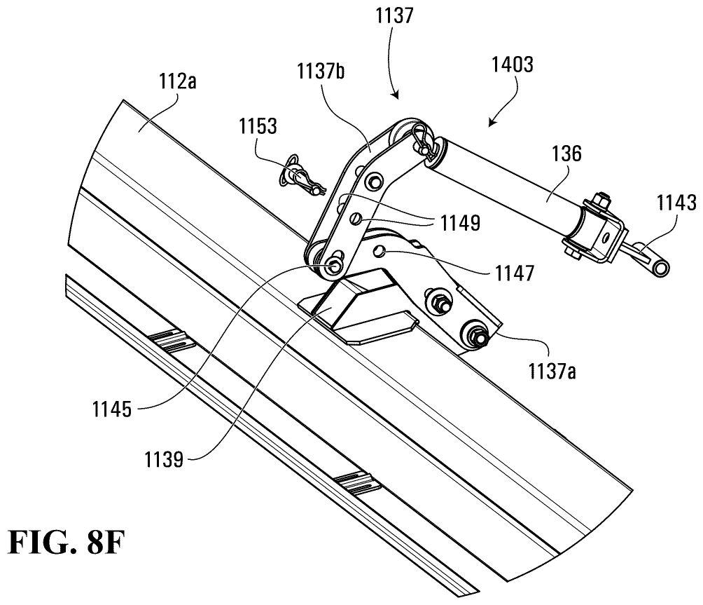

With particular reference to FIGS. 6A, 6B, at the front/forward end or side of propulsion unit 14 may be a structural member such as a transverse beam member 144 [generally forming a front part of the swather chassis] to which a pair of generally forwardly longitudinally extending, elongated lift arms 146a, 146b may be pivotally connected via respective pivotal connections 148a, 148b. Lift arms 146a, 146b may generally extend beneath, and may provide support to, swather header 12. As will be explained in more detail below, depending on the mode of operation of swather header 12, lift arms 146a, 146b may provide first and second support forces Fs (FIG. 8D) to carry/support at least a portion, and possibly substantially all, of the weight of swather header 12, including a portion or substantially all of the weight of main header frame 100.

Pivotal connections 148a, 148b may be any suitable type of connection to facilitate generally upwards and downwards motion of lift arms 146a, 146b (and in particular distal forward end portions 152a, 152b located at or proximate respective distal end regions of lift arms 146a, 146b [FIG. 6B]) about respective pivot points 162a, 162b, as will be explained in more detail below. Depending on the type/brand/model of propulsion unit 14 being utilized, the arrangement of pivotal connections 148a, 148b, lift arms 146a, 146b and their attachment to propulsion unit 14 may vary.

In some embodiments, lift arms 146a, 146b may be mechanically coupled together such that lift arms 146a, 146b may move generally upwards/downwards in unison.

With reference to FIG. 6C, lift arm 146a (like lift arm 146b) may include a generally rectangular (in cross section), forwardly longitudinally extending member 150a terminating at a lower distal end region/portion 152a, which may be formed as a generally U-shaped open bracket defining a lift arm pin receiving channel 154a.

Similarly, lift arm 146b may include a generally rectangular and forwardly longitudinally extending end member 150b terminating at a lower distal end region/portion 152b, which may be formed as a generally U-shaped open bracket defining a lift arm pin receiving channel 154b (FIG. 6B).

As will be explained in more detail below, lower distal end portions 152a, 152b, which may have any suitable shape and configuration, may interconnect with swather header 12 such as with a latch type mechanism, and lower end portions 152a, 152b may act as/provide a lift point/location for raising and/or lowering swather header 12.

As will be described further hereinafter, the connection between propulsion unit 14 and main header frame 100 maybe a “three-point” pivotal connection that enables the propulsion unit 14 to support all, most or some of the weight of the swather header, it may also permit a limited degree of lateral (side-to-side) tilting in upward and downward lateral directions of main header frame 100 relative to propulsion unit 14, about an upper pivotal connection and, thus, relative to lift arms 146a, 146b. This connection between propulsion unit 14 and main header frame 100 may be provided with one or more mounting/connection apparatuses generally designated 400 (FIG. 8A, one or more of which incorporate or provide part of a header suspension system/mechanism (as described hereinafter). Each header suspension system/mechanism is operable to one or more of, support, isolate, resist, absorb, cushion, and dampen at least some of the static and dynamic forces that are being transferred/transmitted between the propulsion unit and the header through the mounting apparatuses. For example, static downward forces acting on header 12 including on main header frame 100 and cutter bar 122, associated with the mass/weight of such components, as well as dynamic downwardly and upwardly acting forces acting on the header 12, may be transferred between the header 12 and propulsion unit 14 through the mounting apparatuses, including the suspension system/mechanisms. Dynamic forces may be imparted to the header 12 and its frame 100 from lift arms 146a, 146b during operation of the header height control system as described herein, and/or the dynamic motion imparted into the swather header 12 by its ground engaging elements [e.g., cutter bar or gauge wheels] as they are mechanically moved by variations in height of the surface terrain. Forces acting in lateral tilt directions may also be transferred though the mounting apparatuses between the propulsion unit 14 and swather header 12. The mass of swather header 12 can be moved to motion by forces due to gravity when accelerating over changing levels of the terrain surface. For example, the swather header may experience nominally vertically directed accelerations-upwards/downwards-due gravity in a “roller coaster” effect when moved over changing heights/elevation of the terrain surface by the propulsion unit 14.

Dynamic downward and/or upward acting forces acting on the header may be transferred from the header 12 to lift arms 146a, 146b (and visa versa), (and possibly to some extent to one or more other members of the propulsion unit) through the mounting apparatuses including through mounting apparatuses that have suspension systems/mechanisms, as described further below. The lift arms 146a, 146b may, at least in some modes of operation, support most or possibly all of the generally downwardly acting weight of swather header 12.

The suspension system/mechanism may be configured with pressurized gas (e.g. air) bags to provide the desired supporting/shock absorption/cushioning/dampening/isolating effect, as described further below. In some embodiments, the suspension system/mechanism may be provided with other types of suitably configured spring devices such as coil, leaf, hydraulic, magnetic, torsion or rubber, spring devices, or any suitably configured elastic material that has a suitable spring rate The suspension system/mechanism may possibly be configured as a hydro-pneumatic suspension system that may combine the use of both pressurized hydraulic fluid and a pressurized gas.

As noted above, during operation of agricultural apparatus 30 other downwardly and upwardly acting dynamic forces may be imparted to propulsion unit 14 and/or header 12, such as when propulsion unit 14 and header 12 moves over uneven terrain and/or during operation of the header height control system. With particular reference to FIG. 8D, if the propulsion unit 14 moves over quickly rising terrain, this may impart an upward directed force from propulsion unit 14 and including from its lift arms 146a, 146b, and upwardly acting support forces Fs acting on lift arms 146a, 146b and/or a lift boot 450 may be transferred upwards into lift boot 450, and through and initially compressing the header suspension system/mechanism as described further below, to lift horn 454. Thus, the upwardly acting support forces Fs may at least in part be cushioned before and while being imparted to the header 12 and its main frame 100.

At least in some embodiments, a suspension mechanism may be configured and operable such that if the propulsion unit 14 moves quickly over downwardly sloped terrain, this may impart a downwardly directed force from propulsion unit 14 and including from its lift arms 146a, 146b, and downwardly acting support forces (in the opposite direction to forces Fs) acting on lift arms 146a, 146b and/or a lift boot 450 (FIG. 8D) may be transferred upwards into lift boot 450, and through the header suspension system/mechanism as described further below, to lift horn 454. Thus, the downwardly acting support forces may at least in part be cushioned before being imparted to the header 12 and its main frame 100.

In some embodiments where lift arms 146a, 146b are mechanically coupled together and cannot move/translate upwards or downwards independently of each other, the three-point pivotal connection allows swather header 12 some limited ability to tilt laterally (side-to-side) relative to propulsion unit 14, which would otherwise not be possible.

### Cutter Bar Float Paddles

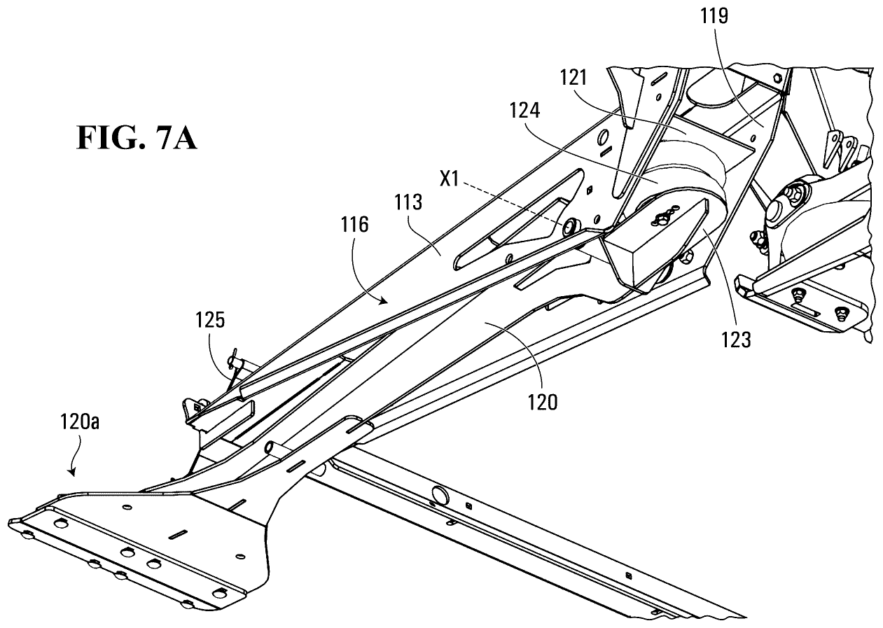

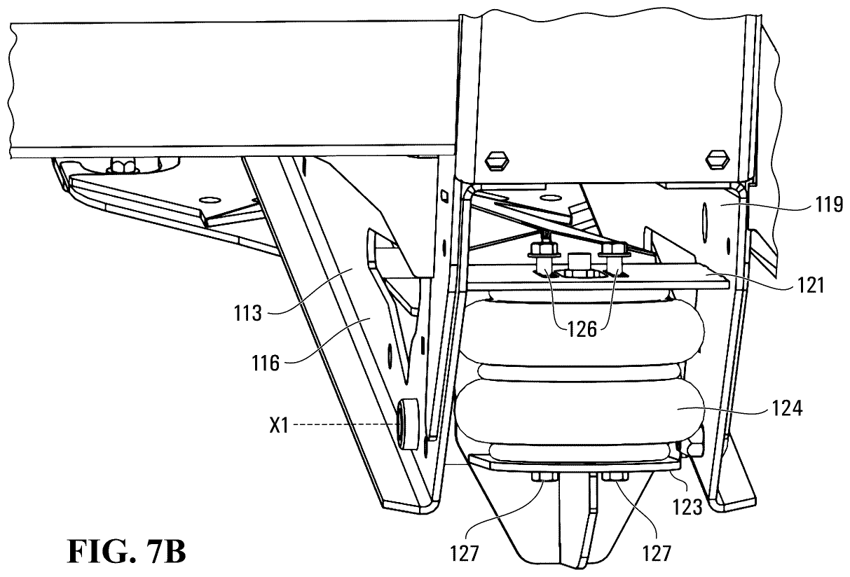

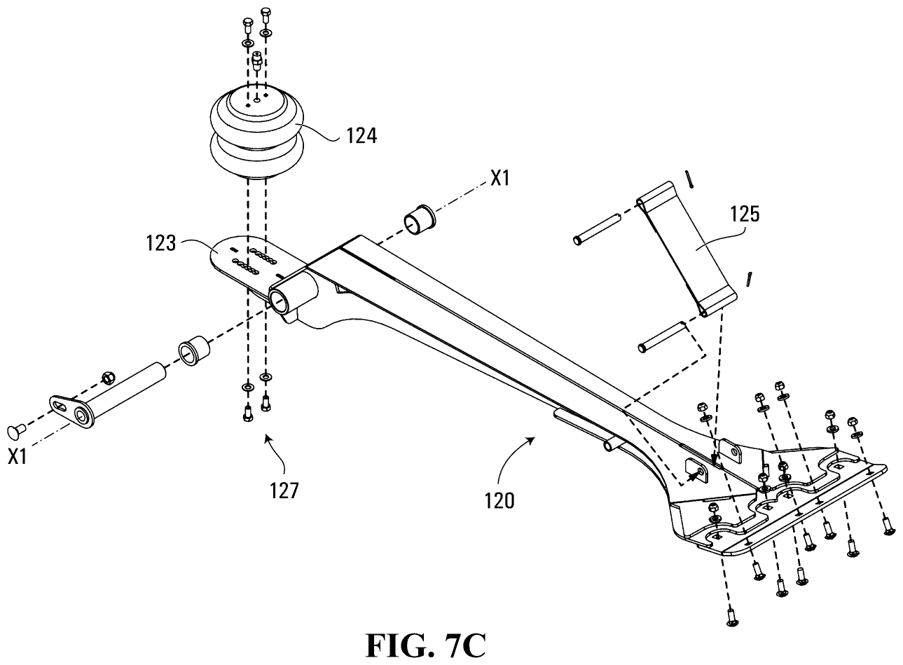

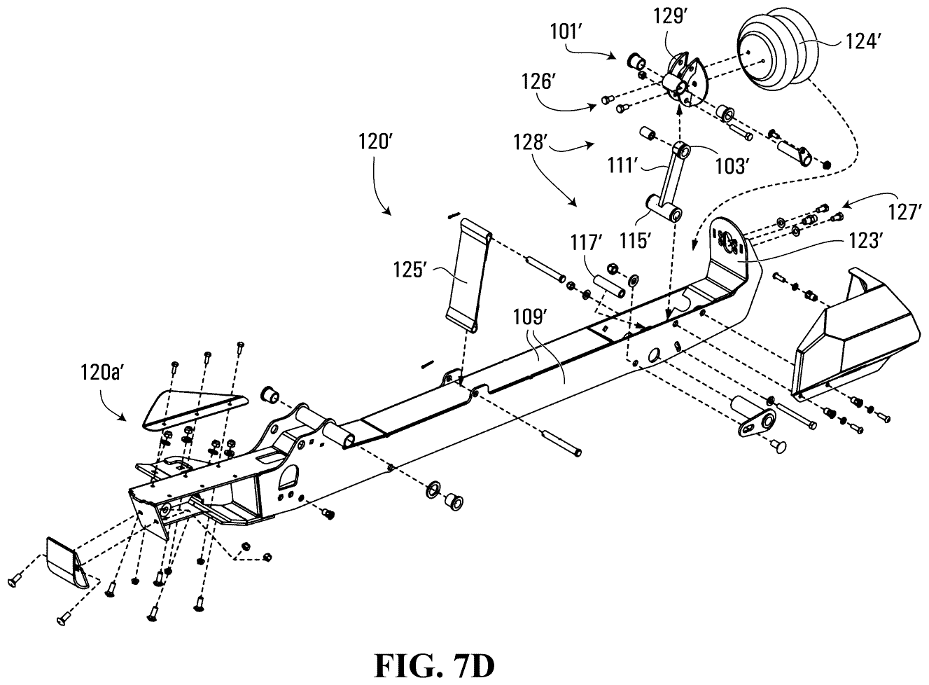

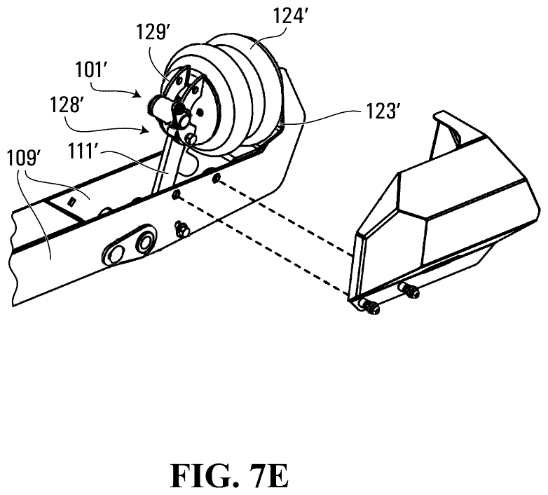

With reference now to FIGS. 3A-3C and FIGS. 7A-7E, pivotally mounted to each horizontal strut 116, may be a forwardly and generally forwardly horizontally extending cutter bar float paddle 120, which has a portion that extends beyond the front edge of each horizontal strut 116. Each cutter bar float paddle 120 may be made of any suitably strong and configured material(s), such as ASTM A36 steel. Each cutter bar float paddle 120 may be configured and mounted to be able to pivot about a transverse axis, X1, at its rearward end region relative to its respective horizontal strut 116. A forward end region of each cutter bar float paddle 120 may be interconnected to cutter bar 122. Thus, cutter bar 122 may be connected to, and at least partially supported by, a plurality of transversely spaced cutter bar float paddles 120, and each cutter bar float paddle 120 may be configured and operable for independent upward and downward movement within an angular range that enables cutter bar 122 to have an upward/downward range of translation of several inches (e.g., an upwards/downwards translation of about nine inches). A paddle travel limiting strap 125 may be secured between each paddle end region 120a and the end of horizontal strut 116. Each paddle travel limiting strap 125 may act to limit the downward movement of paddle regions 120a relative to the end of horizontal strut 116. The upward movement of paddle 120 may be limited by contact between surfaces of paddle 120 and surfaces of horizontal strut 116. Cutter bar 122 may be a known type of crop cutting apparatus that extends laterally substantially the entire width of swather header 12 and may include reciprocating cutting blades that may be powered in a known manner.

FIG. 7D depicts a variation of a type of cutter bar float paddle 120′, which functions substantially the same as cutter bar float paddle 120 but which may be deployed at the right and left end regions of main header frame 100, for securing to right and left end regions of cutter bar 122. Each cutter bar float paddle 120′ may also be made of any suitably strong and configured material(s), such as ASTM A36 steel. Each cutter bar float paddle 120′ may be configured and mounted to be able to pivot about a transverse axis at its rearward end region relative to a respective horizontal strut 116. A forward end region 120a′ of each opposed end cutter bar float paddle 120′ may be interconnected to end regions of cutter bar 122. Thus, cutter bar 122 may be connected to, and at least partially supported by, cutter bar float paddles 120′, and each cutter bar float paddle 120′ may also be configured and operable for independent upward and downward movement within an angular range that enables cutter bar 122 to have an upward/downward range of translation of several inches (e.g., an upwards/downwards translation of about nine inches)—like cutter bar float paddles 120. A paddle travel limiting strap 125′ may be secured between a middle area of cutter bar float paddle 120a′ and a middle region of a horizontal strut 116. Each paddle travel strap 125′ may act to limit the downward movement of paddle 120a′ relative to the end of horizontal strut 116. The upward movement of paddle 120′ may be limited by contact between surfaces of paddle 120 and surfaces of a horizontal strut 116.

In some embodiments, cutter bar float paddle 120′ shown in FIG. 7D (or a cutter bar float paddle configured in a similar manner to cutter bar float paddle 120′) may be deployed at all regions of main header frame 100, i.e., swather header 12 may only utilize cutter bar float paddle 120′ at some or all other horizontal struts 116, in addition to the right and left end regions of main header frame 100.

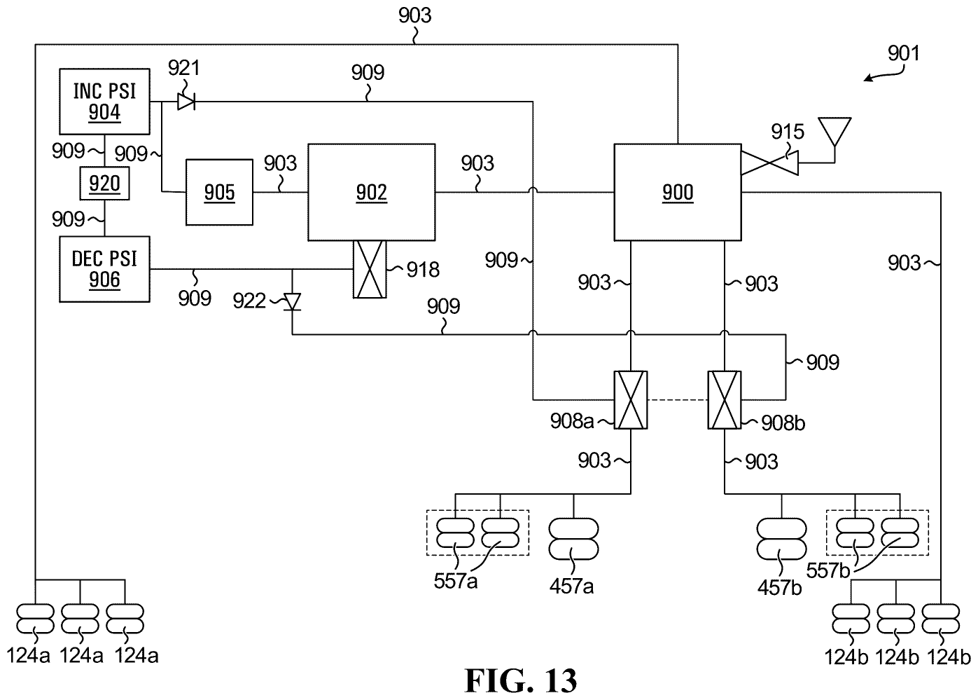

With particular reference to FIGS. 7A to 7D, at least one cutter bar gas actuator device/float gas bag, which may be a cutter bar float air bag 124, may be mounted between a rearwardly generally horizontally extending plate member 123 of each cutter bar float paddle 120 and a rearwardly positioned, upper generally horizontal rigid support plate 121 of the respective horizontal strut 116, behind the pivot axis, X1. Plate members 123 may extend between inward facing support surfaces 119 of vertical side walls 113 of each horizontal strut 116. Each plate member 123 may be formed integrally at a rearward region of cutter bar float paddle 120 and may pivot about axis X1 (FIG. 7C) with the rest of its respective cutter bar float paddle 120 relative to its respective horizontal strut 116. Each cutter bar float air bag 124 may have a lower integral rigid plate portion that may be fixedly secured to a respective plate member 123 with a bolt mechanism 127 and may be held in lateral position relative to support strut plate 121 with guide bolts 126 passing through an opening within support strut plate 121. Bolt holes in the plate portion of cutter bar float air bag 124 can be appropriately sealed in a known manner from the inner pressurized air cavity of cutter bar float air bag 124 (e.g., blind mounting nuts/bolt holes). The rigid upper plate portion may also provide for an air inlet/outlet, which can be pneumatically connected to a pneumatic/air hose 903 (FIG. 13).

Similarly, with reference to FIGS. 7D and 7E, at least one cutter bar float gas bag, which may be a cutter bar float air bag 124′ (and which, hereafter, may, at times, also be referred to collectively with cutter bar float air bag 124 simply as cutter bar float air bag(s) 124), may be mounted between a rearwardly generally vertically extending plate member 123′ of each cutter bar float paddle 120′ and a front side, generally vertically extending mounting plate 129′ of cutter bar float paddles 120′ located at each of the right and left end regions of main header frame 100. Mounting plate 129′ is part of a pivoting mounting bracket assembly 128′. Bracket assembly 128′ may include a pivot arm 111′ having a lower pivot cylinder 115′ that is pivotally mounted with a transverse pin 117′ between vertical side walls 109′ of cutter bar float paddle 120′. An upper pivot assembly 101′ pivotally interconnects an upper end 103′ of pivot arm 111′ to both mounting plate 129′ of cutter bar float air bag 124′ and to a portion of vertical strut 114 of main header frame 100. Each cutter bar float air bag 124′ may have a rear integral rigid plate portion that may be fixedly secured to a respective plate member 123′ with a bolt mechanism 127′ and may be held in vertical position with guide bolts 126′. Bolt holes in the forward rigid plate portion of cutter bar float air bag 124′ can be appropriately sealed in a known manner from the inner pressurized air cavity of cutter bar float air bag 124′ (e.g., blind mounting nuts/bolt holes). This rigid forward plate portion may also provide for an air inlet/outlet which can be pneumatically connected to pneumatic/air hose 903 (see FIG. 13). Increasing the pressure within cutter bar float air bag 124′ will cause cutter bar float air bag 124′ to pivot about transverse axis of upper pivot assembly 101′. There is a mechanical benefit to this mechanism for cutter bar float air bag 124′ compared to the corresponding mechanism for cutter bar float air bag 124 as described above, in that the spring rate response/behavior of the pivot mechanism for cutter bar float air bag 124′ provides a more constant spring rate over the full range of pivoting motion of cutter bar float air bag 124′ about the transverse pivot axis.

Each cutter bar float air bag 124 may be operable to provide an air suspension/force cushioning effect to the pivoting movement of each cutter bar float paddle 120 about axis X1 relative to the horizontal strut 116, when forces are imparted upon cutter blade 122 and, thus, on paddles 120, including the downward acting force of gravity on the cutter blade and paddles, and upward acting forces imposed by rising terrain as cutter bar 122 moves across the ground surface during operation of agricultural apparatus 30.

Each cutter bar float air bag 124 (which may also include each cutter bar float air bag 124′) may, through a plurality of hoses and valves, be in pneumatic communication with, and be a part of, a pneumatic system 901 (which may utilize compressed air or, possibly, another suitable gas), as described further hereinafter, that also includes a gas (air) compressor 905 and a gas (air) storage/working tank 902 (see FIG. 13). While in some embodiments, pneumatic system 901 uses pressurized air as the pressurized gas, other embodiments may utilize other suitable gases, such as gases that may be less thermally expansive than air (e.g., for use in some climatic environments). For example, pneumatic system 901 may utilize pressurized nitrogen gas.

Each cutter bar float air bag 124 (which may also include each cutter bar float air bag 124′) may be inflated and deflated by pneumatic system 901 over a range of air pressures, such as, for example, between 30 psi and 100 psi or between 30/40 psi and 120 psi. Each cutter bar float air bag 124 may feature a generally tubular side wall made of a resiliently expandable material, such as a rubber material. The side wall material may be permanently bonded to/crimped with metal, generally cylindrical, flat end plates at opposite ends. Cutter bar float air bags 124 may also be sized, configured and positioned to be able to exert appropriate forces/pressures (also known as resistance forces) on the surface of each plate member 123 and opposed facing surface of horizontal strut plate 121 of respective horizontal strut 116 when the interior cavity of the cutter bar float air bag 124 is pressurized by pneumatic system 901. Each cutter bar float air bag 124′ may also operate in a similar manner. An example of a known type of air bag that might be employed as cutter bar float air bag 124 is the model FD 70-12 CI Double Convolution Air Actuator made by ContiTech AG of Hanover, Germany and/or one of its affiliated companies or a comparable AIRSTROKE™ actuator made by Firestone Industrial Products, LLC of Indianapolis, IN. Such a cutter bar float air bag 124 may have upper and lower plates with a diameter of about 4.25 inches and the interior of the bag may have operating internal volumes of between about 40 cubic inches to 110 cubic inches over operating pressures of between about 30/40 psi and 120 psi.

It should be noted that a pressurized gas bag, such as cutter bar float air bag 124 (as well as frame gas/air suspension air bag 457 and gauge wheel gas/air bags 557 as described below) may function like a spring in which the spring rate is able to be varied by the air pressure inside the air bag. The higher the internal air pressure, then the stiffer the spring force action of the air bag.

It should also be noted that all such pressurized gas bags may, in addition to being capable of resisting and imparting varying forces (e.g., provide lifting/load carrying capabilities), may also be capable of functioning to act as vibration isolators/dampeners.

The level of the air pressure within each cutter bar float air bags 124/124′ provided by pneumatic system 901 (as well as the height of main header frame 100 relative to the ground surface) can be varied to alter how much of the weight of cutter bar 122 is carried on main header frame 100 and how much is supported by the contact (if any) between the cutter bar 122 and by the stabilizer apparatuses 500 (as referenced below) and the ground surface. When each of the transversely spaced cutter bar float air bags 124/124′ is inflated to a relatively high, typically the same, initial setup pressure by pneumatic system 901 (e.g., a maximum pressure such as 100 psi) each cutter bar float air bag 124 then all cutter bar float air bags 124/124′ will have expanded, and cutter bar float paddles 120/120′ will be forced to pivot, about their respective axes X1 relative to the horizontal strut 116, to a maximum upwards extent permitted. A stop member may be provided to limit the upwards movement of the forward portion of cutter bar float paddle 120/120′. The pressure in each cutter bar float air bag 124/124′ may be set to such a high level that the float air bags will be very difficult to compress during operation of agricultural apparatus 30 as swather header 12 moves through a crop field. Thus, if the height of main header frame 100 is set at a particular desired cutting height above the ground, cutter bar 122 will, when travelling over flat ground surface, have most, or at least the majority, of its weight carried by main header frame 100. This is because each cutter bar float paddle 120/120′ will be unable to pivot to move the cutter bar 122 downwards to any significant extent relative to horizontal strut 116 and cutter bar 122 will typically not be providing any support for the weight of swather header 12. This creates a relatively high degree of stiffness of the entire cutter bar 122, which stiffness results in the entire cutter bar 122 being substantially rigid and substantially fixed in upward/downward movement relative to horizontal struts 116 and, consequently, also relative to main header frame 100. None of cutter bar float paddles 120/120′ will be able to pivot to any significant extent about their respective axes X1 and cutter bar 122 will behave substantially like a cutter bar this is fixedly connected to, and unable to move relative to, main header frame 100. This mode of operation may be referred to as the cutter bar 122 operating in a “rigid mode.” In this mode, the height of main header frame 100 and of cutter bar 122 can be set to a desired cutting height relative to, and typically a few inches above, the ground surface.

However, by varying/lowering the pressure in each cutter bar float air bag 124/124′, each cutter bar float paddle 120/120′ and each cutter bar float air bag 124/124′ arrangement referenced above, can also be operated in a different manner, such that cutter bar 122 can “flex” transversely across its width relative to main header frame 100 (i.e., along its entire length or at one or more certain sections across its width). If each cutter bar float air bag 124/124′ is inflated to a specified lower pressure level (e.g., at an initial setup pressure, such as about 30 psi) then cutter bar float air bags 124/124′ will act more like a spring that allows each cutter bar float paddle 120/120′ to pivot about axis X1 when cutter bar 122 is subjected to upward and downward variations in forces, such as the force of gravity acting on cutter bar 122 and the result of the interaction of cutter bar 122 with a changing level of the ground surface. The pressure in cutter bar float air bags 124/124′ may be at a level that cutter bar float air bags 124/124′ will be able to be resiliently compressed during operation of agricultural apparatus 30 as swather header 12 moves through a crop field. This pressure level creates a lower degree of stiffness in cutter bar float air bags 124 (which results in each cutter bar float paddle 120 being able to pivot about their respective axes X1) and cutter bar 122 will be able to move upwards and downward within a range of movement when subject to variations in upwardly/downwardly acting forces, typically caused by changes in the level of the ground surface. This may be referred to as cutter bar 122 operating in a “flex mode.” At a relatively lower air pressure level in cutter bar float air bags 124/124′ (e.g., 30 psi), the height of the main header frame 100 may be selected such that a relatively high proportion of the weight of cutter bar 122 is being carried by its contact with the ground surface and a much lower proportion, if any, of the weight of cutter bar 122 is carried by stabilizer apparatuses 500, which, generally, are in contact with the ground, and by main header frame 100, acting through cutter bar float air bags 124/124′ interposed between cutter bar float paddles 120/120′ and the respective horizontal struts 116.

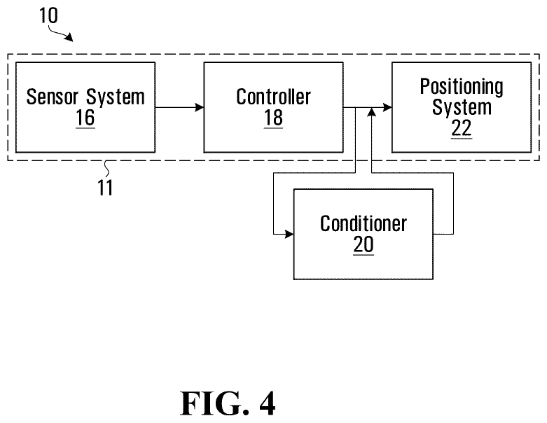

When, during operation, agricultural apparatus 30 is moving through a field, cutter bar 122 may be configured in “flex mode” and main header frame 100 height may be selected (as described further below) so that the cutter bar 122 is, when on level ground, in contact with the ground surface. Main header frame 100 may have been positioned at a particular desired position relative to propulsion unit 14. For example, if cutter bar 122 has a range of relative upward and downward movement relative to main header frame 100 of 9 inches, a header height control system 10 (FIG. 4) may be set such that when cutter bar 122 is resting on a level ground surface, cutter bar 122 may be set at a desired cutting position of 2 inches down from the uppermost zero-inch position. This means that that each paddle 120 is able to independently move upwards 2 inches and downwards 7 inches relative to main header frame 100. When cutter bar 122—or a portion of cutter bar 122—encounters a portion of rising ground surface, if the height control system for main header frame 100 does not raise the entire swather header 12 relative to propulsion unit 14, cutter bar 122 may rise relative to main header frame 100, as the forward regions of one or more cutter bar float paddles 120/120′ pivot upwards relative to and about the pivot connection with its respective horizontal strut 116. This allows the respective cutter bar float air bags 124/124′ to expand, reducing the air pressure therein. During such operation, header height control system 10, which controls the height of main header frame 100 relative to propulsion unit 14, may continue to be utilized to try to maintain main header frame 100 at such a position that the entire cutter bar 122 is maintained at about a 2-inch desired cutting position, on level ground.

However, when cutter bar 122—or a portion of cutter bar 122—encounters a portion of ground surface at a lower level, header height control system 10 (FIG. 4) may not need to respond to lower main header frame 100 relative to propulsion unit 14 and may remain at its set cutting position. Instead, cutter bar 122 (or a portion of cutter bar 122) may lower relative to main header frame 100, as forward regions of one or more cutter bar float paddles 120 pivot downwards relative to and about the pivot connection with its respective horizontal strut 116 due to the weight of cutter bar 122. As cutter bar float paddles 120 pivot downwards at the front regions with cutter bar 122, rear plate member 123 will compress cutter bar float air bag(s) 124/124′ thus increasing the air pressure therein, resulting in an increase in the force being exerted back by cutter bar float air bag 124/124′ against cutter bar float paddle 122. This creates a cushioning effect by which a greater portion of the weight of cutter bar 122 is being carried by main header frame 100 and less of the weight of cutter bar 122 is being carried by the ground surface. This response of cutter bar 122 to the downward change in surface level can occur more quickly as the response is direct, as compared to the response of header height control system 10, which acts in response to header height signals that control hydraulic actuators to adjust the position of main header frame 100, as described further below.

As will be described further hereinafter, swather header 12 may also be equipped with at least one stabilizer apparatus generally designated 500 (and possibly two or more) on each lateral side of the center line, Y1, of swather header 12 (FIG. 3A). Stabilizer apparatus(es) 500 on each side can assist in carrying some of the forces acting on swather header 12, during various modes of operation.

### Header Height Control

As may be evident from the foregoing, swather header 12 may, in some modes of operation (e.g., rigid mode of cutter bar 122 and swather header 12), be able to efficiently cut the crop material when main header frame 100 of swather header 12 is kept at a constant height or separation distance close to but generally above the ground, without striking the ground. As agricultural apparatus 30 travels over the ground, the ground may have inconsistencies and undulations and, therefore, in order to keep swather header 12 at a constant height relative to the ground, agricultural apparatus 30 may have a sensor system 16 to sense changes in level of the ground, which may act as a reference surface. Agricultural apparatus 30 may then control a position of main header frame 100 of swather header 12 relative to propulsion unit 14 to maintain main header frame 100 of swather header 12 at a constant or desired height above the reference surface.

Referring to FIG. 4, to control the position of swather header 12, agricultural apparatus 30, as shown in FIG. 1, may include header height control system 10 for controlling the movement/position of swather header 12 relative to propulsion unit 14. Header height control system 10 may include a controller system 11 including a sensor system 16, a header height controller 18, and a header positioning system 22. Controller system 11 may be a known controller system, such as supplied by a manufacturer of the apparatus for controlling movement of the agricultural implement.

Referring to FIG. 2, sensor system 16 may be configured to sense a position of swather header 12 (e.g., of main header frame 100 relative to the ground) and to transmit position signals representing the sensed position to header height controller 18. Header height controller 18 may receive the position signals representing the sensed position and compare the sensed position to a desired position to determine a difference. Header height controller 18 may then produce control signals, based on the difference. Header height controller 18 may be configured to transmit the control signals to header positioning system 22, which may control hydraulic actuators, for example, to cause movement of main header frame 100 of swather header 12 towards a desired position relative to propulsion unit 14. While the embodiments herein are described with reference to hydraulic actuators, in some embodiments, other types of actuators, such as electrical actuators, may be employed to cause movement of main header frame 100 of swather header 12.

Header positioning system 22 may have a positioning response time for causing agricultural apparatus 30 to respond to the control signals. In cases where header positioning system 22 has a positioning response time that results in excessive movement or “hunting” for the desired position, according to the teachings herein, header height control system 10 may be provided with a signal conditioner 20, which is configured to condition the control signals transmitted by header height controller 18 and normally received by header positioning system 22. Signal conditioner 20 may be configured to intercept the control signals transmitted by header height controller 18, to generate conditioned control signals and to transmit the conditioned control signals or output signals to header positioning system 22 instead of the control signals, in response to the control signals transmitted by header height controller 18. Signal conditioner 20 may be configured to receive system sensor signals 49 from an optional plurality of system sensors 47. The generating of the conditioned control signals may, at least in part, be based on system sensor signals 49.

Referring back to FIG. 1, header height control system 10 of FIG. 4 may be mounted on agricultural apparatus 30. In the embodiment shown, sensor system 16 may include left sensors 32 and right sensors 36 located at first and second locations on left and right ends respectively of main header frame 100 of swather header 12.

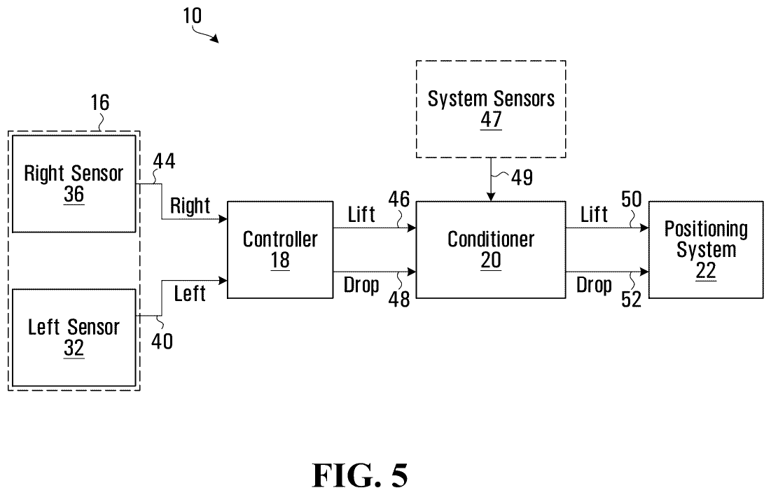

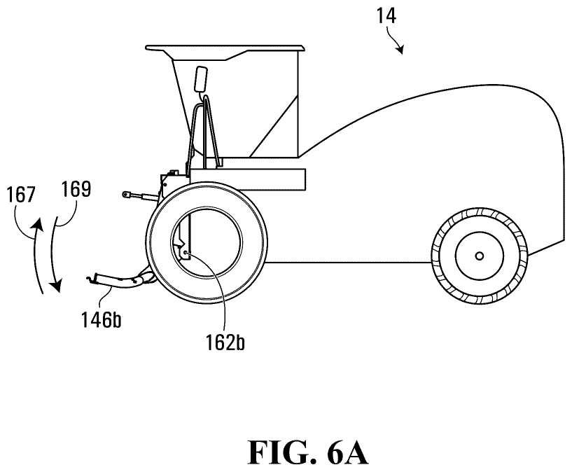

Referring to FIGS. 1 and 5, sensors 32 and 36 may be configured to send left and right position signals 40 and 44 representing left and right sensed positions or heights of respective locations, on swather header 12 (in particular on main header frame 100) relative to the ground, to header height controller 18. In some embodiments, sensors 32 and 36 may each include a sensing arm or paddle attached to main header frame 100 (shown at 33 and 37 in FIG. 1) and a Hall Effect sensor configured to sense a rotational angle of the sensing arm.

In various embodiments left and right position signals 40 and 44 may be electrical signals that have a voltage level representing a sensed position or height measured by their respective sensor. For example, the voltage level of left and right position signals 40 and 44 may be between a low voltage level and a high voltage level, with a low voltage level representing 0% of a maximum sensed height and high voltage level representing 100% of the maximum sensed height. For example, in some embodiments, the low voltage level may be about 1 Volt and the high voltage level may be about 4 Volts. However, in various other embodiments, the high and low voltage levels of left and right position signals 40 and 44 may be other voltage levels.

In the embodiment shown, sensors 32 and 36 have a minimum sensed height of about 0 inches and a maximum sensed height of about 18 inches. However, in various embodiments, sensors 32 and 36 may sense other ranges of heights.

In various embodiments, sensors 32 and 36 may transmit left and right position signals 40 and 44 to header height controller 18 using electrical wires, for example, coupled to a respective one of sensors 32 and 36 at one end and to header height controller 18 at another end.

Referring still to FIG. 5, in various embodiments, header height controller 18 may be configured to receive or sample left and right position signals 40 and 44 representing the left and right sensed heights of main header frame 100 of swather header 12. In some embodiments, header height controller 18 may be configured to sample the position signals periodically, such as once every about 20 ms, for example. Header height controller 18 may be configured to compare each of the left and right sensed heights with desired left and right heights respectively to determine differences between the sensed heights and the desired heights. In some embodiments, header height controller 18 may be configured to receive signals representing the desired left and right heights from memory and/or via an I/O interface of header height controller 18, for example. The desired heights may be about 2″, for example.

Header height controller 18 may, based on the differences between the sensed heights and the desired heights, produce lift control signals 46 and drop control signals 48 for causing header positioning system 22 to move main header frame 100 of swather header 12 towards the desired heights.

For example, in some embodiments, header height controller 18 may be configured to determine a left difference between the left sensed height and the left desired height and to determine a right difference between the right sensed height and the right desired height. When at least one of the left and right differences represents a sensed height that is less than a desired height and has an absolute value that is greater than a threshold difference, header height controller 18 may produce lift and drop control signals 46 and 48 such that, if the control signals were transmitted to header positioning system 22, the control signals would cause header positioning system 22 to cause main header frame 100 of swather header 12 to be raised relative to propulsion unit 14 shown in FIG. 1.

If only one of the left and right differences represents a sensed height that is less than a desired height and has an absolute value that is greater than a threshold difference, header height controller 18 may produce lift and drop control signals 46 and 48 such that there will be both a suitable height adjustment of main header frame 100 relative to the ground surface and a lateral tilt adjustment carried out by header positioning system 22 to achieve a desired frame height on both the right and left sides.

If neither of the left and right differences represents a sensed height that is less than a desired height and has an absolute value that is greater than the threshold difference and at least one of the left and right differences represents a sensed height that is greater than a desired height and has an absolute value that is greater than a threshold difference, header height controller 18 may produce lift and drop control signals 46 and 48 such that, if the control signals were transmitted to header positioning system 22, the control signals would cause header positioning system 22 to drop (i.e., lower) main header frame 100 of swather header 12 relative to propulsion unit 14 shown in FIG. 1. If the left and right differences are both within a threshold range, header height controller 18 may produce lift and drop control signals 46 and 48 to cause header positioning system 22 to not change the height of main header frame 100 of swather header 12 relative to propulsion unit 14 shown in FIG. 1.

As discussed above, header height controller 18 may be configurable to transmit lift and drop control signals 46 and 48 directly to header positioning system 22 but, in the embodiment shown in FIG. 5, conditioner 20 may optionally be provided. Conditioner 20 may be configured to intercept lift and drop control signals 46 and 48 produced by header height controller 18 and to produce and transmit conditioned lift control or output signals 50 and conditioned drop control or output signals 52 to header positioning system 22 instead of the control signals. An example of the incorporation of a conditioner 20 into the control system is disclosed in U.S. Pat. No. 10,462,966, issued on Nov. 5, 2019, the entire contents of which is hereby incorporated by reference herein.

FIG. 6A shows a side view of propulsion unit 14 without swather header 12 attached, showing elements of header positioning system 22 (see FIG. 4), in accordance with one embodiment. Referring to FIGS. 6A and 6B, header positioning system 22 includes lift arms 146a, 146b, which may be pivotally connected to propulsion unit 14 at pivot points 162a, 162b via respective pivotal connections 148a, 148b. In the embodiment shown in FIGS. 6A and 6B, pivotal connections 148a, 148b are associated with a height and tilt controlling hydraulic system, including hydraulic cylinders 164a, 164b. Hydraulic cylinder 164a is connected, at one end, to the right end region of transverse beam member 144 of propulsion unit 14 and, at the other end, to lift arm 146a. Similarly, hydraulic cylinder 164b is connected, at one end, to the left end region of transverse beam member 144 of propulsion unit 14 and, at the other end, to lift arm 146b.

The height and tilt controlling hydraulic system may include a “lift” valve, such as, for example, a solenoid-controlled valve, which may be controlled using conditioned lift output signal 50 and a “drop” valve, such as, for example, a solenoid-controlled valve, which may be controlled using conditioned drop output signal 52. When the lift valve is opened and the drop valve is closed, hydraulic cylinders 164a, 164b both retract. Conversely, when the lift valve is closed and the drop valve is opened, hydraulic cylinders 164a, 164b both extend.

As will be explained in more detail below, swather header 12 shown in FIG. 1 is mounted, to lift arms 146a, 146b of propulsion unit 14 shown in FIGS. 6A and 6B, via one more connection/mounting apparatuses generally designated 400 (FIG. 8A) that may be operably located, and provide connection, between lift arms 146a, 146b and main header frame 100. Extension of hydraulic cylinders 164a, 164b causes the front portions of lift arms 146a, 146b (and, thus, main header frame 100 of swather header 12 shown in FIG. 1 when attached to lift arms 146a, 146b) to move downward relative to propulsion unit 14 in the direction of arrow 166. Conversely, retraction of hydraulic cylinders 164a, 164b may cause the front portions of lift arms 146a, 146b (and, thus, main header frame 100 of swather header 12 shown in FIG. 1 when attached to the front portions of lift arms 146a, 146b) to move upwards relative to propulsion unit 14 in the direction of arrow 167.

In various embodiments, each time header positioning system 22 is instructed by header height controller 18 to move, there may be a positioning response time before header positioning system 22 finishes moving and reaches a generally non-transient or fixed position. In various embodiments, the positioning response time may be due to a variety of factors, such as, for example, weight and momentum of feeder house 60 and/or swather header 12, time required for valves of height and tilt controlling hydraulic system to open and/or close after being commanded to do so, and/or float in the height and tilt controlling hydraulic system.

### Lateral Tilt

The height and tilt controlling hydraulic system (header positioning system 22) may also allow for tilting of main header frame 100 relative to propulsion unit 14. Swather header 12 may, thus, be laterally tilted relative to propulsion unit 14 when there is a difference in the side to side slope of the ground surface beneath swather header 12, compared to the side to side slope of the ground surface beneath propulsion unit 14 and the corresponding slope of propulsion unit 14, itself. In some embodiments, this tilting may be achieved by different amounts of extension/retraction of hydraulic cylinders 164a, 164b, which extension/retraction may be shown to cause swather header 12 to tilt transversely about a forwardly directed rotational axis.

In some embodiments, header height controller 18 may be configured to produce tilt control signals in addition to the signals already described, based on the received left and right position signals 40 and 44. The tilt control signals may be configured to control a lateral tilt of main header frame 100 of swather header 12.

The tilt control signal may cause extension of hydraulic cylinder 164a, causing the front portion of lift arm 146a (and, thus, a right side of main header frame 100 of swather header 12) to move downwards in the direction of arrow 169a (FIG. 6B). Conversely, retraction of hydraulic cylinder 164a causes the front portion of lift arm 146a (and, thus, a right side of main header frame 100 of swather header 12) to move upwards in the direction of arrow 167a.

Similarly, the tilt control signal may cause extension of hydraulic cylinder 164b, causing the front portion of lift arm 146b (and, thus, a left side of main header frame 100 of swather header 12) to move downwards in the direction of arrow 169b (FIG. 6B). Conversely, retraction of hydraulic cylinder 164b causes the front portion of lift arm 146a (and, thus, a left side of main header frame 100 of swather header 12) to move upwards in the direction of arrow 167b In some embodiments, the tilt control signal may cause simultaneous extension of hydraulic cylinder 164a, coupled with retraction of hydraulic cylinder 164b, or simultaneous retraction of hydraulic cylinder 164a, coupled with extension of hydraulic cylinder 164b, thereby causing lateral tilt of swather header 12 relative to propulsion unit 14.

In some embodiments, header height controller 18 may be configured to cause the tilt control signals to direct header positioning system 22 to tilt main header frame 100 of swather header 12 together, such that the heights sensed by left and right sensors 32 and 36 are equal. In some embodiments, header height controller 18 may be configured to transmit the tilt control signals directly to header positioning system 22. In some embodiments, header height controller 18 may transmit the tilt control signals to conditioner 20, and conditioner 20 may relay the tilt control signals to header positioning system 22. In some embodiments, conditioner 20 may condition the tilt control signals generally as described above having regard to lift and drop control signals 46 and 48 shown in FIG. 5.

In other embodiments, propulsion unit 14 may be configured such that hydraulic cylinders 164a, 164b only operate in unison, such that hydraulic cylinders 164a, 164b will both move upwards/downwards at the same time and approximately the same distance. In such embodiments, lift arms 146a, 146b do not provide any lateral tilt of swather header 12 and lateral tilt of swather header 12 is only provided by the three-point pivotal connection described herein.

As described above, in some embodiments, lift arms 146a, 146b may be mechanically coupled together such that lift arms 146a, 146b may move upwards and downwards in unison, such that such that hydraulic cylinders 164a, 164b are only operated in unison. In other embodiments where lift arms 146a, 146b may be mechanically coupled together, hydraulic cylinders 164a, 164b may be replaced by a single hydraulic cylinder that causes upwards/downwards movement of both lift arms 146a, 146b. In some embodiments, lift arms 146a, 146b may be interconnected by a transversely extending member (such as a cylindrical tube) that is interconnected to a hydraulic cylinder. Actuation of the hydraulic cylinder may cause rotation of the transversely extending member about a rotation axis of the member, causing the interconnected lift arms 146a, 146b to also raise or lower.

In some embodiments, propulsion unit 14 may be configured such that upwards movement of lift arms 146a, 146b may be affected without controlled retraction of hydraulic cylinders 164a, 164b, but is instead affected by a hydraulic accumulator float and/or a mechanical float (such as a mechanical slotted linkage float). In some embodiments, the hydraulic accumulator float and/or the mechanical slotted linkage float (also known as a dead lift float) allows of lift arms 146a, 146b to “float” about 6 inches upwards within the range of the linkage. The mechanical float may be unaided, or may be aided by a mechanism, such as a hydraulic cylinder.

### Connection/Mounting Apparatuses

Agricultural apparatus 30 may include one or more mounting apparatuses/connecting apparatuses generally designated 400 (FIG. 3B) that each form an interconnection between swather header 12 and propulsion unit 14, and that each may be a releasable connection. With reference to FIG. 8A, agricultural apparatus 30 may include a right-side mounting apparatus/lower connecting apparatus 400A and a left-side mounting apparatus/lower connecting apparatus 400B, with connecting apparatus 400A being transversely spaced from connecting apparatus 400B, and with each being equally spaced from a centre line of main frame 100, that is aligned with an upper connecting apparatus 403.

Mounting apparatuses 400A and 400B may form part of a header suspension system 401, which may provide for shock absorption between swather header 12 (such as between main header frame 100 of swather header 12) and lift arms 146a, 146b of propulsion unit 14. Header suspension system 401 may be any suitable suspension system such as a physical spring suspension system or a fluid suspension system. In some embodiments the header suspension system includes an assembly that includes one or more pressurized expandable, flexible gas (e.g. air) bags which are capable of transmitting loads from one side of the bag to another, with the bags being positioned between members that are movable relative to each other. Pressurized gas/air bags are particularly useful in that they may have a substantially constant spring rate through the desired range of travel/movement of the bag surfaces and the members that are in contact with such surface. The design of the header suspension assembly may be such that the motion of the members engaged by the bag surfaces operates through the constant spring rate zone of the expandable bag.

However, the header suspension system in other embodiments may include an assembly that incorporates other spring type devices, such as coil springs, leaf springs, hydraulic springs, cylindrical helix springs, conical helix springs, disc springs, tension springs, turn springs, spiral springs, tape springs, magnetic springs, torsion springs, or rubber springs. Indeed, the header suspension system may possibly be configured with an assembly may incorporate as a spring device any elastic material or design that has a spring rate.

For example, header suspension system 401 may be a pressurized air suspension system that may include components that are also part of pneumatic system 901 (as described hereinafter in detail with reference to FIG. 13). Pneumatic system 901 may be configured to facilitate transmission of pressurized air through hoses and valves, to and from a plurality of pressurized gas suspension air bags—which may be implemented as a pressurized frame gas suspension mechanism that may comprise a plurality of pressurized frame air suspension air bags 457 (see FIG. 8C)—positioned operationally between main header frame 100 and lift arms 146a, 146b, as described further hereinafter. Pneumatic system 901 may be operable to allow the air pressure in frame air suspension air bags 457 to be selectively maintained at a specified air pressure and also to allow the air pressure in the frame air suspension air bags 457 to be selectively increased and decreased. Such a header suspension system 401 may support main header frame 100 on lift arms 146a, 146b and absorb forces transmitted between (a) main header frame 100 and cutter bar 122 of swather header 12, and (b) propulsion unit 14, such as when cutter bar 122 impacts/encounters a rising portion of ground/terrain surface while moving across the ground/terrain surface.

With reference now to FIGS. 8A-D, 9, 10, 11A-B and 12A-B, mounting/connection apparatuses 400A and 400B, along with upper connecting apparatus/pivotal connection 403, form a generally triangular shaped, 3-point pivotal connection that allows for at least some amount of lateral tilting to the right and left sides, between main header frame 100 and propulsion unit 14 (e.g., the 3-point connection may typically allow header 12 to tilt laterally upwards and downwards in about 7 degrees in either direction from a horizontal/level orientation).

As described above, center reel arm tower 133 (FIGS. 2A and 2B), may also include center reel arm 130, which may be fixedly connected to transverse support beam 112a of main header frame 100 with a reel arm mounting assembly 134 (see FIG. 8B). A propulsion unit mounting bracket 135 may be formed on an upward facing surface of a transverse beam member 144 of propulsion unit 14. Propulsion unit mounting bracket 135 may be pivotally connected to a rear end of a hydraulic cylinder 136. The forward end of hydraulic cylinder 136 may be connected to a bracket 137 with a spherical bearing connection 138 that accommodates the lateral pivoting/tilting of main header frame 100. Bracket 137 is, in turn, connected to transverse support beam 112a of main header frame 100. Whilst not shown in FIGS. 8A and 8B, in embodiments where swather header 12 includes a center reel arm tower 133 with a center reel arm 130, the reel arm 130 can be used for supporting inward ends of respective reel sections. Reel arm tower 133 may be mounted to a suitable structural member of header 12 such as main frame member 112a with a bracket 137 having amounting cleat 139 (see FIG. 8B) thereby connecting center reel arm tower 133 to transverse support beam 112a of header 12. Mounting cleat 139 may be fixedly secured to transverse support beam 112a, such as, for example, with fasteners or by welding.

Hydraulic cylinder 136 may be double/two-way acting and may be fluidly connected to a header hydraulic fluid system 1000 (FIG. 8B) which may constitute part of, and/or be fluidly interconnected to the hydraulic fluid system of propulsion unit 14, such that the extension/retraction of hydraulic cylinder 136 may be operated and controlled. Hydraulic cylinder 136 may be configured and operable to be able to enable main header frame 100 to be tilted forwards/backward (fore/aft) relative to transverse beam member 144 (and interconnected propulsion unit 14). Main header frame 100 including vertical struts 114 that are interconnected to mounting apparatuses 400a, 400b, may pivot forward and backwards about transverse axis X4 on opposed laterally spaced frame connection pivot pins 456 (see FIG. 8C), when hydraulic cylinder 136 is operated (such as by an operator or controller). This enables header 12, for example, when operating in rigid mode, to have the forward/backward angle of the cutting knives on cutter bar 122 relative to the ground surface adjusted. It may be desirable to adjust the fore/aft angle of the cutting knives dependent, for example, on the header height and on what type of crop is being harvested in a particular situation.

In other embodiments, hydraulic cylinder 136 may be connected to another part of propulsion unit 14, such that operation of hydraulic cylinder 136 still affects forwards/backwards tilting of main header frame 100 relative to propulsion unit 14.

With reference to FIGS. 8E and 8F, another embodiment of the upper connecting apparatus/pivotal connection 403, upper pivotal connection 1403 is depicted, which provides an interconnection between transverse beam member 144 of propulsion unit 14 and transverse support beam 112a of main header frame 100. In this embodiment, the rear end of hydraulic cylinder 136 may be pivotally connected to propulsion unit mounting bracket 135 (not shown in FIGS. 8E and 8F but shown in FIG. 8B) at pivotal connection 1143 by a pin 1146 (not shown in FIGS) which is received in opening 1148. The forward end of hydraulic cylinder 136 may be connected to an upper portion 1137b of a bracket 1137 with a spherical bearing connection 1138 (which may be similar to spherical bearing connection 138 described above), that accommodates the lateral pivoting/tilting of main header frame 100. Bracket 1137 also includes a lower portion 1137a, fixedly connected to a mounting cleat 1139, which is in turn fixedly connected to transverse support beam 112a. Upper portion 1137b of bracket 1137 is at a forwards end pivotally connected (via pivotal connection 1145) to lower portion 1137a and at the opposite, rearwards end fixedly connected to the forward end of hydraulic cylinder 136 via spherical bearing connection 1138.

Upper portion 1137b may be pivotally movable (about pivotal connection 1145) relative to lower portion 1137a between a first (fully lowered) position shown in FIG. 8E and a second (fully raised) position shown in FIG. 8F). Upper portion 1137b may be fixed in the first (lowered) position by a locking pin 1153, which is received in axially aligned holes 1147 and 1149 in respective lower portion 1137a and upper portion 1137b of bracket 1137.

Bracket 1137 provides a degree of flexibility to pivotal connection 1403 to assist with connecting swather header 12 to propulsion unit 14. In operation, when connecting swather header 12 to propulsion unit 14, locking pin 1153 may be removed such that upper portion 1137b may be raised or lowered (via pivotal movement relative to lower portion 1137a), such that rear end of upper portion 1137b may be bought into alignment with the forward end of hydraulic cylinder 136 and secured together with locking pin 1151. Once swather header 12 to propulsion unit 14 and interconnected at pivotal connection 1403, locking pin 1153 can be reinserted to fix the position of upper portion 1137b relative to lower portion 1137a.

Swather header 12 and propulsion unit 14 may be connected/disconnected at pivotal connection 1403 either by inserting/removing locking pin 1151 or at pivotal connection 1143 by inserting/removing locking pin 1146.

In other embodiments, upper portion 1137b and hydraulic cylinder 136 may be bought into alignment via retraction/extension of hydraulic cylinder 136, which may be controlled by an operator on propulsion unit 14.

With respect to the frame/propulsion unit suspension connection, spherical bearing connection 138 of upper pivotal connection 403 allows for lateral tilting to the right and left sides, between main header frame 100 and propulsion unit 14. Right- and left-side mounting apparatuses 400A, 400B, which provide the other two pivotal connections of the 3-point pivotal suspension connection between main header frame 100 and propulsion unit 14 are also illustrated in FIG. 8A. The associated arrangements of the components of main header frame 100 for right-side mounting apparatus 400A and left-side mounting apparatus 400B may be constructed in the same manner. Accordingly, only right-side lower pivotal connection 400A is depicted and described herein in detail.

With particular reference to FIGS. 8C and 8D, representative right-side mounting/connection apparatus 400A is illustrated. As part of propulsion unit 14, lift arm 146a extends generally longitudinally forwards from propulsion unit 14, and generally perpendicular to transverse support beam 112a of main header frame 100. The forward distal end portion 152a of lift arm 146a is received within a lift boot 450. Lift boot 450, which may also be known as a lift boot adaptor or lift arm boot adaptor, is configured to receive, engage and retain the forward end of lift arm 146a, such that lift boot 450 will move with movement of lift arm 146a. The connection between lift boot 450 and the forward end portions 152a, 152b of the lift arms 146a, 146b respectively, may be releasable connections.

Lift boot 450 may be made from any suitably strong and appropriately configurable material, such as a hardened steel, such as ASTM A36 steel.

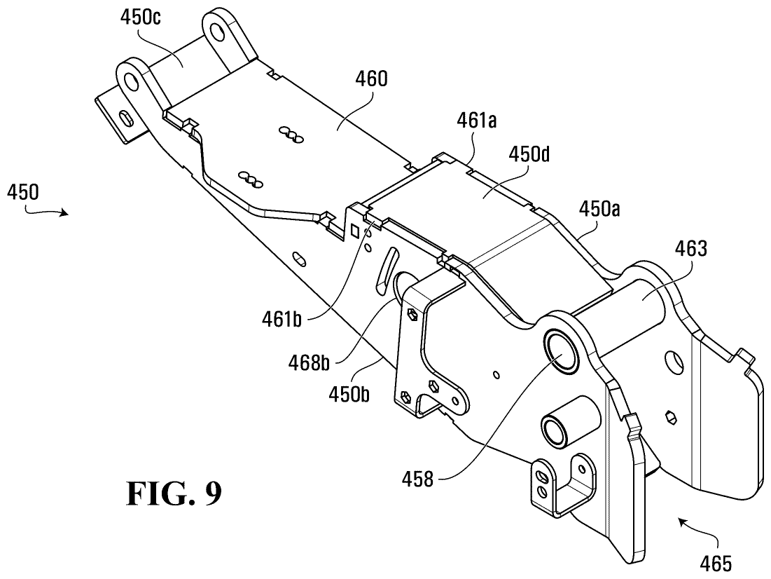

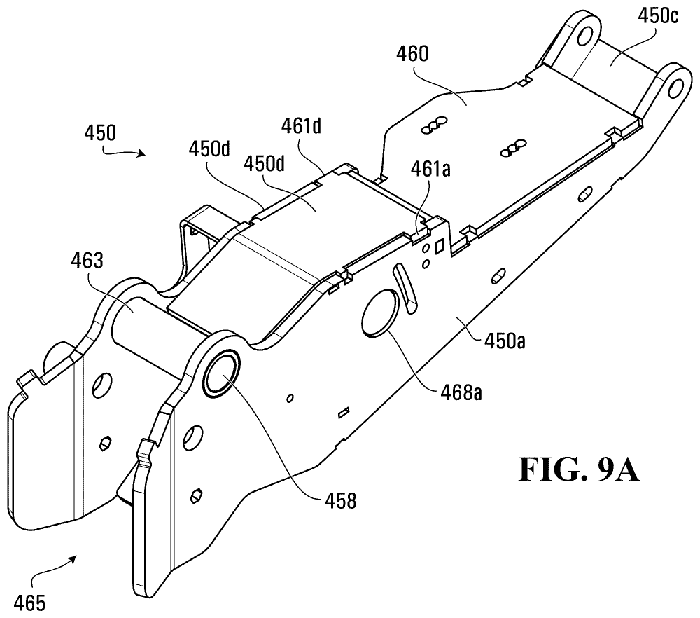

Lift boot 450 is shown in isolation in FIGS. 9 and 9A and includes a pair of transversely spaced, generally parallel orientated in relation to each other and forwardly directed, vertically and longitudinally extending support members 450a, 450b; generally rectangular, generally transversely and longitudinally upper air bag support member 460 and support plates 450c and 450d that are fixedly connected to support members 450a, 450b. Support members 450a, 450b and support plates 450c, 450d define an opening 465 to slidingly and engagingly receive the forward end of lift arm 146a therewithin. Support members 450a, 450b and support plates 450c, 450d may form part of an integral weldment and may be formed from the same suitably strong material.

A lift arm securing pin 466 (FIG. 8D) extends between opposed openings 468a, 468b in support members 450a, 450b, respectively and is secured to lift boot 450, such as by welding. When the forward end of lift arm 146a is received within opening 465, lift arm securing pin 466 is received in lift arm pin receiving channel 154a (FIG. 6C), such that a lower portion of lift arm securing pin 466 is cradled by lift arm pin receiving channel 154a, thereby releasably securing lift arm 146a relative to lift boot 450.

Lift arm securing pin 466 may be made from any suitably strong and configured material, such as hardened steel (such as ASTM A36 steel).

Lift arm securing pin 466 may be secured in lift arm pin receiving channel 154a by a secondary locking mechanism. An example embodiment of the secondary locking mechanism is shown in FIG. 6C and may include a sliding bar 156 that includes two forwardly extending and spaced apart rods 158a and 158b which are interconnected at their rear ends by a connecting portion 160. The forward ends of rods 158a and 158b are received in respective openings 159a and 159b in lower end portion 152a of lift arm 146a. Sliding bar 156 is slidably moveable in directions 161a and 161b (FIG. 6C). When lift arm securing pin 466 is inserted into opposed openings 468a, 468b in support members 450a, 450b, sliding bar may be moved in direction 161a such that the forwards ends of rods 158a and 158b fit around the upper portion of lift arm securing pin 466 on the opposite side to lift arm pin receiving channel 154a, such that lift arm securing pin 466 is retained by the combination of lift arm pin receiving channel 154a and sliding bar 156. Thus, the lift arm 146a is secured in place and is unable to move relative to lift boot 450 until the secondary locking mechanism is removed/released.

In other embodiments, the secondary locking mechanism may, additionally or alternately include one or more transversely extending pins that are inserted thorough both of support members 450a, 450b proximal to (e.g., above or below) lower end portion 152a of lift arm 154a to secure lift arm 146a in place relative to lift boot 450.

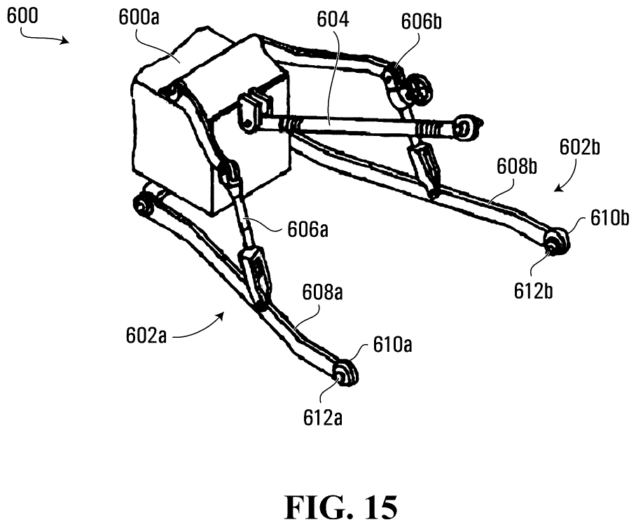

In other embodiments, lift arm securing pin 466 may be inserted through a transversely extending hole in lift arm 146a to releasably secure lift boot 450 to lift arm 146a. An example of this configuration with be described below with respect to FIG. 15. In such embodiments, lift arm securing pin 466 may be a bolt that is inserted through opposed openings 468a, 468b in support members 450a, 450b and the hole in lift arm 146a, before being secured by a nut.

Turning back to FIGS. 8C and 9 and 9A, fixedly positioned and extending between rearwardly located pin mount openings 458 in inward facing surface areas of support members 450a, 450b is a sleeve 463. Sleeve 463 receives a header suspension pivot pin 451 (FIG. 8C) that is operable to rotate within sleeve 463. Fixedly attached to header suspension pivot pin 451 and operable for rotation/pivoting movement with header suspension pivot pin 451 is a pivot arm 452 (FIG. 8C). Pivot arm 452 may thus angularly pivot about a transverse pivot axis X2 of pivot pin 451 to some extent, relative to lift boot 450 in a first angular direction.

Header suspension pivot pin 451 may be made from any suitably strong and configured material, such as a hardened steel (e.g. induction hardened chrome steel bar).

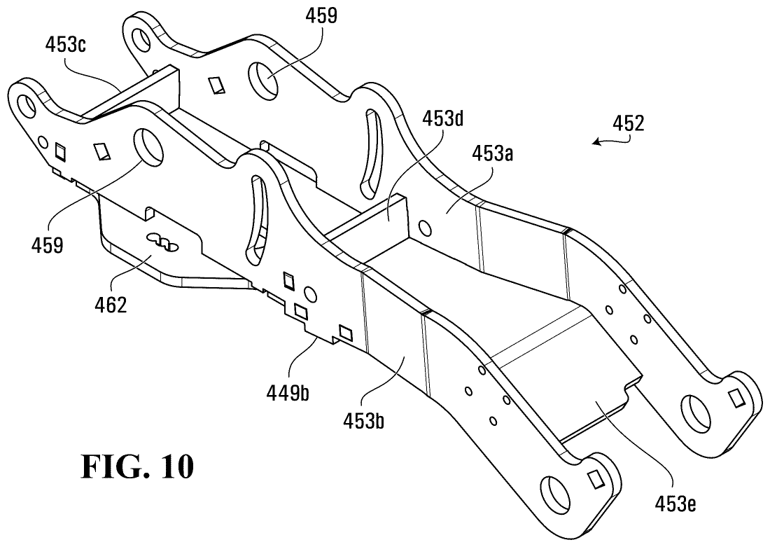

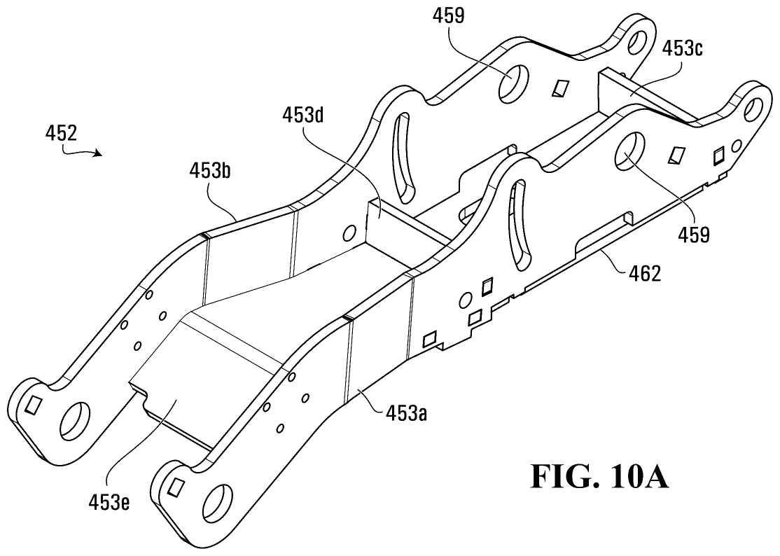

Pivot arm 452 is shown in isolation in FIGS. 10 and 10A and may include generally longitudinally and vertically extending pivot arm side plates 453a, 453b; support plates 453c, 453d, 453e and upper base plate 462. Pivot arm side plates 453a, 453b are oriented generally parallel to each other, are transversely spaced, and extend forwardly and are fixedly attached to opposed side edges of generally vertically and transversely extending support plates 453c, 453d, and to opposed side edges of generally longitudinally and transversely extending support plate 453e. Extending downwardly, each of pivot arm side plates 453a, 453b has a respective pivot arm side plate bottom stop 449a, 449b. Upper base plate 462 extends transversely and forwardly between and is fixedly attached to transversely spaced pivot arm side plates 453a, 453b. Transversely extending support plates 453c, 453d, 453e that are received in slots of pivot arm side plates 453a, 453b in order to provide additional strength and rigidity to pivot arm 452. The components of pivot arm 452 may form part of an integral weldment and may be formed from the same suitably strong material, such as a hardened steel (such as ASTM A36 steel).

With reference to FIGS. 8C and 8D, at a forward end region, extending between forward end surface areas of transversely spaced pivot arm side plates 453a, 453b is a transversely oriented cylindrical rubber bushing 455. Within rubber bushing 455 is a transversely oriented header frame connection pivot pin 456, which extends through rubber bushing 455 between openings 459 in spaced pivot arm side plates 453a, 453b.

Rubber bushing 455 is fixedly attached to a lift horn member 454, and lift horn member 454 may be operable for rotation/pivoting movement with rubber bushing 455 about axis X4 (FIG. 8C) of header frame connection pivot pin 456 relative to pivot arm 452. Lift horn member 454 extends generally upwards and rearwards and is fixedly connected, such as by welding at an upper end thereof, to inboard vertical struts 114 of main header frame 100. Thus, under certain loading conditions, lift horn member 454 can angularly pivot to some extent about pivot pin 456 relative to pivot arm 452, in a second angular amount.

Header frame connection pivot pin 456 may be made from any suitably strong and configured material, such as hardened steel (e.g. induction hardened chrome steel bar).

Rubber bushing 455 also provides a degree of lateral flexibility of mounting apparatuses 400A, 400B in response to lateral/twisting forces applied to mounting apparatuses 400A, 400b during operation, for example caused by lateral tilting of swather header 12 (as will be explained in more detail below). This allows lift horn member 454 to be formed as a rigid member, as rubber bushing 455 may accommodate certain lateral/twisting forces applied to mounting apparatuses 400A, 400B.

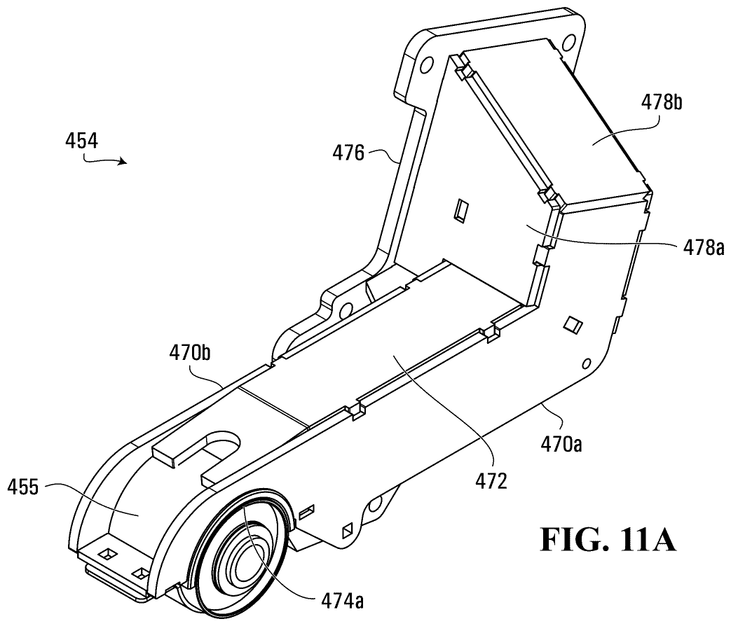

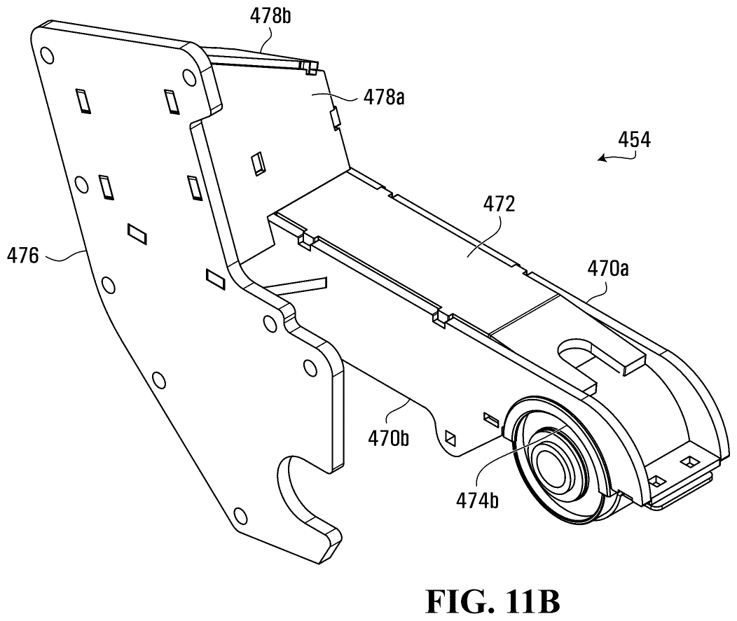

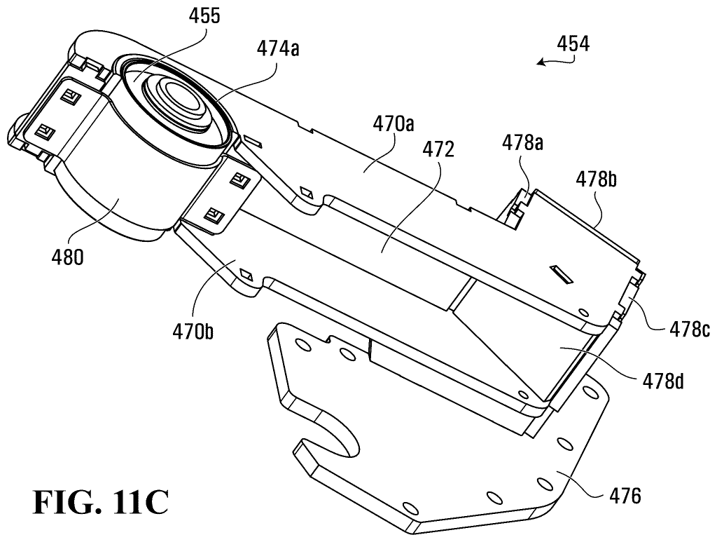

Lift horn member 454 is shown in isolation in FIGS. 11A to 11C and may include a pair of transversely spaced, longitudinally and vertically extending side plates 470a, 470b and a generally rectangular, longitudinally and transversely extending top plate 472, which together may form a generally U-shaped member. At the forward end of side plates 470a, 470b, rubber bushing 455 is received within generally semicircular cut out portions 474a, 474b respectively and may be secured underneath such as by a strap 480 that may be secured to an underneath surface such as an underneath surface of top plate 472 (FIG. 11C).

Side plates 470a, 470b may be generally L-shaped, extend rearwards and upwards from their forward ends and fixedly connect with/attach to, a transversely spaced and vertically orientated header connection plate 476 via plates 478a, 478b, 478c, 478d. The components of lift horn member 454 may form part of an integral weldment and may be formed from the same suitably strong material. The interconnection of side plates with plates 478a, 478b, 478c, 478d and header connection plate 476 provide strength and rigidity, which may be beneficial due to various forces (e.g., torsional/twisting forces) that may be transmitted from swather header 12 to the mounting apparatuses 400A, 400B during operation of agricultural apparatus 30.

Header connection plate 476 may be fixedly attached affixed to an outer vertical face portion of vertical strut 114 of main frame 100, such as by bolting or welding. In other embodiments and, for example, depending on the configuration of main header frame 100, header connection plate 476 may be attached to another portion of main frame 100 or other portion of swather header 12.

Lift horn member 454 may be made from any suitably strong and configured material, such as a suitable steel, such as ASTM A36 steel.

In other embodiments, lift horn member 454 may be configured differently. For example, lift horn member 454 may have a different shape depending on location of a connection between lift horn member 454 and main header frame 100 of swather header 12.

One frame air suspension air bag 457 (or in other embodiments a plurality of frame air suspension air bags 457) may be operationally located between main header frame 100 and propulsion unit 14, on each side of axis Y1 (FIG. 3A) of swather header 12.

In general, each of frame air suspension air bags 457 may have an internal air volume that is generally larger than the volume of cutter bar float air bags 124 (and of gauge wheel air bags 557 described below) when subjected to the same internal air pressure (e.g. 100 psi). For example, each frame air suspension air bags 457 may have an internal air volume that is about two to three times as large as the volume of cutter bar float air bags 124 (and two to three times as large as the volume of each of gauge wheel air bags 557 described below) when subjected to the same internal air pressure (e.g., 100 psi).

It should be noted that, in some embodiments, the combined internal volume of the one or more, gauge wheel bags 557 is greater than the internal volume of the one or more frame air suspension air bags 457 on each side, when subjected to the same internal air pressure. In other embodiments, it may be desirable to provide for a significantly greater combined internal volume of the one or more, gauge wheel bags 557 than the internal volume of the frame air suspension air bag(s) 457, when subjected to the same internal pressure. Providing a greater internal volume of air for gauge wheel bag(s) 557 may provide for a more aggressive/active response of frame air suspension air bags 457 and the lift/tilt force imparted on main header frame 100.

Frame air suspension air bag(s) 457 may be located between the bottom facing surface of upper base plate 462 on an upper side and the top facing surface of air bag support member 460 that extends forwardly and laterally between laterally spaced support members 450a, 450b.

Each frame air suspension air bag 457 may have an upper integral rigid plate portion that may be fixedly secured to plate member 462 with a bolt mechanism (not shown) and may be held in lateral position relative to plate member 462 with guide bolts passing through an opening in plate member 462. Bolt holes in the plate portion of frame air suspension air bag 457 can be appropriately sealed in a known manner from the inner pressurized air cavity of the bag (e.g., blind mounting nuts/bolt holes). The rigid upper plate portion may also provide for an air inlet/outlet, which can be pneumatically connected to pneumatic/air hose 903 for the communication of pressurized air.

Each frame air suspension air bag 457 may include a generally tubular side wall made of a resiliently expandable material, such as a rubber. The side wall material may be permanently bonded to/crimped with metal, generally cylindrical, flat end plates at opposite ends. Each frame air suspension air bag 457 may be sized, configured and positioned to be able to exert appropriate forces/pressures on the surface of upper base plate 462 and lower air bag support member 460 when the interior cavity of frame air suspension air bag 457 is pressurized by pneumatic system 901. An example of a known type of air bag that might be employed as frame air suspension air bag 457 is the model FS 200-10 CI Single Convolution Air Actuator made by ContiTech AG and/or one of its affiliated companies or a comparable AIRSTROKE™ actuator made by Firestone Industrial Products, LLC. Such a frame air suspension air bag may have upper and lower plates with a diameter of about 6.34 inches and the interior of the bag may have operating internal volumes of between about 86 cubic inches to 160 cubic inches over operating pressures of between about 30/40 psi and 120 psi.

Each frame air suspension air bag 457 may, through a plurality of hoses and valves, be in pneumatic communication with, and be a part of, pneumatic system 901. Each frame air suspension air bag 457 may, like cutter bar float air bags 124, and gauge wheel air bags 557 (FIG. 13) also be inflated and deflated through pneumatic/air hose 903 (e.g., FIG. 8C) by pneumatic system 901 over a range of air pressures, such as, for example, between 30 psi and 100 psi. Frame air suspension air bags 457 may be sized, configured and positioned to be able to exert appropriate forces/pressures on the bottom facing surfaces of pivot arm side plates 453a, 453b and upper base plate 462 on one side, and the top facing surface of lower air bag support member 460 on the other side, when the interior cavity of frame air suspension air bag 457 is pressurized by pneumatic system 901.

The level of the air pressure within frame air suspension air bags 457 can be varied, including by operation of pneumatic system 901. This can influence how much, if any, of the weight of header 12, including main header frame 100 and cutter bar 122, is transferred between main header frame 100 and lift arms 146a and 146b and the manner in which such weight is transferred. In some modes of operation (e.g., rigid mode), main header frame 100 (and components supported thereon) may be spring supported on lift arms 146a and 146b and on gauge wheel/stabilizer apparatuses 500; in other modes (e.g., flex mode) there may be near zero spring action/support in the connection between main header frame 100 and propulsion unit 14, and gauge wheel apparatuses 500 may also provide little or no support of main header frame 100 and components supported thereon during normal operation on level ground.

The level of air pressure within frame air suspension air bags 457 can also influence how much of, and whether, and the manner in which, any other forces (beyond the weight of the frame and its components) are transmitted between main header frame 100 and lift arms 146a and 146b on the right and left sides of the swather header 12, including through frame air suspension air bags 457.

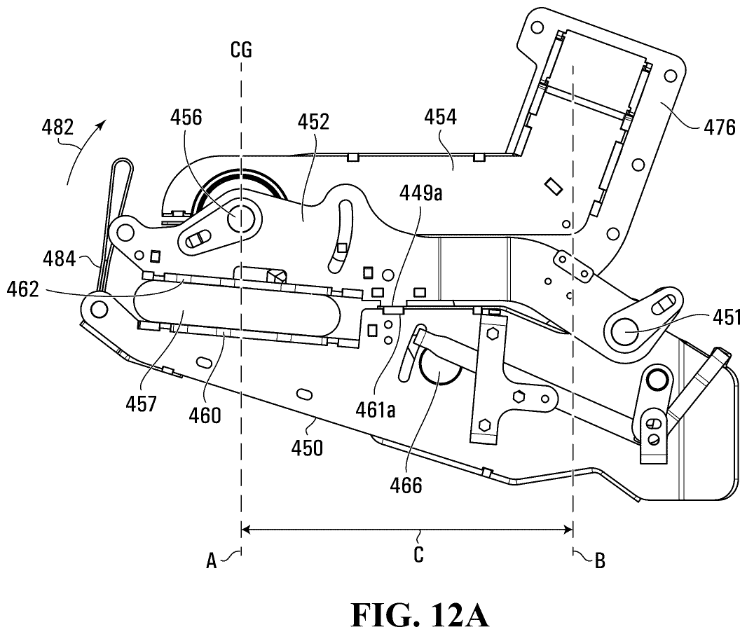

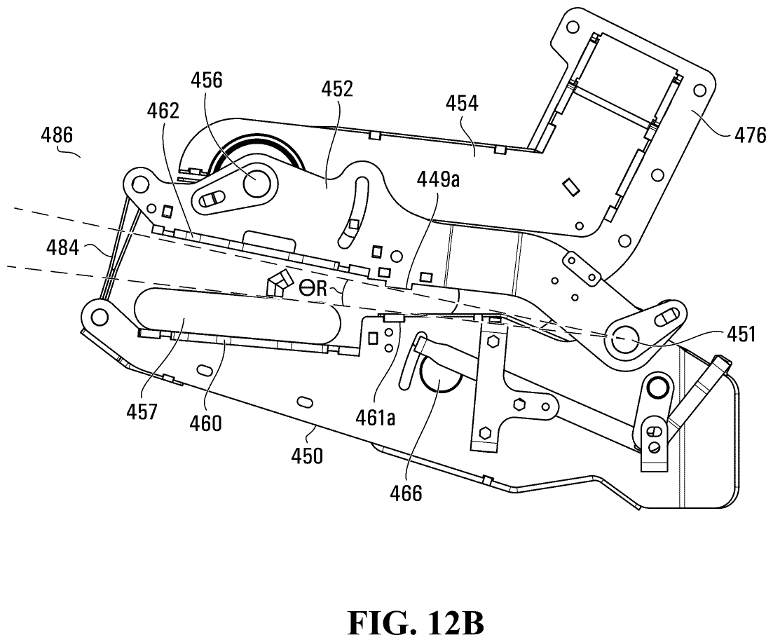

If right side and left side frame air suspension air bags 457 are both inflated to a relatively high air pressure by pneumatic system 901 (e.g., to an air pressure near 100 psi) then frame air suspension air bags 457 will have expanded and on both the right and left side of swather header 12, pivot arm 452 (including pivot arm side plates 453a, 453b, upper base plate 462 along with lift horn member 454) will be forced to angularly pivot about axis X2 (FIG. 8C) relative to support members 450a, 450b of lift boot 450 in the direction indicated by arrow 482 from a lowermost position, shown in FIG. 12A, towards an uppermost position, shown in FIG. 12B. As will be recognized, the degree of angular pivoting movement about axis X2 will be dependent on the magnitude of expansion (and therefore the change in pressure) of frame air suspension air bags 457. The movement upwards of lift horn members 454 on both the left side and the right side of swather header 12 will then result in the upwards movement of the interconnected main header frame 100 and cutter bar 122 on the right and left sides of swather header 12 relative to lift arms 146a, 146b of propulsion unit 14. The air pressure level in each of the right and left side frame air suspension air bags 457 will typically increase to the same increased level.

As air frame air suspension air bags 457 expand, pivoting upwards movement of pivot arm 452 relative lift boot 450 may continue, with the corresponding pivoting lift horn member 454 and pivot arm 452 relative to each other may also continue, until either air frame air suspension air bags 457 reach a maximum expanded volume or until the further movement of pivot arm 452 and lift horn member 454 is restricted by a travel limiting feature, for example, a travel limiting strap 484. As shown in FIGS. 12A and 12B, travel limiting strap 484 may be connected to the forward ends of lift boot 450 and pivot arm 452 to the restrict upwards movement of pivot arm 452 and lift horn member 454 (and, therefore, main header frame 100 and cutter bar 122) to the position shown in FIG. 12B. This range of movement may be selected to a desired range by adjustment and/or selection of the size of travel limiting strap 484.

Conversely, if both right side and left side frame air suspension air bags 457 are both initially inflated to a relatively high air pressure by pneumatic system 901 (e.g., to an air pressure near 100 psi) and then pressure in right side and/or left side frame air suspension air bags 457 is then decreased, frame air suspension air bags 457 will deflate and contract. As this occurs, pivot arm 452 (including pivot arm side plates 453a, 453b, upper base plate 462 along with lift horn member 454 will be forced to pivot about axis X2 (FIG. 8C) relative to support members 450a, 450b of lift boot 450 in the direction indicated by arrow 486 in FIG. 12B from the uppermost position shown in FIG. 12B towards the lowermost position shown in FIG. 12A. As will be recognized, the degree of pivoting movement about axis X2 will be dependent on the magnitude of contraction (and therefore the change in pressure) of frame air suspension air bags 457. The movement downwards of lift horn members 454 on both the left side and the right side of swather header 12 will then result in the downwards movement of main header frame 100 and cutter bar 122 on the right and left sides of swather header 12 relative to lift arms 146a, 146b of propulsion unit 14. The air pressure level in each of the right and left side frame air suspension air bags 457 will typically decrease to the same decreased level.

In some embodiments, the range for movement, OR (FIG. 12B) of pivot arm along with lift horn member 454 will be in the range of about 5 to about 25 degrees and preferably about 15 degrees.

The overall weight of main header frame 100 (and of the components that may be supported thereon, such as the draper decks 118a, 118b and cutter bar 122) may be substantially evenly distributed in a transverse side-to-side direction across main header frame 100, such that the positioning of main header frame 100 on lift arms 146a, 146b does not, if not subjected to any forces beyond gravity, result in an imbalance of the forces/moments. However, the three-point pivotal connection may allow for some lateral and/or forward and backwards adjustments of the position of frame air suspension air bags 457 in order to accommodate left/right side load imbalances. This allowance for adjustments be shown to allow for a uniform pneumatic system pressure to still be employed in pneumatic system 901 between all the right side and left side air bags, while accommodating some level of imbalanced weight loading on the one lateral side of swather header 12 compared to the other lateral side.

The positioning of frame air suspension air bags 457 between lift boot 450 and pivot arm 452 determines a lift point (the forward/aft vertical position line of which is roughly designated A in FIG. 12A) of pivot arm 452 (and interconnected lift horn member 454 and main header frame 100). The lift point A may be in fore/aft alignment with pivot pin 456. The fore/aft longitudinal direction center of gravity CG of swather header 12 may be located in a region generally longitudinally forward of the attachment location where header connection plate 476 of horn member 454 attaches to main header frame 100 at vertical strut 114 (designated generally by line B in FIG. 12A). In some embodiments, it may be beneficial to locate lift point A at or close to the fore/aft center of gravity of swather header 12. In part as a result of this, lift point A may be located at a distance C forwards of attachment point B, such as in the range of 6-48 inches forwards of point B (which may be selected depending on the specific design of the main frame and other components of header 12). The location of lift point A relative to swather header 12 and/or distance C may be selected based on the configuration of header 12, for example based on the length, width, weight distribution and the positioning of the components, particularly the heavy components (for example knife and reel drive components) of header 12. Therefore, in other embodiments, the positioning of the fore/aft center of gravity of swather header 12 may be located considerably further forwards (or backwards) and the position of lift point A may be correspondingly adjusted to be closer to the fore/aft center of gravity CG of swather header 12, such as though variation of the dimensions of the components of mounting apparatuses 400A, 400B and/or changing the location of the connection point between lift horn member 454 and main header frame 100. In an example embodiment, the fore/aft center of gravity of swather header 12 may be about 20 inches rearwards from cutter bar 122.

The fore/aft location of lift point A relative to swather header 12 and its fore/aft center of gravity CG may be selected to ensure that swather header 12 has acceptable “pitch stability”, such that swather header 12 does not pitch forwards (pivoting about header frame connection pivot pin 456) when swather header 12 is lifted. The pitch stability of swather header 12 may beneficially maintain substantially a constant load (i.e., “load stability”) on hydraulic cylinder 136 of upper pivotal connections 403/1403 (FIGS. 8A, 8B, 8E).

As an aside, the transverse positioning of the lift arms 146a, 146b and corresponding mounting apparatuses 400a, 400b, can be selected to provide for relatively balanced side to side loads acting on lift arms 146a, 146b.

In operation, generally downward acting static and/or dynamic loads (e.g. some portion of component weight) from header 12 may be transferred (through main header frame 100) to header connection plate 476 of lift horn member 454; and then though lift horn member 454 to pivot arm 452 at the connection with pivot pin 456.

It may be the case that substantially all the downward weight of the header 12 acts vertically downward with the centre of gravity vertically/longitudinally aligned with pin 456 and the centre of frame suspension gas bag 457. To the extent that there may be some force acting downwards longitudinally between A and B (FIG. 12A) the upper pivotal connections 403/1403 (FIGS. 8A, 8B, 8E) may serve to exert a counter-balancing force on frame 100 such that lift horn 454 will be constrained in its pivotal movement around pin 456 (ie. constrained in clockwise movement around pin 456 in FIG. 12A). It should be noted that if the weight of the swather header 12 acting through lift horn 454 is acting to pivot lift horn downwards towards pivot arm 452, there would normally be no supporting contact between a part of lift horn 454 and a part of pivot arm 452, rearward of pivot pin 456, unless perhaps in a situation of being at the bottom of the range of pivoting motion between when frame air suspension bag 457 is fully compressed. However, this would be an abnormal situation and may be due to a lower than desired air pressure in the frame air suspension bag 457.

A majority of the downwards acting static and/or dynamic loads may be transferred from pivot arm 452 to lift boot 450 via upper base plate 462, through frame air suspension air bag 457 and into air bag support member 460. By passing through air suspension bag 457, that load being transferred may be one or more of, supported, isolated, resisted, absorbed, cushioned, and dampened.

Most of the load from pivot arm 452 may be transmitted to lift boot 450 though frame air suspension bag 457 (and vice versa). When frame air suspension air bag 457 is inflated to a low level (for example as shown in FIG. 12A), a portion of the loads may be transferred from/between pivot arm 452 to/and lift horn member 454 via side plate bottom stop 449a, 449b. The loads transferred to lift boot 450 are transferred though the lift boots 450 to the interconnected lift arms 146a or 146b. Lift arms 146a, 146b then carry those loads and transfer the loads to the main body of the propulsion unit 14. It should be noted that while most of the force transferred to the lift arms 146a, 146b will be vertically upward/downward acting forces (e.g. some or all of the weight of swather header 12), forces in transverse and longitudinal directions imparted to header 12 may also be transferred through the mounting apparatuses 400a, 400b, to lift arms 146a, 146b, although the magnitude of such forces will typically be much less than the weight of the swather header 12.

Lift boot 450, acting as an extension of the power unit lift arms 456a, 456b may thus always carry the majority of the un-sprung load/mass of swather header 12 to the supporting body of the propulsion unit 14 [minus load/mass carried by ground engaging header elements [cutterbar and/or gauge wheels]. The upper pivotal connections 403/1403 typically carry no downward/upwardly directed loads and generally act as position locators only]. Also, header suspension pivot pin 451 (FIG. 8C) is primarily a locator pin as the majority of the load is carried directly through the frame air suspension bags 457, regardless of their pressure level of inflation.

The pressure in the right and left frame air suspension air bags 457 may both be set by pneumatic system 901 to a high level (e.g., near 100 psi) at the same time as cutter bar float air bags 124 are also set to the same high air pressure (e.g., 100 psi) so that cutter bar 122 is in rigid mode, as referenced above, and is generally laterally level (i.e., no lateral tilt) relative to propulsion unit 14 and the ground surface. In the rigid mode of cutter bar 122 (and of swather header 12) and with cutter bar 122 set for a cutting height above the ground surface level, frame air suspension air bag(s) 457 on both sides of center axis Y1 (FIG. 3A), and lift arms 146a, 146b beneath, will typically be carrying a large portion of the weight of main header frame 100 and cutter bar 122 and other components supported on main header frame 100. In rigid mode of cutter bar 122, each air frame suspension air bag 457 may be sufficiently expanded such that main header frame 100 behaves like it is spring loaded on lift arms 146a, 146b (and on stabilizer apparatuses 500 as referenced below).

Main header frame 100 may be in rigid mode of cutter bar 122 and swather header 12 may be positioned relative to lift arms 146a, 146b near to, but slightly above, the bottom/lowermost position of its range of upward/downward movement (i.e., close to or as shown in FIG. 12A). The result can be that main header frame 100 rests and is supported “lightly” on lift arms 146a, 146b such that a relatively small additional upward force is required to lift main header frame 100 upwards (e.g., about 50 lbs. upwards force at either end of main header frame 100 can cause a frame of 40 ft in width to be lifted upward relative to lift arms 146a, 146b). This is because frame air suspension air bags 457 have the capability to further expand and, during further expansion of frame air suspension air bags 457 during upward movement of main header frame 100 relative to lift arms 146a, 146b, frame air suspension air bags 457 can continue to provide a significant upward force that is only a relatively small amount less than the downward weight of main header frame 100 and the swather header 12 components supported thereon. Thus, a relatively small additional upward force is required to start upward movement of main header frame 100 relative to lift arms 146a, 146b.

Each frame air suspension air bag 457 can be configured such that each frame air suspension air bag 457 is not fully expanded when the pressure in the right and left frame air suspension air bags 457 have both been set by pneumatic system 901 to a high level (e.g., 100 psi). Then, any further increase in pressure delivered to either of right or left side frame air suspension air bag 457 will allow and may result in upward movement of pivot arm side plates 453a, 453b and upper base plate 462 along with lift horn member 454, which upward movement will raise that particular side of main header frame 100 and cutter bar 122 (i.e., it will tilt upwards on the that side of swather header 12) relative to lift arms 146a, 146b, as main header frame 100 pivots about upper pivot connection 403 of the three-point connection.

If there is an increase in air pressure of frame air suspension air bags 457 beyond the high level set by pneumatic system 901, with the same level of increase on both the right and left side of the header, this will allow and may result in further upward movement of pivot arm side plates 453a, 453b and upper base plate 462 along with lift horn member 454, on both sides, which upward movement may be shown to result in both sides of main header frame 100 and cutter bar 122 being raised further but with main header frame 100 remaining level (i.e., no lateral side tilting of the header).

If the pressure in the right and left frame air suspension air bags 457 is, as described above, set by pneumatic system 901 to a high level (e.g., 100 psi) at the same time as the cutter bar float air bags 124 are also set to the same high air pressure (e.g., 100 psi) so that cutter bar 122 is in rigid mode as referenced above, then if a significant downward force acts on main header frame 100 and cutter bar 122 beyond their weight (e.g., as a consequence of a limited time, abrupt downward movement in elevation of propulsion unit 14 that is transmitted to main header frame 100 through mounting apparatuses 400A, 400B), then any additional downward forces acting on main header frame 100 and cutter bar 122 can be cushioned/absorbed/dampened by frame air suspension air bags 457 when transmitting the downward acting forces back to propulsion unit 14.

If the pressure in the right and left frame air suspension air bags 457 is, as described above, set by pneumatic system 901 to a high level (e.g., 100 psi) at the same time as cutter bar float air bags 124 are also set to the same high air pressure (e.g., 100 psi) so that cutter bar 122 is in rigid mode as referenced above, and with main header frame 100 resting at the lower end of its range of movement relative to lift arms 146a, 146b (i.e., as shown in FIG. 12A), then if a significant upward force acts upwardly on one transverse side of main header frame 100 and cutter bar 122 (e.g., due to an increase in the level of the ground surface that results in contact between one side of cutter bar 12 and the ground surface), then a delivery of more pressurized air may be expected to maintain, or possibly increase, the air pressure in frame air suspension air bag(s) 457 on that side, in order to be able to transmit an additional upward acting force on pivot arm side plates 453a, 453b, upper base plate 462 along with lift horn member 454, to, thereby, force them to pivot about axis X2 relative to support members 450a, 450b (and interconnected lift arms 146a, 146b). If this additional pressurized air can be delivered to frame air suspension air bags 457, then the movement upwards of lift horn members 454 on the one side of swather header 12 will result in an upwards lifting force on main header frame 100 and cutter bar 122 on that side of swather header 12 relative to lift arms 146a, 146b, resulting in an assistance lifting force being delivered by frame air suspension air bag 457 on that side of swather header 12 to assist in achieving the upward tilt of main header frame 100 and other components of swather header 12 attached to main header frame 100, such as cutter bar 122 and draper decks 118a and 118b. It will be appreciated that the opposite force generated by the increase in pressurized air to one frame air suspension air bag 457, may be transferred through lift arms 146a, 146b and propulsion unit 14, and then transferred to the ground surface.

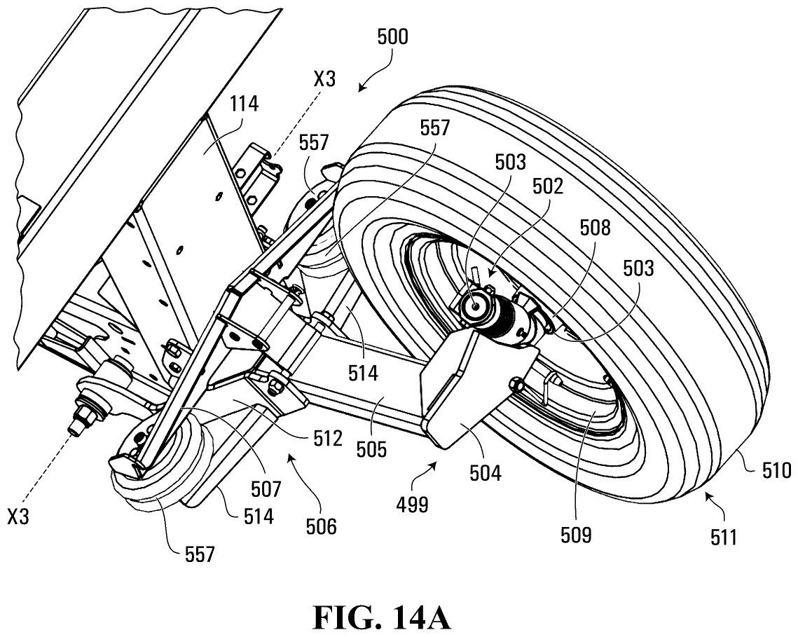

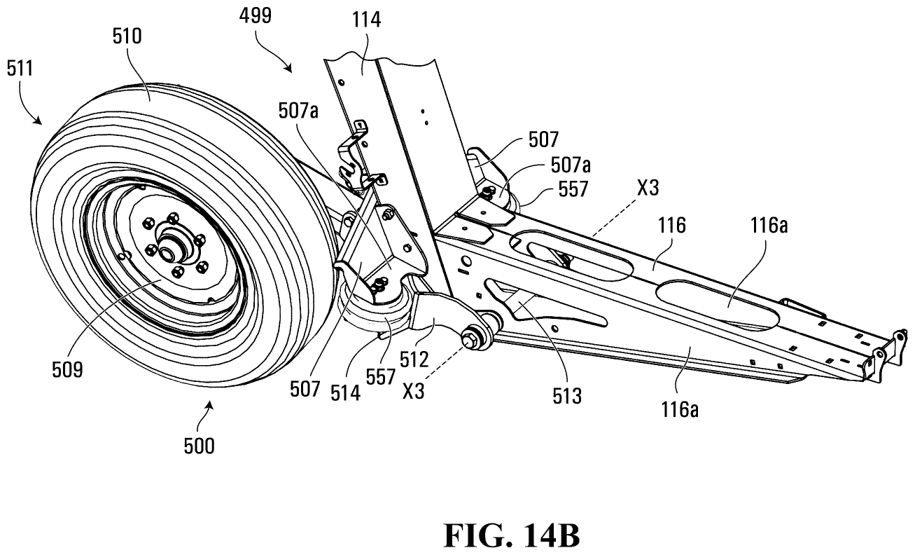

In the present embodiment, the delivery of additional pressurized air to frame air suspension air bag 457 on a side of swather header 12, can be facilitated by delivering pressurized air from stabilizer apparatus 500 on that side of swather header 12. Increasing the air pressure in frame air suspension air bag 457 on one side relative to frame air suspension air bag 457 on the opposite transverse side, can be accomplished by functionally linking components of stabilizer apparatus 500 on one side to frame air suspension air bags 457 on the same side of swather header 12, as described below and, at the same time, also pneumatically isolating the right side pair of frame air suspension air bag 457 and gauge wheel air bag 557 (see FIG. 14A) from the left side frame air suspension air bag 457, gauge wheel air bag 557, from cutter bar float air bags 124, and also from any other components of pneumatic system 901, such as compressor 905 and working air storage tank 902. This isolation of the right side pair of frame air suspension air bag 457a and right gauge wheel air bags 557 from the left side frame air suspension air bags 457, gauge wheel air bags 557, and from other components in pneumatic system 901 allows for increases in pressure in right-side gauge wheel bags 557a to be efficiently and effectively communicated to the right side frame air suspension air bag(s) 457. The same is true on the left side. This isolation of the left side pair of frame air suspension air bag 457b and left-side gauge wheel air bag 557b from the right side frame air suspension air bag 457a, right-side gauge wheel air bag 557a, and from other components in pneumatic system 901 allows for increases in pressure in left-side gauge wheel bags 557b to be efficiently and effectively communicated to the left side frame air suspension air bag(s) 457b. This arrangement may be referred to as part of gauge wheel air bag lifting assist system.

As noted above, if the pressure in each cutter bar float air bag 124 is lowered (e.g., to 30 psi), this results in cutter bar 122 operating in “flex” mode transversely across its width. If each frame suspension air bag 457 is also inflated to a specified lower pressure level (e.g., the same pressure of cutter bar float air bags 124, such as 30 psi) then frame air suspension air bags 457 may provide little or no suspension effect between main header frame 100 and lift arms 146a, 146b. In such a flex mode of operation each pivot arm side plate 453a, 453b may have its respective pivot arm side plate bottom stop 449a, 449b in the fully downward portion (i.e., as shown in FIG. 12A), in which stop 449a, 449b rests directly upon respective stop portions 461a, 461b of lift boot 450. Stop portion 461a may be formed at a portion of the intersection between support member 450a and upper air bag support plate 450d (FIG. 9) and stop portion 461b may be formed at a portion of the intersection between support member 450b and upper air bag support plate 450d. It should be also noted that, in this flex mode, stabilizer apparatuses 500 (as described below) provide little, if any, assistance in supporting swather header 12 on the ground surface. However, even at such a lower internal air pressure, frame air suspension air bags 457 may provide some level of vibration dampening to stabilize main header frame 100 on lift arms 146a, 146b when subject to relatively small vibrational oscillations.

Frame air suspension bags 457 may be configured to absorb and may be configured to dampen applied impact compressive forces acting through the frame air suspension bags between the frame of the header 12 and the lift arms 146a, 146b. Each frame air suspension bag 457 may be configured to be resilient/act elastically so as to recover to its original size/length after the application of additional dynamic compressive forces. Thus, each frame air suspension bag 457 may be configured operate at least in part as a spring—and may also function as an undamped harmonic oscillator in some embodiments. But in some embodiments, frame air suspension bags 457 may act as damped oscillators—either underdamped oscillators or possibly as overdamped oscillators. Dampening of the motion by frame air suspension bags 457 in addition to an elastic/resilient behavior of the frame air suspension bags, is beneficial and important. Air bags 457 may provide dampened and “controlled” motion that decelerates any “fast” accelerations imparted into them during operation. Very high air pressures within the air bag [near the limit of the air bag] would reduce this dampening effect as the spring becomes more of a rigid body. Thus, it is desirable not to operate the air bags at a relatively high pressure zone (for example, not operate at pressure greater than 85% of their maximum pressure rating—otherwise the stiffness/elasticity level of the bag will approach that of a rigid body and a very high spring rate, which is not desirable.

### Stabilizer Apparatus

Turning now to FIGS. 14A and 14B, as referenced above, swather header 12 may be equipped with at least one stabilizer apparatus 500, and possibly multiple stabilizer apparatuses 500, on each transverse side of the center line Y1 of the header (FIG. 3A). Each stabilizer apparatus 500 on each side can assist in carrying some of the forces acting on swather header 12, including at least some of the weight of main header frame 100 and the components supported therein including cutter bar 122 and draper decks 118a and 118b, during at least some modes of operation, such as when cutter bar 122 is in rigid mode as described above. Each stabilizer apparatus 500 will typically be in contact with the ground surface below, and provide support against downward acting forces, at least when cutter bar 122, and swather header 12, is in rigid mode. Stabilizer apparatus 500 can also assist in “lifting” a given side of main header frame 100 when stabilizer apparatus 500 on the given side encounters a rise in the level of the terrain as swather header 12 moves over the ground surface, at least when cutter bar 122 and swather header 12 are in rigid mode. Each stabilizer apparatus 500 may, at least in some modes of operation (e.g., a rigid mode), carry at least part of the weight of swather header 12.

One or more stabilizer apparatuses 500 may be positioned on each side of swather header 12, transversely spaced from frame suspension air bag(s) 457 on each respective side. In some embodiments, where there are single stabilizer apparatuses 500 on each lateral side of the frame, these stabilizer apparatuses 500 may be positioned in the range of about 30% to 75% (such as about 50%) of the distance from the centerline Y1 of main header frame 100 (FIG. 3A) to the end of main header frame 100. For example, for swather headers 12 in the range of about 40 to 45 ft in total width, stabilizer apparatuses 500 on each side may be located about 15 ft from the center line. For swather headers 12 of a total width of less than 40 ft, each stabilizer apparatus 500 may be located only about 10 ft from the center line on each of the left and right sides. It may be appreciated that since each stabilizer apparatus 500 may be mounted to a corresponding vertical strut 114, the selection of the precise transverse locations of stabilizer apparatuses 500 may be limited to where such vertical struts 114 are transversely located on main header frame 100. It may also be desirable, for structural stability, that the stabilizer apparatuses 500 be attached to central support beam component 112a of main transverse support beam 112 and not to right and left side support beam extensions 112b, 112c, which are attached to central support beam component 112a.

Each stabilizer apparatus 500 may be connected to one or more structural members of main header frame 100 such as a corresponding vertical strut 114. Each stabilizer apparatus 500 may comprise a pressurized stabilizer gas actuator device, such as an expandable gas bag actuator (e.g., gauge wheel air bag 557, as described below). Such a pressurized gas actuator device may be configured and operable to provide a spring-like force resistance and response to an upwardly directed force applied to a component of stabilizer apparatus 500 that is in contact with the ground. Such a pressurized gas actuator may also be operable to isolate and/or dampen vibrations from being transferred between main header frame 100 and the component of stabilizer apparatus 500 that is in contact with the ground. Such a pressurized gas actuator device has the benefit of being able to provide for a varying spring rate, which is dependent upon the gas pressure within the gas actuator device. In general, the greater the internal gas pressure within the air actuator, the greater the spring rate, the stiffer the spring action and the greater the initial resistance force. This capability is extremely useful to assist in addressing varying operating modes, conditions and situations for agricultural apparatus 30. In some embodiments, the pressurized gas actuator device may be a stand-alone device that is not in pneumatic communication with any other components of pneumatic system 901. In some embodiments, the pressurized gas actuator device may be an air bag actuator. In other embodiments, the pressurized gas actuator may be a metal pneumatic cylinder with a piston rod that may be actuated by pressure applied by the ground surface onto a component of stabilizer apparatus 500. In some embodiments, the pressurized gas actuator device may be only in pneumatic communication with other components of pneumatic system 901 that enable to the internal pressure within gas actuator device to be set various different levels, depending upon the actual operating conditions/modes.

Each stabilizer apparatus 500 may be configured and operable to absorb shock loads imparted onto the stabilizer apparatus 500 when, for example, the stabilizer apparatus 500 encounters a change in the height of the ground surface beneath it, as the propulsion unit 14 moves swather header 12 across a field.

Each stabilizer apparatus 500 may also be configured and operable to provide assistance to the functioning of header suspension system 401 by placing components of stabilizer apparatus 500 (e.g., a pressurized gas actuator) in pneumatic communication with the header pressurized gas actuators/frame air suspension air bags 457 of header suspension system 401 as will be described further hereinafter. In some embodiments, frame air suspension air bags 457 and gauge wheel air bags 557 are set in an initial state at the same initial operating pressure, such as prior to commencing cutting of a crop in a field. In other embodiments, frame air suspension air bags 457 and gauge wheel air bags may be set in an initial state at different initial operating pressures.

Pneumatic system 901 may also provide for selectively pneumatically isolating the right-side pair of (i) right frame air suspension air bag 457 and (ii) right stabilizer apparatus 500 (e.g., gauge wheel air bags 557 as described below), from the left side pair of (i) left frame air suspension air bag 457 and (ii) left stabilizer apparatus 500 (e.g., gauge wheel air bags 557). Also, both the left and right-side pairs of frame air suspension air bag 457 and gauge wheel bags 557 may be also selectively isolated from any other components of pneumatic system 901, such as cutter bar float air bags 124/124′, compressor 905, working air storage tank 902 and air pressure dump valve 915.

The result may be that forces, imparted onto stabilizer apparatus 500 on any one side of swather header 12, may be converted into a pneumatic gas/air pressure increase on that side stabilizer apparatus(es) 500 (e.g., in one or more gauge wheel air bags 557), which can be transferred/communicated to increase the air pressure in frame air suspension air bag 457, on the same side of swather header 12. That causes that side frame air suspension air bag 457 to expand (and not cause any expansion of any of the opposite side frame air suspension air bag 457, the opposite side gauge wheel air bags 557 or any cutter bar float air bag 124). This results in an upward lifting force being imparted onto main header frame 100 on that side of swather header 12 and cause upward movement of main header frame 100 on that side relative to lift arms 146a, 146b, which results in a lateral tilting movement on that side of main header frame 100, where the lifting force is provided.

Each stabilizer apparatuses 500 may comprise a gauge wheel assembly 499 (see FIG. 14B), which may be supported on respective right and left side vertical struts 114 of main header frame 100. In other embodiments, stabilizer apparatuses 500 may be a plough device, a ski device, or any other device on an agricultural implement capable of travelling in contact with a ground surface.

An example right side, gauge wheel assembly 499 may include a wheel 511 comprising a wheel rim 509 (which may be made from any suitable material such as a steel) on which may be mounted a tire 510 (which may be made from a rubber material). Left side gauge wheel assembly 501 may be constructed in the same manner. Each gauge wheel assembly 499 may include an axle/hub assembly 502 in such a manner as to allow for free rotation of the wheel about the horizontal axis of the axle/hub assembly 502. Axle/hub assembly 502 may also include a wheel hub 508 (see FIG. 14A) to which wheel 511 is affixed and a spindle, which is received in a tubular housing of a king pin assembly 503. King pin assembly 503 may be affixed to a lower end of support bracket 504. King pin assembly 503 may also permit rotation of wheel 511 about a king pin axis of rotation that may be at an angle to a vertical direction.

Support bracket 504 may be fixedly connected to a gauge wheel pivot mechanism that may comprise a trailing wheel leg member 505, which may be part of a trailing gauge wheel mounting assembly 506. Wheel leg member 505 may be supported, for pivoting movement, on opposed transverse sides by a pair pivoting support arms 512. Pivoting support arms 512 may be supported for pivoting movement about a pivot pin 513 and be able to pivot about gauge wheel pivot axis X3 with leg member 505. Pivot pin 513 may be mounted transversely between side strut members 116a, 116b of horizontal strut 116 of main header frame 100 (see FIG. 14B).

Extending transversely from each of right and left side support arms 512 and fixedly attached thereto, such as by welding, may be a lower, gauge wheel air bag support plate 514. Fixedly attached, such as by welding, to opposed longitudinal and vertical surfaces of vertical strut 114, may be a generally V-shaped, flanged, upper, gauge wheel air bag support bracket 507. Gauge wheel air bag support bracket 507 may include right side and left side, upper horizontal and transversely extending air bag mounting plates 507a.

On each side of vertical strut 114, one gauge wheel gas/air bag 557 (or, in other embodiments, a plurality of air bags 557) may be located, and may be positioned beneath the bottom facing surface of upper base plate 507a, on an upper side and the top facing surface of lower base plate 514 that extends laterally outwards from a support arm 512, on both sides. Thus, each transversely spaced gauge wheel air bag 557 may be sandwiched between upper base plate 507a and lower base plate 514. It will be appreciated that the vertical position of each lower base plate 514 relative to its opposed upper base plate 507a, may be varied, as wheel leg member 505 and gauge wheel 501 connected thereto, pivot about gauge wheel pivot axis X3 on pivot pin 513.

Gauge wheel air bags 557 may be fixedly secured to a downward facing surface of upper base plate 507a using a pair of bolts secured to an upper integral rigid plate portion of frame air suspension air bags 457. Bolt holes in the plate portion of the air bag can be appropriately sealed in a known manner from the inner pressurized air cavity of the bag (e.g., blind mounting nuts/bolt holes). The upper integral rigid plate portion may also provide for an air inlet/outlet which can be pneumatically connected to pneumatic/air hose 903.

Each gauge wheel air bag 557 may be include a generally tubular side wall made of a resiliently expandable material, such as a rubber material. The side wall material may be permanently bonded to/crimped with metal, generally cylindrical, flat end plates at opposite ends. Each gauge wheel air bag 557 may also be sized, configured and positioned to be able to withstand appropriate forces/pressures exerted by the surface of each of plates 507a, 514 when the interior cavity of frame air suspension air bag 457 is pressurized by pneumatic system 901. An example of a known type of air bag that might be employed as a gauge wheel air bag 557 is the model FD 70-12 CI Double Convolution Air Actuator made by ContiTech AG and/or one of its affiliated companies. Such a frame air suspension air bag 457 may have upper and lower plates with a diameter of about 4.25 inches and the interior of the bag may have operating internal volumes of between about 40 cubic inches to 110 cubic inches over operating pressures of between about 30/40 psi and 120 psi.

It should be noted that, for a given internal air pressure, cutter bar float air bag 124 and the gauge wheel air bags 557 (e.g., the model FD 70-12 CI Double Convolution Air Actuator made by ContiTech AG) will have a spring rate that is significantly less over the operating air pressures, such as possibly in the range of about ¼ to ½ of the spring rate of frame air suspension air bag 457 (e.g., the model FS 200-10 CI Single Convolution Air Actuator made by ContiTech AG). Thus, with respect to gauge wheel air bags 557, by providing two such air bags the lower spring rate will be compensated for, and yet the smaller size will accommodate small size constraints in providing such air bags within the confines of the relatively small sized gauge wheel assembly 499. However, in other embodiments, only one gauge wheel air bag 557 may be utilized on each side of main header frame 100. In yet other embodiments, more than two gauge wheel air bags 557 may be utilized on each side of main header frame 100.

### Pneumatic System

With reference now to FIG. 13, example pneumatic system 901 is illustrated. Pneumatic system 901 may comprise right side cutter bar float air bags 124a and left side cutter bar float air bags 124b. Right side cutter bar float air bags 124a may be mounted on the right side of main header frame 100 (as described above) in spaced transverse relationship to each other and they may each be pneumatically connected in parallel via pneumatic/air hoses 903 to an air manifold 900. Similarly, left side cutter bar float air bags 124b may be mounted on the left side of main header frame 100 (as described above) in spaced transverse relationship to each other and they may each be may independently be pneumatically connected in parallel via pneumatic/air hoses 903 to air manifold 900.

Right side header frame air suspension air bag 457a and the pair of right-side, gauge wheel bags 557a may be plumbed/pneumatically linked together in parallel by pneumatic/air hoses 903 and be pneumatically connected through an electric solenoid isolation valve 908a to air manifold 900. Similarly, left side header frame air suspension air bag 457b and the pair of left-side gauge wheel bags 557b may be plumbed/pneumatically linked together in parallel by pneumatic/air hoses 903 and be pneumatically connected through an electric solenoid isolation valve 908b to air manifold 900.

Air manifold 900 may be pneumatically connected through pneumatic/air hose 903 to working air storage tank 902. Working air storage tank 902 be, for example, a tank having an interior pressurized air storage volume sufficient to maintain operation over a working pressure range of 30-120 psi and may also be pneumatically connected through another pneumatic/air hose 903 to air compressor 905, which may, for example, be a model 330C air compressor made by VIAIR® Corporation of Irvine, CA, having specifications of 150 psi-100% duty cycle.

Air compressor 905 may be in electrical communication with a switch/relay 904, which may, itself, be activated/controlled by a controller device (or switch box which an operator controls) 920. For example, controller device 920 may be able to provide for the application of a voltage (e.g., 12 volts) to switch/relay 904 to cause air compressor 905 to be activated. Removal of that voltage by controller device 920 and switch/relay 904 can de-activate air compressor 905. Thus, air compressor 905 may be activated and deactivated by controller device 920 through electronic switch/relay 904 to cause pneumatic/air hose 903 to start and stop delivering additional pressurized air to working air storage tank 902 to increase the air pressure within the tank to a desired/specified level.

Working air storage tank 902 may also be in pneumatic communication with an air pressure dump valve device 918, which may also be in electrical communication with an electronic switch/relay 906, which may, itself, also be activated/controlled by controller device 920. For example, controller device 920 may be able to provide for the application of a voltage (e.g., 12 volts) to switch/relay 906 to cause dump valve 918 to be activated/opened. Removal of that voltage by controller device 920 and switch/relay 906 can de-activate/close dump valve 918. Thus, air pressure dump valve device 918, may be activated and deactivated by controller device 920 through electronic switch/relay 906 to cause pneumatic/air hose 903 to start and stop expelling air from working air storage tank 902 to decrease the air pressure within working air storage tank 902 to a desired/specified level.

An air pressure relief valve 915 may be in pneumatic communication with air manifold 900 to ensure that the air pressure, being delivered by air manifold 900 to all the air bags referenced above, does not exceed a maximum permitted level-so as to avoid over-pressuring of the air bags and also to establish that all the air bags can be pressurized to, but not over, a specified maximum level.

Isolation valve 908a and isolation valve 908b may be electrically linked such that an electrical signal/voltage provided by switch/relay 904 to open isolation valve 908a, causing compressor 905 to operate, will also result in isolation valve 908b being opened. Similarly, isolation valve 908a and isolation valve 908b may also be electrically linked such that a lack of electrical signal provided by switch/relay 904 causing air compressor 918 to shut off, will close isolation valve 908a and will also result in isolation valve 908b being closed.

Similarly, isolation valve 908a and isolation valve 908b may be electrically linked such that an electrical signal/voltage provided by switch/relay 906 to open isolation valve 908b, causing air dump valve 918 to open, will also result in isolation valve 908a being opened. Similarly, isolation valve 908a and isolation valve 908b may also be electrically linked such that a lack of electrical signal provided by switch/relay 906 causing dump valve 918 to close, will close isolation valve 908b and will also result in isolation valve 908a being closed.

Steering diode 921 may be provided in the electrical link between compressor switch/relay 904, air compressor 905 and isolation valve 908a. Steering diode 922 may be provided in the electrical link between electronic switch 906, air dump valve 918 and isolation valve 908b.

When an electrical signal is applied to switch/relay 904 and air compressor 905, then steering diode 922 ensures that no electrical signal/voltage is applied to dump valve 918 and no voltage passes via that path to switch/relay 906 or controller device 920. Similarly, when an electrical signal is applied to switch/relay 906 to open dump valve 918, then steering diode 921 ensures that no electrical signal/voltage is applied to air compressor 905 and no voltage passes via that path to switch/relay 904 or controller device 920.

Steering diodes 921 and 922 can be configured to operate such that either air compressor 905 or dump valve 918 can be activated/de-activated by switches/relays 904 or 906 respectively at any one time, with either the operation of air compressor 905 or dump valve 908 resulting in the opening or closing of isolation valves 908a, 908b together (i.e., in tandem). Steering diodes 921 and 922 can also be configured to operate such that at no time are air compressor 905 and dump valve 918 activated together and operated at the same time.

If, during operation, it is desired to operate swather header 12 in rigid mode, header height control system 10 can select and provide a height of main header frame 100 such that cutter bar 122 is at a cutting height above level ground surface (e.g., 2 inches above the ground surface).

Generally speaking, by increasing the initial setup pressure of cutter bar float air bags 124, frame air suspension air bag 457 and gauge wheel gas/air bags 557, the spring rate of each gas/air bag will be increased and, thus, the resistance force provided by each gas/air bag will also be increased. The resistance force is the force exerted by the airbags in opposition to compressive forces applied to the airbags.

When pneumatic system 901 is operating, pneumatic system 901 will increase the air pressure in all the airbags to an initial setup pressure. The greater the initial setup pressure, the greater the spring rate of each air bag and the greater the initial resistance force of each bag will be.

When swather header 12, including pneumatic system 901, in combination with cutter bar 122 are to be operating in rigid mode, controller device 920 can cause switch/relay 904 to open isolation valves 908a, 908b and cause air compressor 905 to be activated to ensure that the air pressure in working air storage tank 902 is increased to the desired high level (e.g., 100 psi as referenced above). Pressurized air may be communicated from working air storage tank 902 through air manifold 900 to pressurize the air bags so that all right-side cutter bar float air bags 124a, the right-side header frame air suspension air bag 457a and the pair of right-side gauge wheel bags 557a are pressurized to the same high level (i.e., the initial setup pressure, for example, 100 psi.). Similarly, all left-side cutter bar float air bags 124b, the left side header frame air suspension air bag 457b and the pair of left-side gauge wheel bags 557b will also all be pressurized to the same high level (i.e., the initial setup pressure, for example, 100 psi.). This may be shown to cause cutter bar 122 to be operating in the rigid mode, with cutter bar 122 positioned, by header height control system 10, to a cutting position above the level ground surface level. Header height control system 10 can select and provide a height of main header frame 100 such that cutter bar 122 is at, and tries to maintain, a specified cutting height above level ground surface (e.g., 2 inches above level ground surface). Stabilizer apparatuses 500 on both sides will be operating to carry some of the weight of main header frame 100 and the components supported thereon.

When pneumatic system 901 is operating in rigid mode, pneumatic system 901 will have raised the air pressure in all the air bags to the same high/upper level, and controller device 920 may also have sent electrical signals through electric cables 909 to operate air compressor 905 and place isolation valves 908a, 908b in an open configuration. Once the pressure in all the air bags has reached the desired high/upper level, then controller device 920 can deactivate switch/relay 904 causing air compressor 905 to be turned off and for isolation valves 908a, 908b to be closed. This places right and left isolation valves 908a, 908b, in an isolation state. In this isolation state of right and left isolation valves 908a, 908b, right-side frame air suspension air bag 457a and the pair of right-side gauge wheel bags 557a will be in direct pneumatic communication with each other, but will otherwise be pneumatically isolated from the rest of pneumatic system 901. The amount of air in this isolated part of pneumatic system 901 will be fixed. The result is that if the size/volume of the air cavity in any of right-side gauge wheel air bags 557a is reduced, the air pressure therein is increased (such as when right-side gauge wheel air bags 557a are both compressed due to their associated gauge wheel 501 encountering a rise in the ground surface). As the pressure in right-side gauge wheel air bags 557a is increased, this causes a delivery of pressurized air though pneumatic/air hose 903 towards right air suspension air bag 457a, with the result that the air pressure in right frame air suspension air bag 457a will also increase, causing right frame air suspension air bag 457a to expand. This causes main header frame 100 to be raised/lifted relative to lift arm 146a as described above, on that right side of main header frame 100.

Similarly, in this rigid mode of swather header 12, and in this isolation mode on pneumatic system 901, the left side frame air suspension air bag 457b and the pair of left-side gauge wheel bags 557b will be in direct pneumatic communication with each other, but will otherwise be isolated from the rest of pneumatic system 901. The amount of air in this isolated part of pneumatic system 901 will also be fixed. The result is that the size of the air cavity in any of the left gauge wheel air bags 557b is reduced and the air pressure therein is increased (such as when left-side gauge wheel air bags 557b are both compressed due to their associated gauge wheel 501 encountering a rise in the ground surface). As the pressure in left-side gauge wheel air bags 557b is increased, pressurized air is communicated via pneumatic/air hose(s) 903 towards left side frame air suspension air bag 457b, with the result that the pressure in left side frame air suspension air bag 457b will also increase, causing frame air suspension air bag 457b to expand. This causes main header frame 100 to be raised relative to lift arm 146b as described above, on the left side of main header frame 100.

Pneumatic system 901 may benefit from a relative simplicity in design. For example, pneumatic system 901, as depicted in FIG. 13, may, prior to agricultural apparatus 30 being in a commencement state of operation—that is, prior to commencing working (e.g., cutting a crop in a field) in a particular mode (e.g., rigid mode or flex mode)—be able to pressurize cutter bar float air bag 124, frame air suspension air bags 457 and gauge wheel air bags 557, all to the same internal air pressure. For example, with cutter bar 122 above the ground surface, providing an internal pressure of 100 psi in all such air bags, including cutter bar float air bags 124, then swather header 12 may be configured in a rigid mode as described above; frame air suspension air bags 457 may be providing appropriate support for main header frame 100 and the components thereon, but have a relatively small degree of expansion such that pivot arm side plates 453a, 453b are close to the bottom of their range of movement (i.e., close or at the position shown in FIG. 12A). At the same time, gauge wheel air bags 557 may be sufficiently expanded and have an appropriate spring rate, such that a shock force resulting from a gauge wheel 501 travelling over rising terrain will provide and appropriate level of absorption by one or more gauge wheel air bags 557, but there may also result in a sufficient pressure increase inside such air bags, that there is sufficient pressurized air transmitted to frame air suspension air bags 457 to achieve a suitable amount of lifting force. It is possible to achieve this simplicity in design, in part by appropriately engineering and taking into account the physical characteristics of swather header 12, such as the overall weight and weight distribution of main header frame 100 and components supported thereon, as well as the specifications of cutter bar float air bags 124, frame air suspension air bags 457 and gauge wheel air bags 557 and the air pressures to be applied therein, as well as the dimensions, etc., of the components that are directly functionally linked to frame air suspension air bags 457 and gauge wheel air bags 557 (e.g., the length of the trailing wheel leg members 505 and support arms 512, from pivot pins 513 and the position of gauge wheel air bags 557 in relation thereto). Achieving the ability to be able to pressurize cutter bar float air bags 124/124′, frame air suspension air bags 457 and gauge wheel air bags 557, all to the same internal air pressure in rigid mode and in flex mode of operation may be accomplished, at least in part, by practical experimentation, on for example, the length of the gauge wheel lever arm—to ensure it will work for wheel clearance, amongst other considerations—and, for example, attempting to make it as short as practical. Experimentation can also be made with respect to the position of gauge wheel air bags 557 relative to the transverse pivot axis X3 of the lever arm to achieve a desirable level of performance.

It should be also noted that, within the stabilizer apparatus 500 itself, there may be a mechanical advantage in having gauge wheel air bags 557 being squeezed between lower plates 514 and upper plates 507a, created by a lever action of a gauge wheel 501 supported on a leg arm 505 such that there is a significant lever action caused by gauge wheel 501 acting on gauge wheel air bags 557. The degree of this lever action will be determined, at least in part, by the distance of gauge wheel air bags 557 from the gauge wheel pivot axis X3 (FIG. 14A) and the distance of the contact point of gauge wheel 501 with the ground surface from axis X3.

Accommodation can be made for any weight imbalance on the left side/right side of main header frame 100 by fore/aft and/or right/left side air bag position adjustments of any or all cutter bar float air bags 124/124′, frame air suspension air bags 457 and gauge wheel air bags 557 to increase/decrease the spring rate in the bags to achieve a nominally level attitude of main header frame 100. Multiple wheel air bag mounting position/pattern of holes may be provided at different fore/aft locations and different right/left locations.

In other embodiments, pneumatic system 901 may be configured such that cutter bar float air bags 124, frame air suspension air bags 457 and gauge wheel air bags 557 are not all pressurized to the same pressure level at the initial commencement of a rigid or flex mode of operation. In some embodiments, it may be possible for pneumatic system 901 to initially pressurize all cutter bar float air bags 124, all frame air suspension air bags 457 and all gauge wheel air bags 557 to an initial setup pressure. Thereafter on each side, frame air suspension air bags 457 and all gauge wheel air bags 557 can be isolated from cutter bar float air bags 124/124′ and then cutter bar float air bags 124/124′ across the entire width of cutter bar 122 may have their internal pressures adjusted independently of all frame air suspension air bags 457 and all gauge wheel air bags 557 (e.g., cutter bar float air bags 124/124′ may have their internal pressures adjusted downwards) during the initial commencement state.

Other components recited herein may be made from suitable materials.

### In Operation

In use, when cutter bar 122 is operating in rigid mode as described above, with both left and right side header frame air suspension air bags 457a, 457b and optionally their respective pair of left and right side, gauge wheel bags 557a, 557b being in respective direct pneumatic communication with each other, but otherwise being isolated from the rest of pneumatic system 901, during operation across level ground, the weight of main header frame 100, cutter bar 122 and other components secured to main header frame 100, such as draper decks 118a and 118b, will be carried mostly by lift arms 146a, 146b.

As described above, each header suspension system/mechanism associated with the connection/mounting apparatus 400 is operable to one or more of, support, isolate, resist, absorb, cushion, and dampen at least some of the static and dynamic forces that are being transferred/transmitted between the propulsion unit and the header through the mounting apparatuses. Static downward forces acting on header 12 including on main header frame 100 and cutter bar 122, associated with the mass/weight of such components, as well as dynamic downwardly and upwardly acting forces acting on the header 12, may be transferred between the header 12 and propulsion unit 14 through the mounting apparatuses, including the suspension system/mechanisms. Dynamic forces may be imparted to the header 12 and its frame 100 from lift arms 146a, 146b during operation of the header height control system as described herein, and/or the dynamic motion imparted into the swather header 12 by its ground engaging elements [e.g., cutter bar or gauge wheels] as they are mechanically moved by variations in height of the surface terrain. The mass of swather header 12 can be moved to motion by forces due to gravity when accelerating over changing levels of the terrain surface.

Dynamic downward and/or upward acting forces acting on the header may be transferred from the header 12 to lift arms 146a, 146b (and visa versa), (and possibly to some extent to one or more other members of the propulsion unit) through the mounting apparatuses including through mounting apparatuses that have suspension systems/mechanisms, as described further below. The lift arms 146a, 146b may, at least in some modes of operation, support most or possibly all of the generally downwardly acting weight of swather header 12.

In rigid mode of swather header 12, a significant (e.g., majority) proportion of the weight will typically be carried by main header frame 100 and will typically be transferred to lift arms 146a, 146b and on to propulsion unit 14. Typically, a smaller minority proportion of that weight will be carried by stabilizer apparatuses 500 located towards opposite transverse ends of swather header 12, typically somewhere between the outside edge of lift arms 146a, 146b and the end of main header frame 100. Stabilizer apparatuses 500 will be configured such that gauge wheel air bags 557 are acting like stiff springs and providing some amount of support of the weight of swather header 12. Typically, it is desirable that stabilizer apparatuses 500 on both sides provide support no more than the lesser of (i) 10% of the weight of main header frame 100 and the components supported thereon and (ii) about 1000 lbs. It should be noted that, if gauge wheel air bag 557 is fully compressed, main header frame 100 and/or lift arms 146a, 146b may be in contact with the ground surface, which would not be appropriate for operation either in rigid mode or in flex mode. Therefore, it is important to ensure that, in normal operation on level ground, gauge wheels 501 are not carrying too much of the weight of main header frame 100 and the components mounted thereon and to ensure that gauge wheel air bags 557 are not too compressed and they have sufficient ability to respond, with spring-like action, to a rise in the level of the ground surface, as discussed herein.

At least in rigid mode, upon one side (e.g., the right side) gauge wheel 501 encountering a rise in terrain, this will normally result in a generally upward force being imparted onto that gauge wheel 501 (assuming gauge wheel 501 is able to respond by moving upwards on the rising terrain). This generally upwardly directed force will cause the pair of gauge wheel air bags 557 on that side of swather header 12 to be compressed as trailing wheel leg member 505 pivots about gauge wheel pivot axis X3 on pivot pin 513. This pivoting action of right wheel leg member 505 causes lower plate 514 to also pivot upwards relative to upper support plate 507a, which results in compression of both right-side gauge wheel air bags 557a.

The compression of right-side gauge wheel air bags 557a will then cause an increase in air pressure within right-side gauge wheel air bags 557a, and this increase in air pressure is communicated to right side frame air suspension air bag 457a through pneumatic/air hose 903, increasing the air pressure in right side frame air suspension air bag 457a on the right side of swather header 12. The increase in air pressure in right side frame air suspension air bag 457a and the corresponding expansion of right side frame air suspension air bag 457a transmits an upward acting lifting force on pivot arm side plates 453a, 453b, upper base plate 462 along with lift horn member 454, on that side of swather header 12 to force them to pivot about axis X2 relative to support members 450a, 450b of lift boot 450 on that side of swather header 12. The movement upwards of lift horn member 454 on the right side of swather header 12 will then result in the upwards lifting movement of main header frame 100 and cutter bar 122 on the right side of swather header 12 relative to lift arm 146a. The three-point pivotal connection formed though mounting apparatuses 400A, 400B and pivotal connection 403 (FIG. 8A) can enable the right side of swather header 12 to be lifted upwards without the left side frame air suspension air bag 457b being compressed. That is, typically, because when moving across a typical ground surface in a crop field, if the right side of swather header 12 (and its associated stabilizer apparatus 500) encounters rising terrain, the opposite left side of swather header 12 will encounter falling terrain. Thus, the opposite left side of swather header 12 will be able to tilt downwards along with stabilizer apparatus 500, thus avoiding the left side stabilizer apparatus 500 and associated gauge wheel airbags 557b responding to an increase in the pressure in the left side frame air suspension air bag 457b. However, if, when moving across the ground surface in a crop field, the right side of swather header 12 (and its associated stabilizer apparatus 500) encounters rising terrain, and the opposite left side of swather header 12 does not encounter falling terrain, header height control system 10, referenced above, may respond to provide for lifting of main header frame 100, to compensate for the lower left side of swather header 12 being too low, as determined by header height sensors. Thus, header height control system 10 may operate co-operatively with the gauge wheel air bag/frame air suspension air bag system to provide for a relatively smooth movement over uneven terrain.

The air pressure level in right side frame air suspension air bag 457a will have increased above the air pressure level in the opposite left side frame air suspension air bag 457b. This will then result an upward tilt on the right side of swather header 12, of main header frame 100 and other components of swather header 12 attached to the frame, such as cutter bar 122 and draper decks 118a and 118b. Thus, the increasing of the air pressure in the right side frame air suspension air bag 457b on one side of swather header 12 is functionally linked to, and caused by, the increase in air pressure in the pneumatically linked gauge wheel air bags 557b on that side of swather header 12. The increase in air pressure in gauge wheel air bags 557a on that right side of swather header 12 is caused by an increased upward mechanical force being applied to gauge wheel 501 on the right side of swather header 12.

The foregoing description of right gauge wheel 501 encountering rising terrain relative to left gauge wheel 501, would apply in the opposite manner if, instead, left gauge wheel 501 encountered rising terrain relative to right gauge wheel 501, with the left gauge wheel 501 providing pressurized air to left side frame air suspension air bag 457, resulting in a lifting force to assist in a tilting upwards of the left side of swather header 12.

If both right gauge wheel 501 and left gauge wheel 501 encountered rising terrain at the same time relative to central area of main header frame 100, then both of the following would occur: (a) left gauge wheel 501 provides pressurized air to left side frame air suspension air bag 457b, resulting in a lifting force to the left side of swather header 12 and (b) the right gauge wheel 501 provides pressurized air to right side frame air suspension air bag 457a, resulting in a lifting force to the right side of swather header 12. The combined result is that lifting forces on both the right side and the left side of main header frame 100 will assist in lifting main header frame 100 upwards, generally level, thus cushioning the forces associated with the rising terrain on both the left side and the right side of swather header 12. Additionally, header height sensors in header height control system 10 may also provide signals to the header height controller, which would cause the header height positioning system to lift the entire main header frame 100 relative to propulsion unit 14. However, it is notable that the gauge wheel air bag/frame air suspension air bag combinations on both sides of main header frame 100, are typically able to transmit a lifting force to main header frame 100 more quickly than the header height control system 10 can cause a lifting force to be implemented on main header frame 100 (typically through the hydraulic lift cylinders). The pneumatic system 901 with its direct communication of pressurized air, may implement a level lifting force more quickly than header height control system 10 with its hydraulic lift cylinders.

This same feature may also be applicable with respect to lateral tilting of swather header 12 when only one side encounters rising terrain and it is desirable to assist in tilting swather header 12 in response to the rising terrain on one side. As described above, header height control system 10 may be equipped with the ability to laterally tilt main header frame 100 relative to propulsion unit 14 through independent vertical movement of lift arms 146a, 146b. Header height sensors 32, 36 in header height control system 10 may also provide signals 40, 44 to header height controller 18 indicating that the header height is too low on one side, which would cause header positioning system 22 to tilt main header frame 100 relative to propulsion unit 14 to raise that one side with the rising terrain. However, the gauge wheel air bags/frame air suspension air bag(s) combination on that side of main header frame 100, will be typically able to transmit a lifting tilting force to main header frame 100 relative to propulsion unit 14 (as described above) more quickly than header height control system 10 can cause a tilting force to be implemented on main header frame 100 (typically through the hydraulic lift cylinders). Pneumatic system 901, with its direct communication of pressurized air, may implement a tilting force more quickly than header height control system 10 with its hydraulic lift cylinders.

A mechanical advantage may also be provided by having gauge wheels 501 and associated gauge wheel air bags 557 located transversely outside of frame air suspension air bag 457 on swather header 12, on each left and right sides. For example, for a swather header 12 having a total transverse width of 40 ft, gauge wheels 501 may be located approximately 15 ft from the center axis Y1 (FIG. 3A). Header frame air suspension air bag 457 may be positioned about 3 ft from the axis Y1 on the same side of swather header 12. The result is that, if there is an increase in air pressure within gauge wheel air bags 557 resulting in a compression of these gauge wheel air bags 557 during the impact of gauge wheels 501 on the ground surface, then there will be a corresponding increase in pressure in header frame air suspension air bag 457, which increase in pressure will cause an expansion of frame air suspension air bag 457 on that side of main header frame 100. Since frame air suspension air bag 457 is closer to the tilt axis of main header frame 100 relative to propulsion unit 14, a change in the volume of frame air suspension air bag 457 may have a relatively larger impact and cause a relatively large lift force effect on main header frame 100.

It may also be appreciated that the further outboard gauge wheel 501 is located on main header frame 100, the less may be the effect of the lift force generated at frame air suspension air bag 457. This is because the further outboard gauge wheel 501 is located, when gauge wheel 501 encounters rising terrain, less force will be required to transmitted to main header frame 100 in order to create the lever action required to tilt main header frame 100 upwards (i.e., the longer the lever arm, the less the upward force required to create the tilting movement). If less force is required to create a tilt, then gauge wheel air bag 557 will be pressurized to a relatively lower extent (compared to a tilting force required—due a smaller lever arm—if gauge wheel 501 is located closer to the center line). Therefore, a selection can be made to choose a location for gauge wheels 501 that is suitable/desirable both for static conditions (e.g., swather header 12 moving over a level ground surface) and for dynamic conditions (when one gauge wheel 501 moves over rising ground surface), and this will depend upon a variety of variables including weight and weight distribution of main header frame 100 and components mounted thereon, and the overall width of main header frame 100.

Furthermore, if stabilizer apparatus 500 is located very close transversely to the center axis Y1 on each side, then if gauge wheel 501 on one side encounters a rise in terrain of N inches (e.g., 12 inches) on that side, this will impart a relatively large tilt angle on main header frame 100, which tilt angle may not be desirable. If, by contrast, stabilizer apparatuses 500 are located very close to the outside end of main header frame 100, then, if gauge wheel 501 on one side encounters a rise in terrain of the same N inches (e.g., 12 inches) on that side, this will impart a relatively much lower tilt angle on main header frame 100. This may, possibly, also not be desirable, at least in some situations. It may, therefore, be advisable to select a location of stabilizer apparatus 500 where the tilt angle created by such a rise in terrain, is moderate, such as, for example, about half-way between the centerline and the end of swather header 12. In many situations, in part due to physical and other constraints, gauge wheel 501 may be a small amount less than 50% of the distance from the centerline to the outside end of main header frame 100. The precise selection of the transverse position of stabilizer apparatuses 500 on each side may also be affected by various design constraints, such as the location of vertical struts 114 to which the stabilizer apparatuses are mounted. It can be determined, in part by experimentation on a case-by-case basis, where is a suitable location for each stabilizer apparatus 500, which suitable location does not provide too much tilt angle and which suitable location provides a suitable amount of lift assist to frame air suspension air bags 457 as a result of the compression of gauge wheel air bags 557 when encountering a typical/design amount of terrain rise.

It should be noted that swather header 12, as configured above, is capable of tilting in either lateral direction by the combination of: (a) the mounting of swather header 12 to lift arms 164a, 164b, in a manner in which varying amounts of extension/retraction of the hydraulic cylinders 164a, 164b allows for tilting together of main header frame 100 relative to propulsion unit 14 under the control of header positioning system 22 (as described above with reference to FIG. 5) and (b) the tilting of main header frame 100 relative to propulsion unit 14, as a result of the 3-point pivotal connection of mounting apparatus (including mounting apparatuses 400A, 400B and pivotal connection 403) in combination with the lifting force being assisted by the pneumatic connection between gauge wheel air bags 557 and frame air suspension air bags 457 (i.e., from the gauge wheel air bag lifting assist system. The total range of titling motion is a result of the combination of these separate capabilities.

In the foregoing embodiments, it has been found that the combined effects of the header suspension mechanism as described above, the header positioning system 22 and gauge wheel air bag lifting assist system as described above, work extremely well and co-operate with each other in providing for a relatively smooth operation of agricultural apparatus 30 over uneven terrain. Header height control system 10 may be shown to provide a significant level of height control for swather header 12 but, due to header height control system 10 relying upon and utilizing sensors 32, 36, which are processed by header height controller 18, which then operates devices (typically hydraulic cylinders) to adjust the height/tilt of swather header 12, the response to changes in the height of the terrain may be somewhat delayed. The gauge wheel air bag lifting assist system, as described above, may be shown to have a benefit in that changes in the height of the terrain (particularly upward height changes) are immediately mechanically translated into compression of gauge wheel air bags 557, which compression is then directly translated into a mechanical/pneumatic connection with frame air suspension air bag 457, which connection quickly delivers pressurized air to frame air suspension air bag(s) 457 to create the lifting force on main header frame 100 relative to lift arms 146a, 146b. In particular, it should be emphasized that a gas, such as air, can typically be transmitted and converted into a lift force, more quickly than hydraulic fluid passing through hydraulic lines and operating a hydraulic lift cylinder. Nevertheless, air bags have a limited range of height adjustment—relative to the ability of the hydraulic lift cylinders associated with header height control system 10 associated with propulsion unit 14 as described above. Therefore, the frame air suspension air bag/gauge wheel air bag system operates co-operatively with header height control system 10 to deliver an enhanced main header frame 100 height and tilt control during movement over uneven terrain.

In some embodiments, the gauge wheel air bag/frame air suspension air bag lifting assist system as described above can operate effectively on an agricultural implement (such as a swather) that does not have a separate automated header height control system, whereby the height/tilt may also be automatically effected/controlled by components associated with propulsion unit 14. So long as the gauge wheel air bag system has pressurized gas/air, it can function independently of any interaction with control components of propulsion unit 14. So long as there is some kind of mechanism for supporting and driving the agricultural implement in forward motion, the gauge wheel gas/air bag system can operate independently to assist the agricultural implement in moving across uneven terrain by providing a power assist to the frame gas/air suspension system. However, it is to be noted that, with respect to at least a swather header, it may typically still be necessary to have some kind of coarse header height control/tilt adjustment that could be manually operated by an individual operator. Notably, even in this situation, gauge wheel air bag/frame air suspension air bag lifting assist system may still assist a manual operator by providing a fast response to a rise in terrain, allowing the manual operator more time to respond manually with the manual header height control system.

In other embodiments, the gauge wheel air bags 557 or other stabilizer component air bags may be part of a pneumatic system which includes a main header frame air suspension (such as, for example, as is described above) but does not include a cutter bar pneumatic suspension that allows, at least in some modes of operation, for upward/downward movement of the cutter bar relative to the main header frame. In such systems, the cutter bar assembly may be permanently and rigidly fixed in upward/downward movement relative to the header frame (i.e., it is always operating in a rigid type of mode). In other agricultural implements, there may be no cutter bar at all (e.g., a sprayer implement). Some embodiments may, and some may not, include an air compressor and air pressure dump capability to vary the air pressure by application of such components. Instead in some embodiments, the gauge wheel air bags or other stabilizer component air bags may be part of a system that during operation is a closed pneumatic system, which is subject to appropriate air pressure valves and only plumbed/in air pressure communication with the components of the header frame air suspension (e.g., frame air suspension air bags 457).

In some other possible embodiments, main header frame 100 might, possibly, be designed such that the stabilizers (e.g., gauge wheel devices) carry a significant (e.g., more than a majority) amount of the total weight of main header frame 100 and the components supported thereon, during movement across a ground surface, even on a level ground surface. Nevertheless, the same lifting force effect when the stabilizer component air bags are compressed, providing pressurized air that is delivered to one or more frame air suspension air bags can be achieved. However, it is noted that, in pneumatic system 901 depicted in FIG. 13, when the isolation valves 908a, 908b are closed and during a rigid mode of operation with the gauge wheel air bags 557 and frame air suspension air bags 457 pressurized to a high level (e.g., 100 psi) as described above, then pneumatic system 901 is effectively configured and operating just the same as a header that does not have a flexible cutter bar system that is capable of operating in both rigid and flex modes.

In other embodiments, there may be more than one stabilizer apparatus 500 on each lateral side of swather header 12. For example, swather header 12 might have two stabilizer apparatuses 500 on each of the right side and the left side of swather header 12. Each of the right-side stabilizer apparatuses 500 may be spaced transversely from each other and varied distances from the centerline axis Y1 and frame air suspension air bags 457. Each of the left-side stabilizer apparatuses may be spaced transversely from each other and varied distances from the center axis Y1 and frame air suspension air bags 457. Pneumatic system 901 may be configured such that on each side of swather header 12, each of the plurality of stabilizer apparatuses 500 may include one or more air bags, which may be in pneumatic communication to be able to selectively supply pressurized air (in a manner like that described above) to the same side frame air suspension air bag 457, but not to any other air bags or pneumatic system components in pneumatic system 901, including not to the other air bag on the other stabilizer apparatus 500 on the same side. On each side of swather header 12, the plurality of laterally spaced stabilizer apparatuses 500 and frame gas/air suspension air bags may, in at least in one mode of operation, (e.g., rigid mode) be selectively isolated from other components of pneumatic system 901 to ensure that an increase in pressure in the stabilizer gas/air bags is efficiently transferred to the frame air suspension air bag(s).

The foregoing apparatuses provides a benefit in that the gauge wheel air bags 557 and frame air suspension air bags 457 will, once appropriately pressurized to a suitable pressure, be able to operate without any adjustment, either manual or mechanical/electrical. The closed pneumatic circuit created when these bags are pneumatically isolated, will function without any further external adjustments or inputs, or modifications, thereby working independently.

While the above has been described having regard to an agricultural apparatus including a swather header, which acts as an agricultural implement, mounted to a propulsion unit, in various embodiments, similar methods, systems and apparatuses to those described above may be used in connection with other agricultural implements, such as, for example, a spray boom on a power unit. In particular, other embodiments may generally relate to agricultural apparatuses that include an agricultural implement having a main frame that is directly mounted to a propulsion unit using the types of mounting apparatuses/connection apparatuses as described herein, that allow for the connection to the one or more lift arms of a propulsion unit. For example, the agricultural implement mounted to either the front area or rear area of a propulsion unit may be a baler, rock picker, swather or spray boom.

In various embodiments, the propulsion unit may be any propulsion unit with a three-point hitch (which may at the front or rear of the propulsion unit, to which an implement is mounted). In an embodiment, the propulsion unit is a tractor with a standard type of rearward three-point hitch. A representative example of a three-point hitch 600 is depicted in FIG. 15, which may be connected at a rear end 600a to the front or rear end of a propulsion unit. Three-point hitch 600 may include a pair of transversely spaced lower powered (at least upwardly powered) lift arms 602a, 602b and an upper center arm 604 (top link) that may or may not be powered. Lift arms 602a, 602b may be generally similar to lift arms 146a, 146b and include generally forwardly extending members 608a, 608b which terminate at lower end portions 610a, 610b. Respective openings 612a, 612b, extend transversely through lower end portions 610a, 610b. Each arm 602a, 602b may include leveling assembly 606a, 606b respectively, configured to allow adjustment of the height of lift arms 602a, 602b. The three-point hitch 600 may also include one or more stabilizer arms/links to reduce lateral side to side sway movement of the implement when attached to the three-point hitch. Thus, an agricultural implement, such as swather header 12 can be connected to a propulsion unit by an embodiment of the three-point pivotal connection (including right-side mounting apparatus 400A, left-side mounting apparatus 400B and upper pivotal connection 403) as described herein. In such embodiments, a lift arm securing pin 466 may be received in each of openings 612a, 612b, in lower end portions 610a, 610b of lift arms 602a, 602b and secured as described above.

When introducing elements of the present invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

The term “comprise,” including any variation thereof, is intended to be open-ended and means “include, but not limited to,” unless otherwise specifically indicated to the contrary.

When a set of possibilities or list of items is given herein with an “or” before the last item, any one of the listed items or any suitable combination of two or more of the listed items may be selected and used.

The above-described embodiments are intended to be illustrative only. Modifications are possible, such as modifications of form, arrangement of parts, details and order of operation. The examples detailed herein are not intended to be limiting of the invention. Rather, the invention is defined by the claims.

1. An agricultural system comprising:
a propulsion unit comprises at least one, elongated and generally longitudinally extending, lift arm;
a generally transversely extending implement comprising a generally transversely extending main frame, said implement having a weight;
a mounting apparatus located on the at least one lift arm and operable to provide a first support force to support at least a first portion of said weight of said implement;
wherein the mounting apparatus comprises a suspension mechanism operable to provide suspension of said portion of said weight of said implement on said propulsion unit.

2. An agricultural system comprising:
a propulsion unit comprises at least one, generally longitudinally extending, lift arm;
a generally transversely extending implement comprising a generally transversely extending main frame, said implement having a weight; wherein said at least one lift arm is operable to support at least a first portion of said weight of said implement;
a connection apparatus operable to connect the at least one lift arm to the implement and transmit forces between said implement and said least one lift arm;
wherein the connection apparatus comprises a suspension mechanism operable to any one or more of, support, isolate, resist, cushion, absorb and dampen static forces and/or dynamic forces during the transmission of said static and/or dynamic forces between the implement and the at least one lift arm of the propulsion unit.

3. The agricultural system of claim 1, wherein the mounting apparatus is located proximate a distal end region of the at least one lift arm.

4. The agricultural system of claim 2, wherein the connection apparatus is operably located proximate a distal end region of the at least one lift arm.

5. The agricultural system of claim 1, wherein the mounting apparatus is operably located between the at least one lift arm and the main frame of the implement.

6. The agricultural system of claim 2, wherein the connection apparatus is operable to connect the at least one lift arm to the main frame of the implement.

7. The agricultural system of claim 4, wherein the connection apparatus is operable to releasably connect the at least one lift arm to the main frame of the implement.

8. The agricultural system of claim 1, wherein the suspension mechanism comprises a pressurized gas suspension mechanism.

9. The agricultural system of claim 2, wherein the suspension mechanism comprises a pressurized gas suspension mechanism.

10. The agricultural system of claim 8, wherein the pressurized gas suspension mechanism comprises a flexible and/or expandable gas bag operable to contain a pressurized gas therein.

11. The agricultural system of claim 9, wherein the suspension mechanism comprises at least one of a coil spring, a leaf spring, a pressurized gas bag spring, a hydraulic spring, a cylindrical a helix spring, a conical helix spring, a disc spring, a tension spring, turn spring, a spiral spring, a tape spring, a magnetic spring, a torsion spring, and a rubber spring.

12. The agricultural system of claim 1, wherein the suspension mechanism is operable to provide suspension during the transfer of one or both of dynamic forces and static forces, between the implement and the at least one lift arm of the propulsion unit.

13. The agricultural system of claim 1, wherein the mounting apparatus further comprises:
a first member releasably coupled to the end region of the lift arm; and
a second member pivotally connected to the first member by a first pivotal connection.

14. The agricultural system of claim 2, wherein the connection apparatus further comprises:
a first member releasably coupled to the end region of the lift arm; and
a second member pivotally connected to the first member by a first pivotal connection.

15. The agricultural system of claim 13, wherein the mounting apparatus further comprises a third member pivotally connected to the second member by a second pivotal connection at a first end region of the third member and fixedly connected to the main frame at a second end region of the third member.

16. The agricultural system of claim 15, wherein the second member can pivot to a limited extent relative to the first member in a first angular direction.

17. The agricultural system of claim 16, wherein the third member can pivot to a limited extent relative to the second member in a second angular direction.

18. The agricultural system of claim 13, wherein the lift arm and the first and second members extend generally in a longitudinal direction that is generally orthogonal to the transverse extension of the main frame.

19. The agricultural system of claim 14, wherein the connection apparatus further comprises a third member pivotally connected to the second member by a second pivotal connection at a first end region of the third member and fixedly connected to the main frame at a second end region of the third member.

20. The agricultural system of claim 19, wherein the second member can pivot to a limited extent relative to the first member in a first angular direction.

21. The agricultural system of claim 20, wherein the third member can pivot to a limited extent relative to the second member in a second angular direction.

22. The agricultural system of claim 19, wherein the lift arm and the first and second members extend generally in a longitudinal direction that is generally orthogonal to the transverse extension of the main frame.

23. The agricultural system of claim 13, wherein the suspension mechanism comprises a gas suspension actuator device operationally located between the first member and the second member.

24. The agricultural system as claimed in claim 19, wherein said gas suspension actuator device is operable to provide for an elastic spring movement between said main frame and said at least one lift arm.

25. The agricultural system as claimed in claim 19, wherein said gas suspension actuator device is operable to provide for a dampened elastic spring movement between said implement and said lift arm.

26. The agricultural system of claim 23, wherein an increase in a gas pressure in the gas suspension actuator device creates a lifting force to cause the second member to pivot about the first pivotal connection and lift upwards relative to the first member and the propulsion.

27. The agricultural system of claim 15, wherein the second pivotal connection is positioned in the longitudinal direction proximate to a fore/aft longitudinal direction center of gravity of the implement.

28. The agricultural system of claim 1, wherein the suspension mechanism comprises a gas suspension actuator device, and wherein the agricultural system further comprises:
a stabilizer apparatus inter-connected to said main frame and transversely spaced outwards from said mounting apparatus, said stabilizer apparatus operable to provide support for said main frame against downward-acting forces acting upon said main frame;
wherein said stabilizer apparatus is operable to support a portion of said weight of said implement.

29. The agricultural system of claim 28, wherein the stabilizer apparatus comprises a stabilizer gas actuator device and wherein the gas suspension actuator device is in pneumatic communication with the stabilizer gas actuator device.

30. The agricultural system of claim 1, wherein the at least one lift arm comprises a first lift arm, and wherein the at least one lift arm further comprises a second elongated, generally longitudinally extending lift arm, the first lift arm being transversely spaced from the second lift arm, the second lift arm having an end region and being transversely spaced from the first lift arm;
and wherein the mounting apparatus comprises a first mounting apparatus at a distal end region of the first lift arm, and wherein the system further comprises a second mounting apparatus located at a distal end region of the second lift arm and operable to provide a second support force for carrying a second portion of said weight of said implement;
and wherein the second mounting apparatus includes a frame gas suspension mechanism operable to at least partly provide suspension to said second support force carrying said second portion of said weight of said implement on said propulsion unit.

31. The agricultural system of claim 2, wherein the at least one lift arm comprises a first lift arm, and wherein the at least one lift arm further comprises a second elongated, generally longitudinally extending lift arm, the first lift arm being transversely spaced from the second lift arm, the second lift arm having an end region and being transversely spaced from the end region of first lift arm;
and wherein the connection apparatus comprises a first connection apparatus located at an end region of the first lift arm, and the suspension mechanism comprises a first suspension mechanism, and wherein the system further comprises a second connection apparatus located at the distal end region of the second lift arm and operable to connect the second lift arm to the implement and transmit forces between said implement and said second lift arm;
and wherein the second connection apparatus includes a second suspension mechanism operable to one or more of support, isolate, resist, cushion, absorb and dampen forces during the transmission of static and/or dynamic forces between the implement and the second lift arm of the propulsion unit.

32. The agricultural system of claim 30, wherein said first and second mounting apparatuses provide first and second lower operational connections between said implement and said first and second lift arms respectively, and wherein said agricultural system further comprises an upper connection apparatus operationally connecting said propulsion unit and said implement at a third operational connection above said first and second operational connections.

33. The agricultural apparatus of claim 32, wherein said upper connection apparatus and said first and second lower mounting apparatuses are configured in a generally triangular shaped three-point arrangement.

34. The agricultural system of claim 31, wherein said first and second connection apparatuses provide first and second lower operational connections between said implement and said first and second lift arms respectively, and wherein said agricultural system further comprises an upper connection apparatus operationally connecting said propulsion unit and said implement at a third operational connection above said first and second operational connections.

35. The agricultural apparatus of claim 34, wherein said upper connection apparatus and said first and second lower mounting apparatuses are configured in a generally triangular shaped three-point arrangement.

36. The agricultural system of claim 1, wherein said implement is a swather header.

37. The agricultural system of claim 1, wherein said propulsion unit is a tractor, and wherein said at least one lift arm comprises part of a three-point hitch of said tractor.

38. The agricultural system of claim 1, wherein said implement is a swather header, and wherein said propulsion unit is a tractor, and wherein said at least one lift arm comprises part of a rearwardly positioned three-point hitch of said tractor.

39. The agricultural system of claim 30, wherein each of the first and second mounting apparatuses further comprises:
a first member releasably coupled to the end region of the lift arm; and
a second member pivotally connected to the first member by a first pivotal connection.

40. The agricultural system of claim 39, wherein each of the first and second mounting apparatuses further comprises a third member pivotally connected to the second member by a second pivotal connection at a first end of the third member and fixedly connected to the main frame at a second end of the third member.

41. The agricultural system of claim 40, wherein the first lift arm and the first and second members of the first mounting apparatus extend generally in a longitudinal direction that is generally orthogonal to the transverse extension of the main frame; and wherein the second lift arm and the first and second members of the second mounting apparatus also extend generally in said longitudinal direction that is generally orthogonal to the transverse extension of the main frame.

42. The agricultural system of claim 41, wherein the frame gas suspension mechanisms of the first and second mounting apparatuses each comprise a frame gas suspension actuator device operationally located between the respective first member and second member of the respective first and second mounting apparatuses.

43. The agricultural system of claim 42, wherein during operation of the first mounting apparatus, an increase in a gas pressure in the frame gas actuator device of the first mounting apparatus creates a lifting force to cause the second member of the first mounting apparatus to pivot about the first pivotal connection and lift upwards relative to the first member of the first mounting apparatus and the propulsion unit; and wherein during operation of the second mounting apparatus, an increase in a gas pressure in the frame gas actuator device of the second mounting apparatus creates a lifting force to cause the second member of the second mounting apparatus to pivot about the first pivotal connection of the second mounting apparatus and lift upwards relative to the first member of the second mounting apparatus and the propulsion unit.

44. The agricultural system of claim 40, wherein the lift force is applied proximate to a fore/aft longitudinal direction center of gravity of the implement.

45. The agricultural system of claim 44, wherein the lift force is applied proximate to a fore/aft longitudinal direction center of gravity of the implement.

46. The agricultural system of claim 39, wherein each of the first and second mounting apparatuses further comprises a third member pivotally connected to the second member by a second pivotal connection at a first end of the third member and fixedly connected to the main frame at a second end of the third member; and the lift force is applied proximate to a fore/aft position of each second pivotal connection.

47. The agricultural system of claim 46, wherein the second pivotal connection of each of the first and second mounting apparatus is positioned in the longitudinal direction proximate to a longitudinal center of gravity of implement.

48. The agricultural system of claim 30, further comprising:
a first stabilizer apparatus inter-connected to said main frame and transversely spaced outwards from said first mounting apparatus, said first stabilizer apparatus operable to provide support for said implement against downward-acting forces acting upon said implement;
a second stabilizer apparatus inter-connected to said main frame and transversely spaced outwards from said second mounting apparatus in an opposite transverse direction to said first stabilizer apparatus, said second stabilizer apparatus operable to provide support for said implement against downward-acting forces acting upon said implement.

49. The agricultural system of claim 48, wherein the first and second stabilizer apparatuses each comprises a stabilizer gas actuator device and wherein the frame gas suspension actuator device is in pneumatic communication with the stabilizer gas actuator device.

50. A mounting apparatus comprising:
an assembly;
a first connection mechanism operable to connect the assembly to a propulsion unit, the propulsion unit including a lift arm, the first connection mechanism including a boot configured to engage and retain an end region of the lift arm;
a second connection mechanism operable to connect the assembly to a main header frame of a swather header, the main header frame including a transverse support beam and a vertical strut secured to the transverse support beam, the assembly comprising a lift horn member operable to fixedly connect to the vertical strut with the second connection mechanism;
a header suspension system including an expandable pressurized gas bag operably interposed between the boot and the lift horn member; and
a pneumatic system configured to control a pressure of gas in the gas bag to, thereby, adjust an extent to which the mounting apparatus is operable to transfer, to the lift arm a force acting upon the main header frame.

51. The mounting apparatus as claimed in claim 50, wherein the assembly comprises:
a first member releasably coupled to the end region of the lift arm with the boot; and
a second member pivotally connected to the first member at a first pivotal connection, and the second member fixedly connected to the lift horn member;
wherein the pressurized gas bag is operably interposed between the first member and the second member, such that during operation a change in size of the gas bag results in a change in angle between the first member and the second member.

52. The mounting apparatus as claimed in claim 51, wherein the lift horn member is pivotally connected to the second member at a second pivotal connection at a first end region of the lift horn member and fixedly connected to the main frame at a second end region of the lift horn member.

53. An agricultural system comprising:
a propulsion unit comprises at least one, elongated, generally longitudinally extending, lift arm, said at least one lift arm having a distal end region;
a generally transversely extending implement comprising a generally transversely extending main frame, said implement having a weight; wherein said at least one lift arm is operable to support at least a first portion of said weight of said implement;
a connection apparatus located proximate the distal end region of the at least one lift arm and operable to connect the at least one lift arm to the implement and transmit forces between said implement and said least one lift arm;
wherein the connection apparatus comprises a suspension mechanism operable to one or more of support, isolate, resist, cushion, absorb and dampen static and/or dynamic forces during the transmission of said forces between the implement and the at least one lift arm of the propulsion unit; and
a header height control system operable to control a distance between a bottom of the main header frame and a ground level.

54. The agricultural system of claim 53, wherein the header height control system comprises a sensor system operable to:
sense the distance between the bottom of the main header frame and the ground level; and
generate a position signal representative of the distance.

55. The agricultural system of claim 54, wherein the header height control system comprises an actuator mounted between the main header frame of the swather header and the propulsion unit, wherein the distance between the bottom of the main header frame and the ground level is controlled, at least in part, by extension and contraction of the actuator.

56. The agricultural system of claim 55, wherein the actuator comprises a hydraulic actuator.

57. The agricultural system of claim 55, wherein the actuator comprises an electric actuator.

58. The agricultural system of claim 54, wherein the header height control system comprises:
a header positioning system operable to transmit, to the actuator, an actuator signal;
a controller operable to:
receive the position signal from the sensor system, the position signal representing a sensed position;
compare the sensed position to a desired position to, thereby, determine a difference;
produce, based on the difference, a control signal; and
transmit the control signal towards the positioning system.

59. The agricultural system of claim 58, wherein the control signal comprises a lift control signal, causing the positioning system to cause the actuator to act to raise the main header frame.

60. The mounting apparatus of claim 58, wherein the control signal comprises a drop control signal, causing the positioning system to cause the actuator to act to lower the main header frame.

61. The agricultural system of claim 55, further comprising a signal conditioner configured to:
intercept the control signal transmitted by the controller;
generate, based, at least in part, on the control signal, a conditioned control signal; and
transmit the conditioned control signal to the positioning system instead of the control signal.

62. The agricultural system of claim 61, further comprising a system sensor operable to:
generate a system sensor signal; and
transmit the system sensor signal to the signal conditioner;
wherein the signal conditioner is configured to generate the conditioned control signal based, at least in part, on the system sensor signal.

63. The agricultural system of claim 62, wherein the sensor system comprises a first sensor operable to:
sense a first distance between a first portion of the bottom of the main header frame and the ground level; and
generate a first position signal representative of the first distance.

64. The agricultural system of claim 63, wherein the sensor system comprises a second sensor operable to:
sense a second distance between a second portion of the bottom of the main header frame and the ground level; and
generate a second position signal representative of the second distance.

65. An agricultural apparatus comprising:
a propulsion unit including first and second generally longitudinally extending lift arms, the first and second lift arms being transversely spaced apart and each of the first and second lift arms having an end region;
a transversely extending header having a weight;
a first lower connecting apparatus and a second lower connecting apparatus interconnecting the end regions of the first and second lift arms respectively to the header and operable to provide support for at least a portion of said weight of said main header;
wherein each of the first and second lower connecting apparatuses includes a fluid suspension mechanism operable to at least partly provide suspension between said end regions of said first and second lift arms and said main frame on said propulsion unit.

66. An agricultural apparatus as claimed in claim 65, wherein includes the fluid suspension mechanism is a pressurized gas suspension system.

67. An agricultural apparatus as claimed in claim 66, wherein the header has a main frame and wherein each of the first and second lower connecting apparatuses are operable to connect the first and second lift arms respectively, to the main frame of the implement.

68. An agricultural apparatus as claimed in claim 67, wherein said main frame comprises a main transverse beam and first and second transversely spaced vertical struts that are depending generally downwardly from said main transverse beam, and wherein the first lower connecting apparatus is operationally positioned between a lower end region of the first vertical strut and the first lift arm, and the second lower connecting apparatus is operationally positioned between a lower end region of the first vertical strut and the second lift arm.

69. An agricultural apparatus as claimed in claim 68, further comprising an upper connection apparatus operationally positioned between a connection location on said main transverse beam and a structural member of said propulsion unit.

70. An agricultural apparatus as claimed in claim 69, wherein said upper connection mechanism and said first and second lower connecting apparatuses are configured in a generally triangular shaped three-point arrangement.

71. An agricultural apparatus as claimed in claim 66, wherein said gas suspension mechanism of each of the first and second lower connecting apparatuses are operable to provide for an elastic spring movement between said main frame and said first and second lift arms respectively.

72. An agricultural apparatus as claimed in claim 65, wherein said gas suspension mechanism of each of the first and second lower connecting apparatuses are operable to provide for a dampened spring movement between said main frame and said first and second lift arms respectively.
